(19) United States
(12) Patent Application Publication
(10) Pub. No.: US 2015/0030068 A1
(43) Pub. Date: Jan. 29, 2015

(54) IMAGE PROCESSING DEVICE AND METHOD

(71) Applicant: Sony Corporation, Tokyo (JP)

(72) Inventor: Kazushi Sato, Kanagawa (JP)

(73) Assignee: SONY CORPORATION, Tokyo (JP)

(21) Appl. No.: 14/373,691

(22) PCT Filed: Mar. 4, 2013
(86) PCT No.: PCT/JP2013/055884

§ 371 Date: Jul. 22, 2014

(30) Foreign Application Priority Data
Mar. 15, 2012 (JP) 2012-058680
Mar. 29, 2012 (JP) 2012-076222

(51) Int. Cl. H04N 19/124; H04N 19/174

(52) U.S. Cl. CPC H04N 19/0009; H04N 19/00272
USPC 375/240.03

(57) ABSTRACT

The present disclosure relates to an image processing device and method that enable efficient decoding of a picture partitioned into tiles. Upon being supplied with a tile initial QP from a tile initial QP buffer, a differential QP generation unit acquires a picture initial QP by sending a request to a picture initial QP buffer. The differential QP generation unit generates a differential QP between the picture initial QP and the tile initial QP, and supplies the generated differential QP to a syntax setting unit 161. The syntax setting unit sets the differential QP between the picture initial QP and the tile initial QP, near the beginning of the corresponding tile in an encoded stream, as the initial value of the quantization parameter for the tile (TILE_int_QP). The present disclosure is applicable to, for example, an image processing device.

### TECHNICAL FIELD

The present disclosure relates to image processing devices and methods, and more specifically to an image processing device and method that enable efficient decoding of a picture partitioned into tiles.

### BACKGROUND ART

In recent years, devices for compressing and encoding images using a coding scheme that digitally handles image information and, when doing so, for the purpose of high-efficiency transmission and accumulation of information, utilizes redundancy specific to image information to compress the image information using an orthogonal transform such as a discrete cosine transform and motion compensation are becoming widespread. Examples of the coding scheme include MPEG (Moving Picture Experts Group).

In particular, MPEG2 (ISO/IEC 13818-2) is defined as a general-purpose image coding scheme, and is a standard for both interlaced scanned images and progressively scanned images and for standard-definition images and high-definition images. For example, MPEG2 is currently, widely used for a wide range of applications for professional use and consumer use. With the use of the MPEG2 compression scheme, for example, a standard-definition interlaced scanned image having 720×480 pixels is given a coding rate (bit rate) of 4 to 8 Mbps. With the use of the MPEG2 compression scheme, furthermore, for example, a high-resolution interlaced scanned image having 1920×1088 pixels is given a coding rate (bit rate) of 18 to 22 Mbps. Accordingly, it is possible to achieve a high compression ratio and high image quality implementation.

Although MPEG2 mainly targeted high-quality image coding suitable for broadcasting, it did not support coding schemes with lower coding rates (bit rates) than MPEG1, that is, coding schemes with higher compression ratios. With the increased popularity of mobile terminals, the needs for such coding schemes were expected to increase in the future, and the MPEG4 encoding scheme was standardized accordingly. A standard for an image coding scheme was approved as international standard ISO/IEC 14496-2 in December 1998.

The schedule for standardization was as follows: International standard called H.264 and MPEG-4 Part 10 (Advanced Video Coding; hereinafter referred to as the AVC scheme) was published in March 2003.

Additionally, standardization of an extension of the AVC scheme, FRExt (Fidelity Range Extension), which includes coding tools that are necessary for business use, such as RGB, 4:2:2, and 4:4:4, and 8×8 DCT and quantization matrices defined in MPEG-2, was completed in February 2005. As a result, a coding scheme with which even film noise in a movie can be expressed well by using the AVC scheme has led to its use in a wide variety of applications such as Blu-Ray Disc (trademark).

However, there have recently been an increasing number of demands for even higher compression ratio coding, such as the demand to compress images having a resolution of approximately 4000×2000 pixels, which is four times that of high-definition images, and the demand to distribute high-definition images in an environment with limited transmission capacity, such as the Internet. To meet the demands, improvements in coding efficiency are being studied by VCEG (=Video Coding Expert Group) of the ITU-T, described above.

Meanwhile, there has been a concern that a macroblock size of 16 pixels×16 pixels will not be optimum to large image sizes such as UHD (Ultra High Definition; 4000 pixels 2000 pixels) which will be the targets of next-generation coding schemes.

Accordingly, standardization of a coding scheme called HEVC (High Efficiency Video Coding) is currently being undertaken by JCTVC (Joint Collaboration Team—Video Coding), which is a joint standardization organization of the ITU-T and the ISO/IEC, with the aim of further improvements in coding efficiency over AVC.

In the HEVC scheme, a coding unit (CU) is defined as a unit of processing similar to a macroblock in the AVC scheme. Unlike a macroblock in the AVC scheme, whose size is fixed at 16×16 pixels, the size of a CU is not fixed, and is specified in image compression information for each sequence. Further, the maximum size (LCU=Largest Coding Unit) and minimum size (SCU=Smallest Coding Unit) of a CU are also specified for each sequence.

CUs are split into prediction units (PUs), which are regions used as the unit of intra or inter prediction processing (sub-regions of a picture-based image), and are further split into transform units (TUs), which are regions used as the unit of orthogonal transform processing (sub-regions of a picture-based image).

In the HEVC scheme, furthermore, information concerning a quantization parameter is delivered to the decoding side. In this regard, first, as information concerning a quantization parameter, the initial quantization parameter for the picture is set in a picture parameter set (PPS) in image compression information. In this case, which granularity (size) of CU is to be used to deliver the quantization parameter to the decoding side is also set.

Then, a difference between the initial quantization parameter for the picture and the initial quantization parameter for the slice is set in the slice header. This allows the initial quantization parameter for the slice to be calculated on the decoding side.

In addition, at the beginning of a CU having a size greater than or equal to the size set in the picture parameter set, a difference between the initial quantization parameter for the slice and the quantization parameter for the CU is set. This allows the quantization parameter for the CU to be calculated on the decoding side.

Incidentally, in the HEVC scheme, as in NPL 1, tiles are specified as a tool for parallel processing. A tile is one of the units of picture partitioning. With regard to tiles, the row size and column size of each tile are specified in units of LCUs in a sequence parameter set (SPS) or picture parameter set in image compression information.

LCUs included in each tile are processed in raster scan order, and tiles included in each picture are processed in raster scan order. Furthermore, a slice may contain tiles, and a slice boundary may be located in the middle of a tile.

Additionally, it is proposed in NPL 2 that information indicating which positions tiles begin with is specified in image compression information and is transmitted to the decoding side.

### CITATION LIST

### Non Patent Literature

NPL 1: Arild Fuldseth, Michael Horowitz, Shilin Xu, Andrew Segall, Minhua Zhou, “Tiles”, JCTVC-F335, Joint Collaborative Team on Video Coding (JCT-VC) of ITU-T SG16 WP3 and ISO/IEC JTC1/SC29/WG11 (VCEG) 6th Meeting: Torino, IT, 14-22 Jul., 2011
NPL 2: Kiran Misra, Andrew Segall, “New results for parallel decoding for Tiles”, JCTVC-F594, Joint Collaborative Team on Video Coding (JCT-VC) of ITU-T SG16 WP3 and ISO/IEC JTC1/SC29/WG11 (VCEG) 6th Meeting: Torino, IT, 14-22 Jul., 2011

### SUMMARY OF INVENTION

### Technical Problem

As described above, a slice may contain tiles, and a slice boundary may be located in the middle of a tile. However, consideration is given to the case where, for example, parallel processing is executed in units of tiles on a picture partitioned into three tiles 0 to 2 in the horizontal direction, in which case the picture is partitioned into two slices 0 and 1 and the boundary between the two slices 0 and 1 is located in the tile 1.

In this case, in order to reconfigure the quantization parameter of the CU located at the beginning of the tile 2, it is necessary to access the header of the slice 1 near the boundary between the slices 0 and 1 located in the middle of the tile 1, which has been transmitted to the decoding side.

That is, the tile 2 is not processible until the processing of the slice header in the tile 1 is completed, which may hinder tile-by-tile parallel processing.

The present disclosure has been made in view of the foregoing situation, and is designed to enable efficient decoding of a picture partitioned into tiles.

### Solution to Problem

An image processing device of an aspect of the present disclosure includes a receiving unit configured to receive an encoded stream and an initial value of a quantization parameter for a tile in a picture included in an image and partitioned into a plurality of tiles, the initial value of the quantization parameter for the tile being set so as to ensure that processes related to quantization parameters for tiles in the picture are independent; a quantization parameter reconfiguration unit configured to reconfigure a quantization parameter of a coding unit in the tile, using the initial value of the quantization parameter for the tile received by the receiving unit; and a decoding unit configured to decode the encoded stream received by the receiving unit using the quantization parameter reconfigured by the quantization parameter reconfiguration unit to generate the image.

The receiving unit can receive, as the initial value of the quantization parameter for the tile, a value set at a certain position in the encoded stream.

The receiving unit can receive, as the initial value of the quantization parameter for the tile, a value set in a picture parameter set in the encoded stream.

The receiving unit can receive, as the initial value of the quantization parameter for the tile, a value set in an initial slice header of the picture in the encoded stream.

The receiving unit can receive, as the initial value of the quantization parameter for the tile, a value set near the beginning of the tile in the encoded stream.

The receiving unit can receive, as the initial value of the quantization parameter for the tile, a value set in slice data in the encoded stream.

The receiving unit can receive information concerning a quantization parameter of a coding unit in the tile, and the quantization parameter reconfiguration unit can reconfigure a quantization parameter of a coding unit in the tile, using the information concerning a quantization parameter of a coding unit in the tile received by the receiving unit.

An image processing method of an aspect of the present disclosure includes receiving an encoded stream and an initial value of a quantization parameter for a tile in a picture included in an image and partitioned into a plurality of tiles, the initial value of the quantization parameter for the tile being set so as to ensure that processes related to quantization parameters for tiles in the picture are independent; reconfiguring a quantization parameter of a coding unit in the tile, using the received initial value of the quantization parameter for the tile; and decoding the received encoded stream using the reconfigured quantization parameter to generate the image, wherein the image processing method is performed by an image processing device.

An image processing device of another aspect of the present disclosure includes an encoding unit configured to encode an image to generate an encoded stream; an initial value setting unit configured to set an initial value of a quantization parameter for a tile in a picture included in the image and partitioned into a plurality of tiles so as to ensure that processes related to quantization parameters for tiles in the picture are independent; and a transmission unit configured to transmit the initial value of the quantization parameter for the tile set by the initial value setting unit and the encoded stream generated by the encoding unit.

The initial value setting unit can set the initial value of the quantization parameter for the tile at a certain position in the encoded stream.

The initial value setting unit can set the initial value of the quantization parameter for the tile in a picture parameter set in the encoded stream.

The initial value setting unit can set the initial value of the quantization parameter for the tile in an initial slice header of the picture in the encoded stream.

The initial value setting unit can set the initial value of the quantization parameter for the tile near the beginning of a tile in the encoded stream.

The initial value setting unit can set the initial value of the quantization parameter for the tile in slice data in the encoded stream.

The transmission unit can transmit information concerning a quantization parameter of a coding unit in the tile, the quantization parameter of the coding unit in the tile being generated using the initial value of the quantization parameter for the tile.

An image processing method of another aspect of the present disclosure includes encoding an image to generate an encoded stream; setting an initial value of a quantization parameter for a tile in a picture included in the image and partitioned into a plurality of tiles so as to ensure that processes related to quantization parameters for tiles in the picture are independent; and transmitting the set initial value of the quantization parameter for the tile and the generated encoded stream, wherein the image processing method is performed by an image processing device.

In an aspect of the present disclosure, an encoded stream and an initial value of a quantization parameter for a tile in a picture included in an image and partitioned into a plurality of tiles are received, the initial value of the quantization parameter for the tile being set so as to ensure that processes related to quantization parameters for tiles in the picture are independent. Then, a quantization parameter of a coding unit in the tile is reconfigured using the received initial value of the quantization parameter for the tile, and the received encoded stream is decoded using the reconfigured quantization parameter to generate the image.

In another aspect of the present disclosure, an image is encoded to generate an encoded stream, and an initial value of a quantization parameter for a tile in a picture included in the image and partitioned into a plurality of tiles is set so as to ensure that processes related to quantization parameters for tiles in the picture are independent. Then, the set initial value of the quantization parameter for the tile and the generated encoded stream are transmitted.

Note that each of the image processing devices described above may be an independent device, or may be an internal block included in a single image encoding device or image decoding device.

### Advantageous Effects of Invention

According to an aspect of the present disclosure, it is possible to decode an image. In particular, it is possible to improve processing efficiency for decoding of a picture partitioned into tiles.

According to another aspect of the present disclosure, it is possible to encode an image. In particular, it is possible to improve processing efficiency for decoding of a picture partitioned into tiles.

### BRIEF DESCRIPTION OF DRAWINGS

FIG. 1 is a block diagram illustrating an example main configuration of an image encoding device.

FIG. 2 is a diagram depicting example configurations of coding units.

FIG. 3 is a diagram depicting tiles.

FIG. 4 is a diagram illustrating an example of the relationship between tiles and slices.

FIG. 5 is a diagram illustrating an example of the syntax for the picture parameter set in the HEVC scheme.

FIG. 6 is a diagram illustrating the example of the syntax for the picture parameter set in the HEVC scheme.

FIG. 7 is a diagram illustrating an example of the syntax for the sequence parameter set in the HEVC scheme.

FIG. 8 is a diagram illustrating the example of the syntax for the sequence parameter set in the HEVC scheme.

FIG. 9 is a diagram illustrating the example of the syntax for the sequence parameter set in the HEVC scheme.

FIG. 10 is a diagram illustrating the example of the syntax for the sequence parameter set in the HEVC scheme.

FIG. 11 is a diagram illustrating an example of the syntax for a transform unit in the HEVC scheme.

FIG. 12 includes diagrams illustrating another example of the relationship between slices and tiles.

FIG. 13 includes diagrams illustrating examples of the initial values of the quantization parameters for tiles.

FIG. 14 is a diagram illustrating an example of the initial values of the quantization parameters for tiles.

FIG. 15 is a block diagram illustrating an example main configuration of a quantization initial value setting unit and a lossless encoding unit.

FIG. 16 is a flowchart depicting an example of the flow of an encoding process.

FIG. 17 is a flowchart depicting an example of the flow of a quantization parameter initial value setting process.

FIG. 18 is a flowchart depicting an example of the flow of a tile encoding process.

FIG. 19 is a block diagram illustrating another example main configuration of the quantization initial value setting unit and the lossless encoding unit.

FIG. 20 is a flowchart depicting another example of the flow of the quantization parameter initial value setting process.

FIG. 21 is a diagram illustrating an example of the syntax for the sequence parameter set in a second method.

FIG. 22 is a diagram illustrating the example of the syntax for the sequence parameter set in the second method.

FIG. 23 is a diagram illustrating the example of the syntax for the sequence parameter set in the second method.

FIG. 24 is a diagram illustrating an example of the syntax for the picture sparameter set in the second method.

FIG. 25 is a diagram illustrating the example of the syntax for the picture parameter set in the second method.

FIG. 26 is a diagram illustrating an example of the syntax for slice data as another example of the syntax in the second method.

FIG. 27 is a block diagram illustrating an example main configuration of an image decoding device.

FIG. 28 is a block diagram illustrating an example main configuration of a quantization initial value decoding unit and a lossless decoding unit.

FIG. 29 is a flowchart depicting an example of the flow of a decoding process.

FIG. 30 is a flowchart depicting an example of the flow of a tile decoding process.

FIG. 31 is a block diagram illustrating another example main configuration of the quantization initial value decoding unit and the lossless decoding unit.

FIG. 32 is a flowchart depicting an example of the flow of a decoding process.

FIG. 33 is a diagram illustrating an example of a multi-view image encoding scheme.

FIG. 34 is a diagram illustrating an example main configuration of a multi-view image encoding device to which the present technology applies.

FIG. 35 is a diagram illustrating an example main configuration of a multi-view image decoding device to which the present technology applies.

FIG. 36 is a diagram illustrating an example of a layered image encoding scheme.

FIG. 37 is a diagram illustrating an example main configuration of a layered image encoding device to which the present technology applies.

FIG. 38 is a diagram illustrating an example main configuration of a layered image decoding device to which the present technology applies.

FIG. 39 is a block diagram illustrating an example main configuration of a computer.

FIG. 40 is a block diagram illustrating an example of a schematic configuration of a television apparatus.

FIG. 41 is a block diagram illustrating an example of a schematic configuration of a mobile phone.

FIG. 42 is a block diagram illustrating an example of a schematic configuration of a recording/reproducing apparatus.

FIG. 43 is a block diagram illustrating an example of a schematic configuration of an imaging apparatus.

FIG. 44 is a block diagram illustrating an example of the use of scalable coding.

FIG. 45 is a block diagram illustrating another example of the use of scalable coding.

FIG. 46 is a block diagram illustrating still another example of the use of scalable coding.

### DESCRIPTION OF EMBODIMENTS

Modes for carrying out the present disclosure (hereinafter referred to as embodiments) will be described hereinafter. The description will be given in the following order.

1. First embodiment (image encoding device)
2. Second embodiment (image decoding device)
3. Third embodiment (multi-view image encoding/multi-view image decoding device)
4. Fourth embodiment (layered image encoding/layered image decoding device)
5. Third embodiment (computer)
6. Example applications
7. Example applications of scalable coding

### 1. First Embodiment

### Image encoding Device

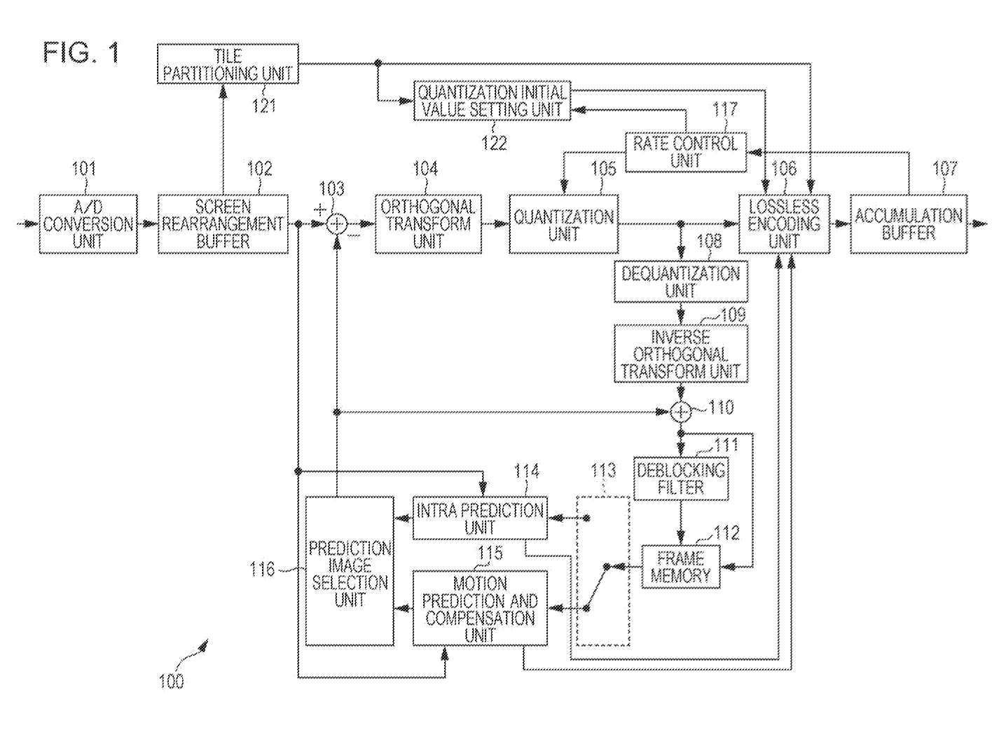

FIG. 1 is a block diagram illustrating an example main configuration of an image encoding device.

An image encoding device 100 illustrated in FIG. 1 encodes image data using, for example, a prediction process in the HEVC (High Efficiency Video Coding) compliant scheme.

As illustrated in FIG. 1, the image encoding device 100 includes an A/D conversion unit 101, a screen rearrangement buffer 102, a computation unit 103, an orthogonal transform unit 104, a quantization unit 105, a lossless encoding unit 106, an accumulation buffer 107, a dequantization unit 108, and an inverse orthogonal transform unit 109. The image encoding device 100 also includes a computation unit 110, a deblocking filter 111, a frame memory 112, a selection unit 113, an intra prediction unit 114, a motion prediction and compensation unit 115, a prediction image selection unit 116, and a rate control unit 117.

The image encoding device 100 further includes a tile partitioning unit 121 and a quantization initial value setting unit 122.

The A/D conversion unit 101 performs A/D conversion on input image data, and supplies the resulting image data (digital data) to the screen rearrangement buffer 102 for storage.

The screen rearrangement buffer 102 rearranges the images of frames arranged in the order of display, which are stored, in order of frames for coding in accordance with a GOP (Group Of Picture). Then, the screen rearrangement buffer 102 supplies an image whose frames have been reordered to the computation unit 103. Note that this image is also supplied to the tile partitioning unit 121. The screen rearrangement buffer 102 also supplies the image whose frames have been reordered to the intra prediction unit 114 and the motion prediction and compensation unit 115.

The computation unit 103 subtracts a prediction image supplied from the intra prediction unit 114 or the motion prediction and compensation unit 115 via the prediction image selection unit 116 from the image read from the screen rearrangement buffer 102, and outputs difference information indicating the difference therebetween to the orthogonal transform unit 104.

For example, in the case of an image to be inter-coded, the computation unit 103 subtracts the prediction image supplied from the motion prediction and compensation unit 115 from the image read from the screen rearrangement buffer 102.

The orthogonal transform unit 104 performs an orthogonal transform such as a discrete cosine transform or a Karhunen-Loève transform on the difference information supplied from the computation unit 103. Note that an arbitrary orthogonal transform method may be adopted. The orthogonal transform unit 104 supplies the transform coefficients to the quantization unit 105.

The quantization unit 105 quantizes the transform coefficients supplied from the orthogonal transform unit 104 using quantization parameters supplied from the rate control unit 117. Note that an arbitrary quantization method may be adopted. The quantization unit 105 supplies the quantized transform coefficients to the lossless encoding unit 106.

The lossless encoding unit 106 encodes the transform coefficients quantized by the quantization unit 105 using an arbitrary coding scheme. Since coefficient data has been quantized under the control of the rate control unit 117, the coding rate is equal to the target value set by the rate control unit 117 (or is approximate to the target value).

The lossless encoding unit 106 acquires information indicating an intra prediction mode and the like from the intra prediction unit 114, and acquires information indicating an inter prediction mode, differential motion vector information, and the like from the motion prediction and compensation unit 115. The lossless encoding unit 106 further acquires the addresses of tile boundaries from the tile partitioning unit 121 as tile partitioning information. The lossless encoding unit 106 acquires information concerning the initial values of quantization parameters from the quantization initial value setting unit 122.

The lossless encoding unit 106 encodes the various pieces of information described above using an arbitrary coding scheme, and incorporates (multiplexes) them into header information in the encoded data (also referred to as the encoded stream) as part of the header information. The lossless encoding unit 106 supplies the encoded data obtained through encoding to the accumulation buffer 107 for accumulation.

Examples of the coding scheme of the lossless encoding unit 106 include variable-length coding and arithmetic coding. Examples of the variable-length coding include CAVLC (Context-Adaptive Variable Length Coding) specified in the AVC scheme. Examples of the arithmetic coding include CABAC (Context-Adaptive Binary Arithmetic Coding).

The accumulation buffer 107 temporarily holds the encoded data supplied from the lossless encoding unit 106. The accumulation buffer 107 outputs the held encoded data to, for example, an unillustrated downstream recording device (recording medium), a transmission path, or the like at a predetermined timing. That is, the accumulation buffer 107 also serves as a transmission unit configured to transmit encoded data.

Furthermore, the transform coefficients quantized by the quantization unit 105 are also supplied to the dequantization unit 108. The dequantization unit 108 dequantizes the quantized transform coefficients using a method corresponding to the quantization method performed by the quantization unit 105. The dequantization method may be any method corresponding to the quantization process performed by the quantization unit 105. The dequantization unit 108 supplies the obtained transform coefficients to the inverse orthogonal transform unit 109.

The inverse orthogonal transform unit 109 performs an inverse orthogonal transform on the transform coefficients supplied from the dequantization unit 108 using a method corresponding to the orthogonal transform process performed by the orthogonal transform unit 104. The inverse orthogonal transform method may be any method corresponding to the orthogonal transform process performed by the orthogonal transform unit 104. The inversely orthogonally transformed output (restored difference information) is supplied to the computation unit 110.

The computation unit 110 adds the prediction image obtained from the intra prediction unit 114 or the motion prediction and compensation unit 115 via the prediction image selection unit 116 to the restored difference information supplied from the inverse orthogonal transform unit 109, which is the result of the inverse orthogonal transform, and obtains a locally decoded image (decoded image). The decoded image is supplied to the deblocking filter 111 or the frame memory 112.

The deblocking filter 111 performs a deblocking filter process, if necessary, on the decoded image supplied from the computation unit 110. For example, the deblocking filter 111 performs a deblocking filter process on the decoded image to remove block distortion from the decoded image.

The deblocking filter 111 supplies the result of the filter process (the decoded image subjected to the filter process) to the frame memory 112. Note that, as described above, the decoded image output from the computation unit 110 may be supplied to the frame memory 112 without passing through the deblocking filter 111. That is, the filter process performed by the deblocking filter 111 may be omitted.

The frame memory 112 stores the supplied decoded image, and supplies the stored decoded image to the selection unit 113 as a reference image at a predetermined timing.

The selection unit 113 selects the destination of the reference image supplied from the frame memory 112. For example, in the case of inter prediction, the selection unit 113 supplies the reference image supplied from the frame memory 112 to the motion prediction and compensation unit 115.

The intra prediction unit 114 performs intra prediction (intra-frame prediction) to generate a prediction image, basically in prediction units (PUs) used as the unit of processing, by using pixel values in the picture to be processed, which is the reference image supplied from the frame memory 112 via the selection unit 113. The intra prediction unit 114 performs the intra prediction described above in a plurality of intra prediction modes prepared in advance.

The intra prediction unit 114 generates a prediction image in all the possible intra prediction modes, evaluates the cost functions of the respective prediction images using the input image supplied from the screen rearrangement buffer 102, and selects an optimum mode. After selecting an optimum intra prediction mode, the intra prediction unit 114 supplies the prediction image generated in the optimum mode to the prediction image selection unit 116.

In addition, as described above, the intra prediction unit 114 supplies intra-prediction mode information indicating the adopted intra prediction mode, and the like to the lossless encoding unit 106, as necessary, for encoding.

The motion prediction and compensation unit 115 performs motion prediction (inter prediction), basically in units of PUs used as the unit of processing, by using the input image supplied from the screen rearrangement buffer 102 and the reference image supplied from the frame memory 112 via the selection unit 113. The motion prediction and compensation unit 115 performs a motion compensation process in accordance with the detected motion vectors, and generates a prediction image (inter prediction image information). The motion prediction and compensation unit 115 performs the inter prediction described above in a plurality of inter prediction modes prepared in advance.

The motion prediction and compensation unit 115 evaluates the cost functions of the respective prediction images using the input image supplied from the screen rearrangement buffer 102, information on the motion vectors, and so on, and selects an optimum mode. After selecting an optimum inter prediction mode, the motion prediction and compensation unit 115 generates a prediction image in the optimum mode, and supplies the generated prediction image to the prediction image selection unit 116.

The motion prediction and compensation unit 115 supplies information indicating the adopted inter prediction mode, information necessary to perform processing in the inter prediction mode when the encoded data is decoded, and the like to the lossless encoding unit 106 for encoding.

The prediction image selection unit 116 selects the source of the prediction image to be supplied to the computation unit 103 and the computation unit 110. For example, in the case of inter coding, the prediction image selection unit 116 selects the motion prediction and compensation unit 115 as the source of the prediction image, and supplies the prediction image supplied from the motion prediction and compensation unit 115 to the computation unit 103 and the computation unit 110.

The rate control unit 117 controls the rate of the quantization operation of the quantization unit 105 in accordance with the coding rate of the encoded data accumulated in the accumulation buffer 107 so as not to cause overflow or underfloor.

Furthermore, the rate control unit 117 sets quantization parameters in accordance with information concerning the target value of the coding rate, and supplies the quantization parameters to the quantization unit 105. Among them, the rate control unit 117 supplies an initial quantization parameter for the picture (hereinafter referred to as the picture initial QP) and an initial quantization parameter for each tile (hereinafter referred to as the tile initial QP) to the quantization initial value setting unit 122.

A setting concerning how the picture is partitioned into tiles to perform processing, which is specified by a user, is input to the tile partitioning unit 121 via an unillustrated operation input unit or the like. The tile partitioning unit 121 refers to the input image obtained from the screen rearrangement buffer 102, and determines tile partitioning in accordance with the setting concerning how the picture is partitioned into tiles to perform processing. The tile partitioning unit 121 supplies the determined addresses of tile boundaries or the like to the quantization initial value setting unit 122 and the lossless encoding unit 106 as tile partitioning information.

The quantization initial value setting unit 122 refers to the tile partitioning information obtained from the tile partitioning unit 121, and sets the initial value of the quantization parameter for each tile using the information supplied from the rate control unit 117. The initial value of the quantization parameter for each tile is a value used as an initial value when the quantization parameter for the initial CU in a tile is reconfigured on the decoding side when a difference between quantization parameters for the initial CUs in tiles is generated on the encoding side. In this case, the initial value of the quantization parameter for a tile is set so as to ensure that processes related to quantization parameters for tiles are independent in the picture of interest.

The quantization initial value setting unit 122 supplies the initial values of the quantization parameters for the tiles and information concerning the quantization parameters for the initial CUs in the tiles, and so on to the lossless encoding unit 106 as information concerning the initial values of quantization parameters.

### [Coding Unit]

Next, a description will be given of the coding unit specified in the HEVC scheme. A macroblock size of 16 pixels×16 pixels will not be optimum to large image sizes such as UHD (Ultra High Definition; 4000 pixels×2000 pixels) which will be the targets of next generation coding schemes.

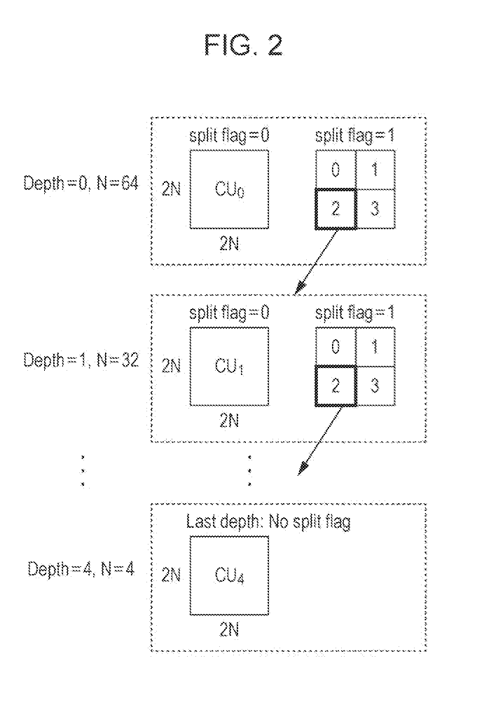

Accordingly, the AVC scheme specifies a hierarchical structure formed of macroblocks and sub-macroblocks, whereas, for example, the HEVC scheme specifies coding unit (CU), as illustrated in FIG. 2.

CU is also termed Coding Tree Block (CTB), and is a sub-region of a picture-based image, which plays a role similar to that of the macroblock in the AVC scheme. Whereas the latter is fixed at the size of 16×16 pixels, the size of the former is not fixed and is specified in image compression information for each sequence.

For example, the maximum size (LCU (Largest Coding Unit)) and minimum size ((SCU (Smallest Coding Unit)) of a CU are specified in the sequence parameter set (SPS) included in encoded data to be output.

In each LCU, split-flag=1 is set within a range not smaller than the size of the SCU, allowing each LCU to be split into CUs having smaller sizes. In an example in FIG. 2, the LCU has a size of 128 and a maximum hierarchical depth of 5. A CU having a size of 2N×2N is split into CUs having a size of N×N, which are located immediately below the depth in question, when the value of split_flag is equal to “1”.

The CUs are further split into prediction units (PUs), which are regions used as the unit of intra or inter prediction processing (sub-regions of the picture-based image). The PUs are further split into transform units (TUs), which are regions used as the unit of orthogonal transform processing (sub-regions of the picture-based image). In the HEVC scheme, 16×16 and 32×32 orthogonal transforms as well as 4×4 and 8×8 are currently available.

For an inter PU, it is possible to split a single CU having a size of 2N×2N into any of 2N×2N, 2N×N, N×2N, and N×N sizes. Note that inter 4×4 enable flag is defined in the sequence parameter set described above, and setting the value of inter 4×4 enable flag to 0 can prohibit the use of an inter CU of a 4×4 block size.

In coding schemes in which a CU is defined and various processes are performed in units of the CU, such as the HEVC scheme described above, it may be considered that a macroblock in the AVC scheme corresponds to an LCU and a block (sub-block) corresponds to a CU. It may also be considered that a motion compensation block in the AVC scheme corresponds to a PU. However, since a CU has a hierarchical structure, the size of the LCU in the top layer of the CU is generally set to be larger than that of a macroblock in the AVC scheme, for example, 128×128 pixels.

### [Overview of Tiles]

In the HEVC scheme, tiles are specified in NPL 1 for parallel processing. A tile is one of the units of picture partitioning. With regard to tiles, the row size and column size of each tile are specified in units of LCUs in a sequence parameter set (SPS) or picture parameter set (PPS) in image compression information.

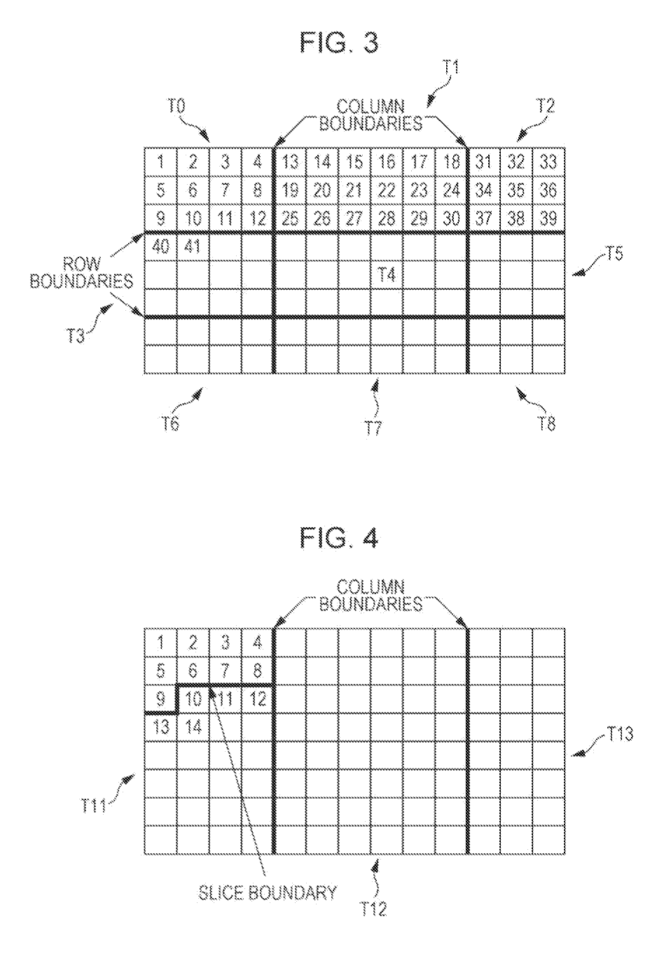

In an example in FIG. 3, a picture partitioned into LCUs is illustrated. Rectangular segments containing numbers represent LCUs. The picture is further partitioned into tiles T0 to T8 which are segmented by row boundaries and column boundaries indicated by bold lines.

For example, the tile T0 located at the top-left position is defined by three rows and four columns, and is configured to include LCUs labeled 1 to 12. The tile T1 on the right adjacent to the tile T0 is defined by three rows and six columns, and is configured to include LCUs labeled 13 to 30. The tile T2 on the right adjacent to the tile T1 is defined by three rows and three columns, and is configured to include LCUs labeled 31 to 39.

As illustrated in FIG. 3, LCUs included in each tile are processed in raster scan order, or in order of labeled numerals illustrated in FIG. 3. In addition, the tiles included in the picture are also processed in raster scan order, or in order of the tiles T0 to T8 illustrated in FIG. 3.

Furthermore, as illustrated in FIG. 4, a slice boundary may be located middle of a tile. That is, in an example in FIG. 4, two column boundaries that separate the picture into three tiles T11 to T13 in the horizontal direction are illustrated. Further, a slice boundary is indicated between the LCU labeled 9 and the LCU labeled 10 within the tile T11.

### [Example of Syntax of HEVC Scheme]

Next, information concerning quantization parameters will be described with reference to the syntax of the HEVC scheme.

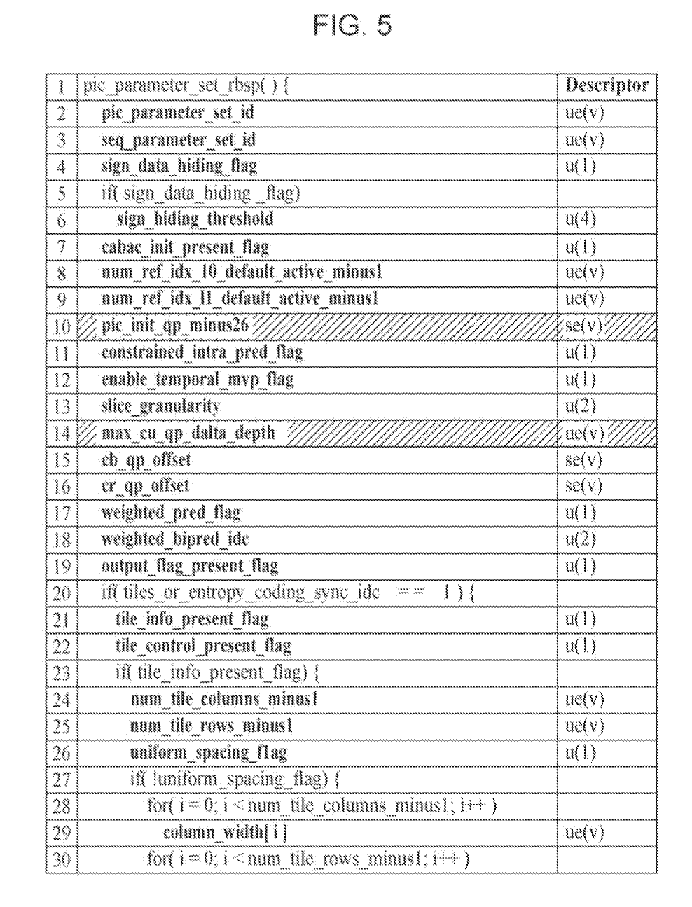

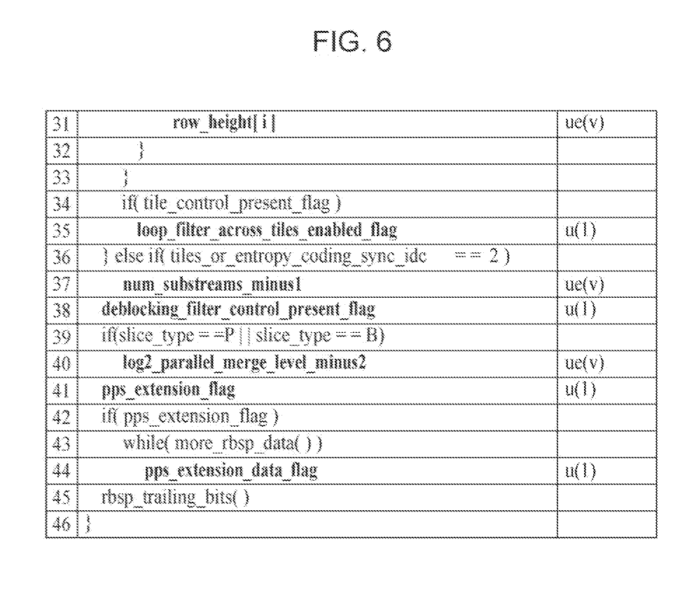

FIG. 5 and FIG. 6 are diagrams illustrating an example of the syntax for the picture parameter set in the HEVC scheme. Numbers on the left of the respective rows represent line numbers given for description.

In the example in FIG. 5, an initial quantization parameter for each picture is set in pic_init_qp_minus26 in the tenth row. In max_cu_qp_delta_depth in the fourteenth row, which granularity (depth) of CU is to be used to transmit the quantization parameter is set.

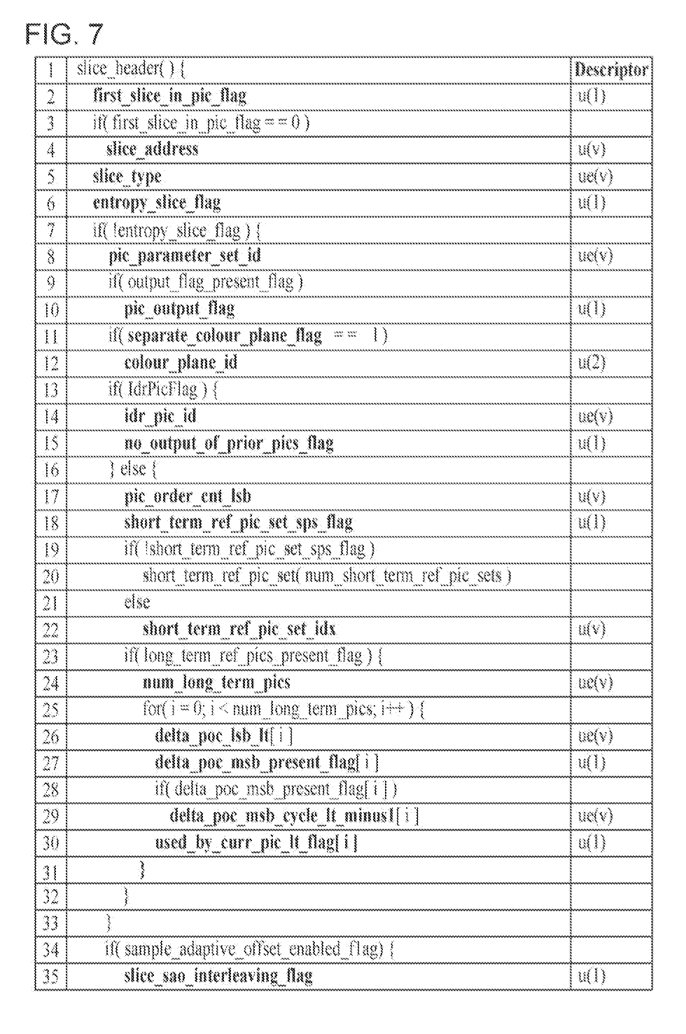

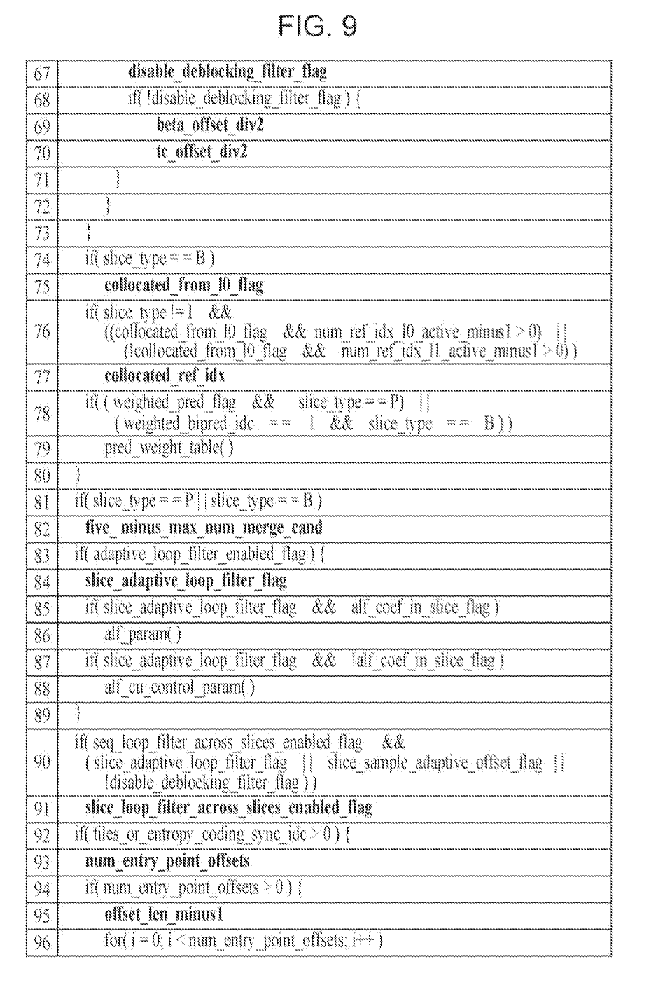

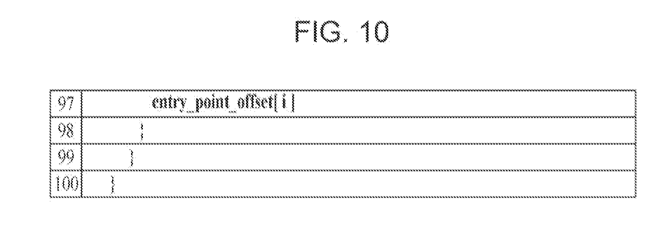

FIG. 7 to FIG. 10 are diagrams illustrating an example of the syntax for the sequence parameter set in the HEVC scheme. Numbers on the left of the respective rows represent line numbers given for description.

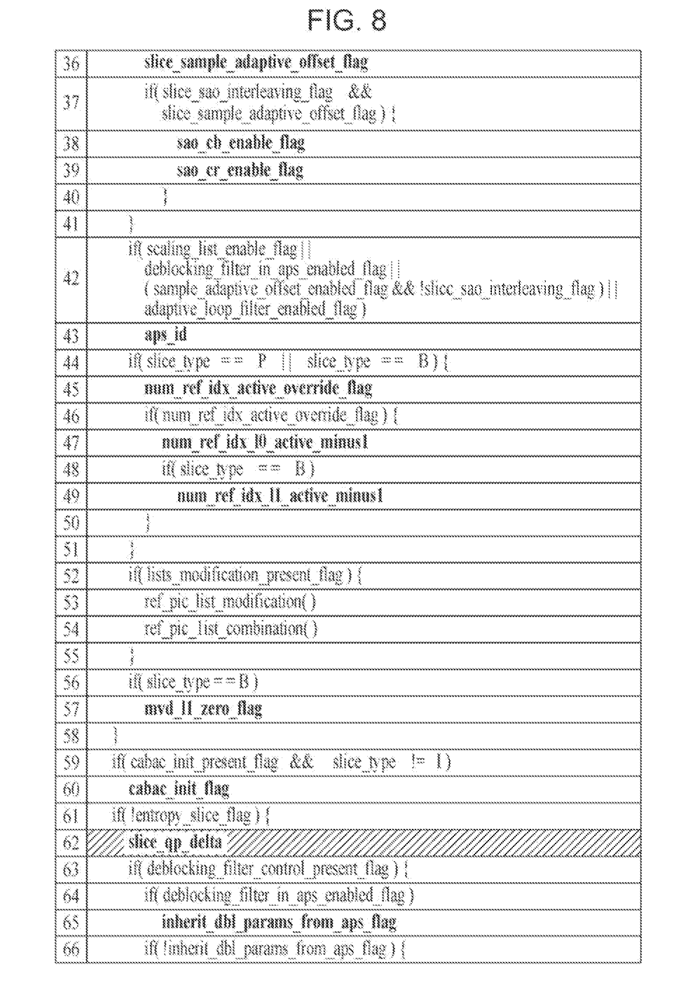

In the example in FIG. 8, slice_qp_delta in the sixty-second row represents difference information between the initial quantization parameter of a slice and the initial quantization parameter of the picture. This allows the initial quantization parameter for the slice to be calculated on the decoding side.

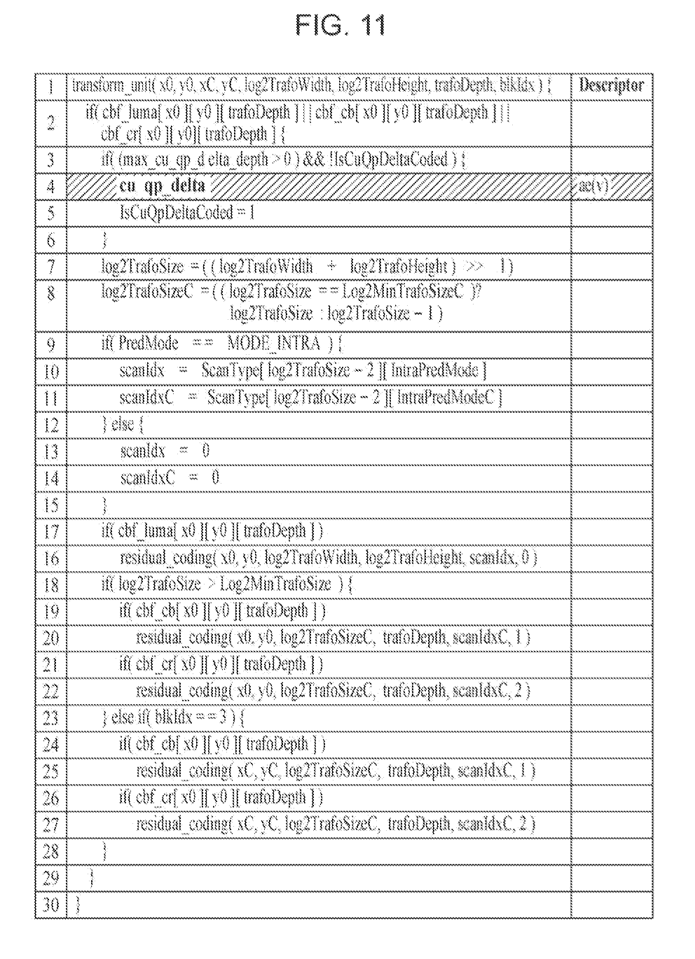

FIG. 11 is a diagram illustrating an example of the syntax for the transform unit in the HEVC scheme. Numbers on the left of the respective rows represent line numbers given for description.

In the example in FIG. 11, cu_qp_delta in the fourth row represents difference information between the initial quantization parameter of a slice and the quantization parameter of the initial CU of the slice. This allows the quantization parameter of the initial CU to be calculated on the decoding side.

cu_qp_delta is transmitted to the decoding side using a transform unit at the beginning of a CU having a size greater than or equal to the size specified in max_cu_qp_delta_depth in FIG. 5. Note that there is no need to transmit the quantization parameter of a CU having a smaller size than the size specified in max_cu_qp_delta_depth in FIG. 5 to the decoding side since, for example, the quantization parameter for a correlated neighboring region among neighboring regions is used.

As described above, in the HEVC scheme, as information concerning quantization parameters, first, the initial quantization parameter for a picture is set in the picture parameter set in image compression information. In this case, which granularity of CU is to be used to deliver the quantization parameter to the decoding side is also set.

Then, a difference between the initial quantization parameter for the picture and the initial quantization parameter for a slice is set in the slice header. This allows the initial quantization parameter for the slice to be calculated on the decoding side.

At the beginning of a CU having a size greater than or equal to the size set in the picture parameter set, furthermore, a difference between the initial quantization parameter for the slice and the quantization parameter for the CU is set. This allows the quantization parameter for the CU to be calculated on the decoding side.

However, the method for transmitting the information concerning quantization parameters described above is not applicable to the case where a picture is partitioned into tiles in the manner described with reference to FIG. 3 and FIG. 4.

### [Example of Relationship Between Slices and Tiles]

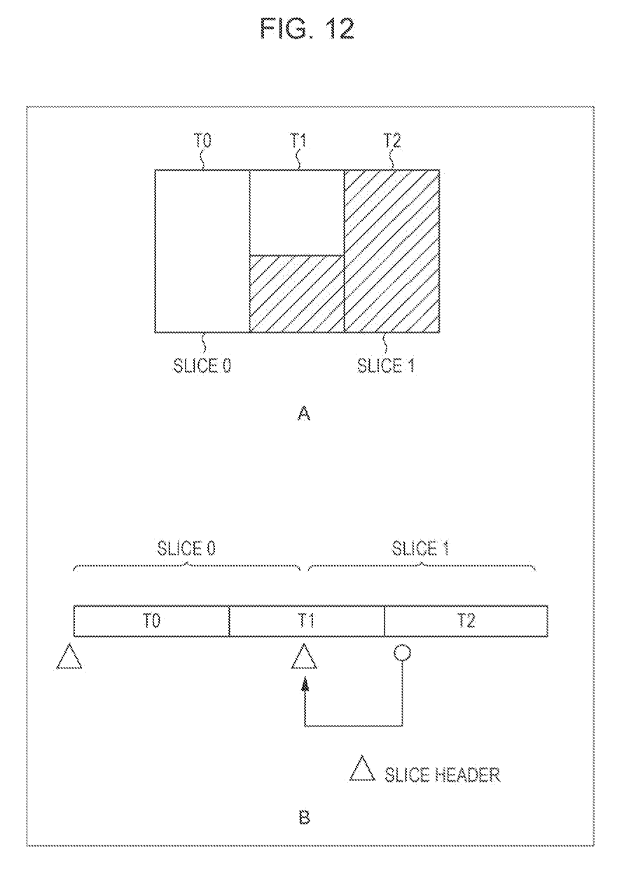

For example, in part A of FIG. 12, a picture is partitioned into three tiles T0 to T2 in the horizontal direction. The picture is further partitioned into unhatched slice 0 and hatched slice 1, and the boundary therebetween is contained in the tile T1.

In part B of FIG. 12, an encoded stream (image compression information) transmitted from the encoding side in the case of part A of FIG. 12 is illustrated. In the example illustrated in part B of FIG. 12, the triangles represent respective slice headers, and the circle represents the CU at the beginning of the tile T2.

The slice header of the slice 0 is positioned near the beginning of the slice 0 and near the beginning of the tile T0. On the other hand, the slice header of the slice 1 is positioned near the beginning of the slice 1 and in the middle of the tile T1.

Further, the tile T2 is contained in the slice T1. Thus, in a case where a quantization parameter for the CU at the beginning of the tile T2 is to be reconfigured, it is necessary to access the slice header of the slice 1 positioned in the middle of the tile T1.

That is, the tile T2 is not processible until the processing of the slice header of the slice 1 in the tile T1 is completed, which may hinder tile-by-tile parallel processing.

### [Explanation of Present Technology]

Accordingly, in the image encoding device 100, the initial value of the quantization parameter for a tile is set so as to ensure that processes related to quantization parameters for tiles are independent, that is, in order to keep processes related to quantization parameters for tiles from being dependent on each other.

In other words, which information (a value set at a certain position) in an encoded stream is to be referred to on the decoding side is set as the initial value of the quantization parameter for a tile. Note that the process related to the quantization parameter for a tile is a process performed using a quantization parameter, examples of which include a quantization process and any other process performed using a quantization parameter.

This enables parallel processing based on tile partitioning while enabling an intra-frame quantization control process.

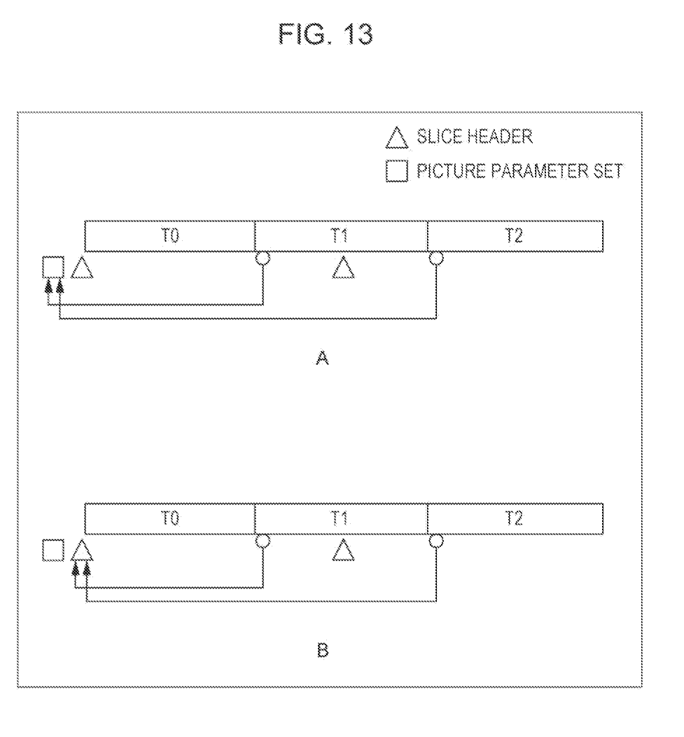

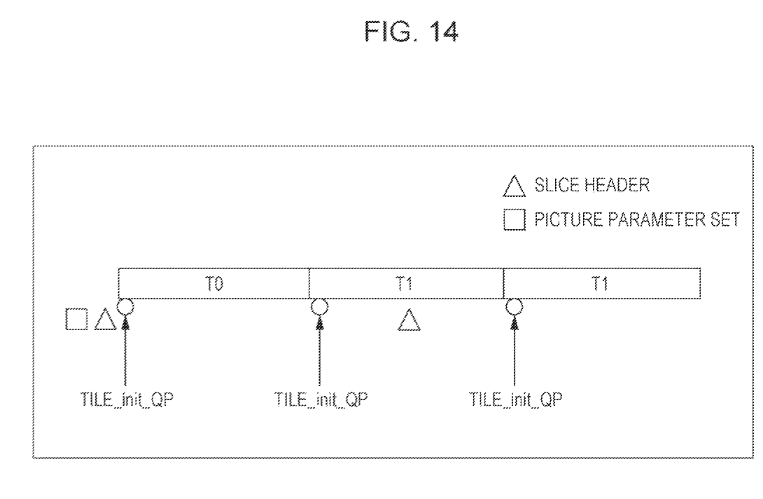

A specific description will be given with reference to FIG. 13 and FIG. 14. FIG. 13 and FIG. 14 conceptually illustrate an encoded stream of a picture partitioned into tiles T0 to T2. In the example in FIG. 13 and FIG. 14, the triangles represent the slice headers, the rectangles represent the picture parameter sets, and the circles represent the respective CUs at the beginning of the tile T1 and tile T2.

In a first method, the initial values of the quantization parameters for the respective tiles to which the CUs at the beginning of the tiles are referred are set in information positioned outside the first tile (before the tile).

That is, for example, as illustrated in part A of FIG. 13, the quantization initial value setting unit 122 sets the initial value of the quantization parameter for each tile in the picture parameter set positioned before the first tile. Specifically, pic_init_qp_minus26 (the existing initial quantization parameter for the picture) in the picture parameter set illustrated in FIG. 5 is set as the initial value of the quantization parameter for each tile.

Thus, in this case, a difference between the initial value of the quantization parameter for each tile (the initial QP for the picture) and the initial QP for the tile is set as CU_delta_QP in a transform unit of the initial CU of the tile.

Alternatively, for example, as illustrated in part B of FIG. 13, the quantization initial value setting unit 122 sets the initial value of the quantization parameter for each tile in the initial slice header of the picture, which is positioned before the first tile. In the following, the initial slice is also referred to as the first slice.

Specifically, slice_qp_delta in the first slice header illustrated in FIG. 8 (the existing initial quantization parameter for the first slice) is set as the initial value of the quantization parameter for each tile.

Thus, in this case, a difference between the initial value of the quantization parameter for each tile (the initial QP for the first slice) and the initial QP for the tile is set as CU_delta_QP in a transform unit of the initial CU of the tile.

Note that, in the former case (hereinafter also referred to as the first method A), since the information concerning the quantization parameters, which is set in the slice header, is skipped, the amount of computation is reduced and the process is shortened. On the other hand, however, the processing processes for the quantization parameters differ depending on whether the picture is partitioned into tiles or not.

In the latter case (hereinafter also referred to as the first method B), in contrast, the processing processes for the quantization parameters do not differ depending on whether the picture is partitioned into tiles or not.

Next, in a second method, as indicated by the circles in FIG. 14, the initial value of the quantization parameter for each tile (TILE_int_QP) to which the CU at the beginning of the corresponding tile is referred is newly set near the beginning of the corresponding tile.

Thus, in this case, a difference between the initial value of the quantization parameter for each tile (TILE_int_QP) and QP of the initial CU included in the tile is set as CU_delta_QP in a transform unit of the initial CU of the tile.

In an example of the setting near the beginning of each tile, the initial value of the quantization parameter for each tile may be included in information (entry point) indicating the beginning of the corresponding tile, which is proposed in, for example, NPL 2.

Note that the first method involves storing the initial values in the buffer at the beginning of the picture and referring to the stored initial values at the beginning of the respective tiles, causing an increase in the capacity of the picture buffer, whereas the second method does not cause such an increase in circuitry.

However, the second method requires the transmission of the initial values at the beginning of the respective tiles, reducing coding efficiency compared to the first method. The first method does not cause such an increase in coding rate.

Applying either the first method or the second method described above enables the reconfiguration of the quantization parameters for the initial CUs of the respective tiles while enabling an intra-frame quantization control process. That is, it is possible to perform parallel processing based on tile partitioning.

### [Example Configuration of Quantization Initial Value Setting Unit and Lossless Encoding Unit]

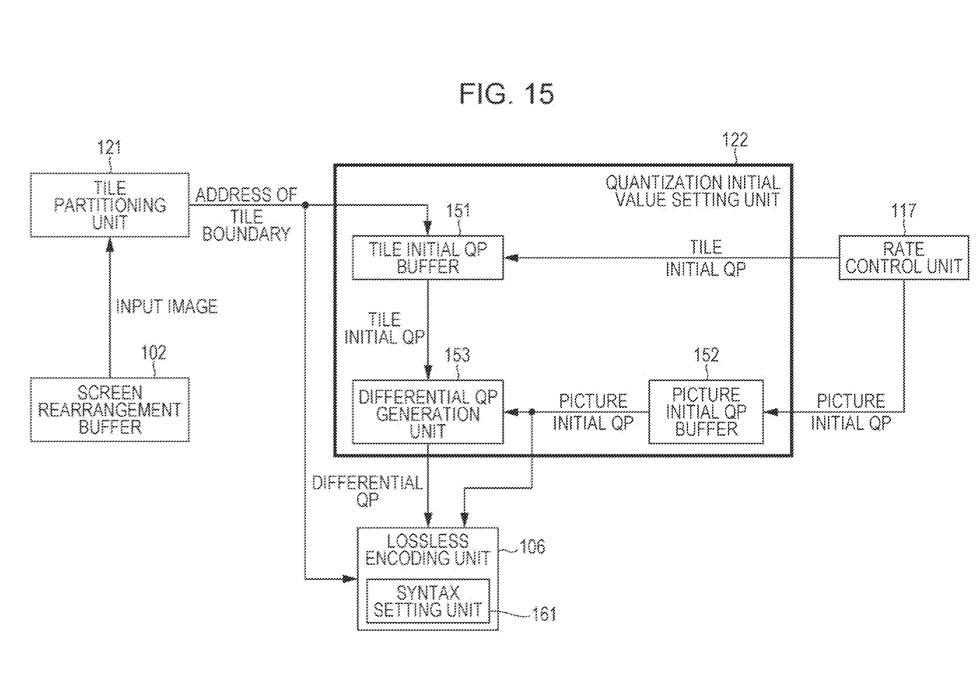

FIG. 15 is a block diagram illustrating an example main configuration of the quantization initial value setting unit 122 and the lossless encoding unit 106 that execute the second method described above with reference to FIG. 14.

In the example in FIG. 15, the quantization initial value setting unit 122 is configured to include a tile initial QP buffer 151, a picture initial QP buffer 152, and a differential QP generation unit 153.

The lossless encoding unit 106 is configured to include at least a syntax setting unit 161.

The address of a tile boundary is supplied from the tile partitioning unit 121 to the tile initial QP buffer 151 and the syntax setting unit 161. When the address of a tile boundary is supplied, the tile initial QP buffer 151 acquires a tile initial QP by sending a request to the rate control unit 117. The tile initial QP is, for example, the quantization parameter of the initial CU included in a tile. Alternatively, the tile initial QP may be, for example, a value or the like close to the quantization parameter of the initial CU included in a tile, or may be any value. The tile initial QP buffer 151 supplies the acquired tile initial QP to the differential QP generation unit 153.

A picture initial QP is supplied to the picture initial QP buffer 152 from the rate control unit 117. The picture initial QP is, for example, the quantization parameter of the initial CU included in the picture. Alternatively, the picture initial QP may be, for example, a value or the like close to the quantization parameter of the initial CU included in the picture, or may be any value. The picture initial QP buffer 152 supplies the picture initial QP to the differential QP generation unit 153 and the syntax setting unit 161 in accordance with a request from the differential QP generation unit 153.

When the tile initial QP is supplied from the tile initial QP buffer 151, the differential QP generation unit 153 acquires the picture initial QP by sending a request to the picture initial QP buffer 152. The differential QP generation unit 153 generates a differential QP between the picture initial QP and the tile initial QP, and supplies the generated differential QP to the syntax setting unit 161.

The syntax setting unit 161 sets syntax using, as information concerning the initial values of quantization parameters, the picture initial QP obtained from the picture initial QP buffer 152, the differential QP obtained from the differential QP generation unit 153 between the picture initial QP and the tile initial QP, and so on.

Specifically, the syntax setting unit 161 sets the picture initial QP obtained from the picture initial QP buffer 152 in pic_init_qp_minus26 for the picture parameter set in the encoded stream. The syntax setting unit 161 further sets the differential QP between the picture initial QP and the tile initial QP near the beginning of the corresponding tile in the encoded stream as the initial value of the quantization parameter for the tile (TILE_int_QP).

Note that, in the example in FIG. 15, although not illustrated because of similarity to a conventional configuration, it is assumed that a difference between the initial value of the quantization parameter for a tile and the quantization parameter of the initial CU in the tile is calculated by, for example, the quantization unit 105.

For example, the initial value of the quantization parameter for the tile is supplied to the quantization unit 105. In response to this, the quantization unit 105 supplies the syntax setting unit 161 with a difference between the initial value of the quantization parameter for the tile and the quantization parameter of the initial CU in the tile as information concerning the quantization parameter of CUs. Then, the syntax setting unit 161 sets the supplied information concerning the quantization parameter of CUs in a transform unit of the initial CU in the tile.

Additionally, the syntax setting unit 161 is also supplied with tile partitioning information. The tile partitioning information is also transmitted to the decoding side, in which case, for example, as described in NPL 2, information indicating a tile boundary may be set near the beginning of a tile on the basis of the tile partitioning information.

Furthermore, although an example of the second method is illustrated in the example in FIG. 15, the first method A illustrated in part A of FIG. 13 may also be performed using the functional blocks in FIG. 15.

Note that, in the first method A, the syntax setting unit 161 sets syntax using, as information concerning the initial values of quantization parameters, the picture initial QP obtained from the picture initial QP buffer 152 and the differential QP obtained from the differential QP generation unit 153.

Specifically, a difference from the second method is that the syntax setting unit 161 sets the picture initial QP in pic_init_qp_minus26 for the picture parameter set in the encoded stream as the initial value of the quantization parameter for the tile. Another difference from the second method is that the syntax setting unit 161 sets the differential QP between the picture initial QP and the tile initial QP in a transform unit of the initial CU of the corresponding tile in the encoded stream as the differential QP of the initial CU in the tile.

[Flow of Encoding Process]

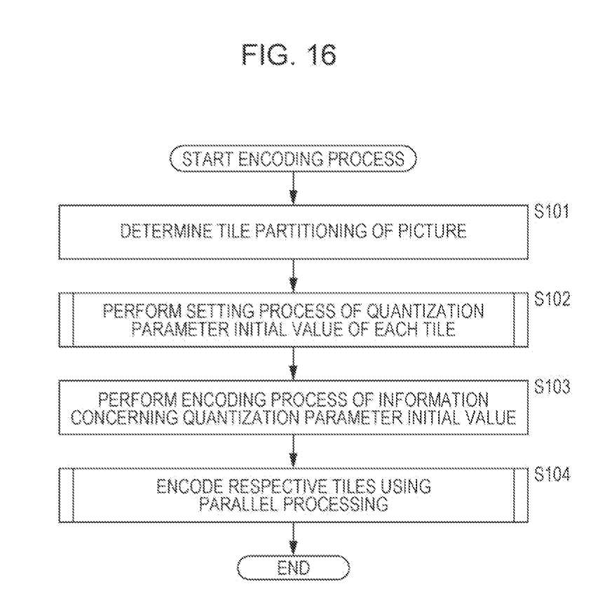

Next, a description will be given of the flow of individual processes executed by the image encoding device 100 as described above. First, the flow of an encoding process for the second method will be described with reference to a flowchart in FIG. 16.

A setting concerning how the picture is partitioned into tiles to perform processing, which is specified by a user, is input to the tile partitioning unit 121 via an unillustrated operation input unit or the like.

In step S101, the tile partitioning unit 121 refers to the input image obtained from the screen rearrangement buffer 102, and determines tile partitioning in accordance with the setting concerning how the picture is partitioned into tiles to perform processing. The tile partitioning unit 121 supplies tile partitioning information, which is the determined addresses of tile boundaries, to the tile initial QP buffer 151 and the lossless encoding unit 106 of the quantization initial value setting unit 122.

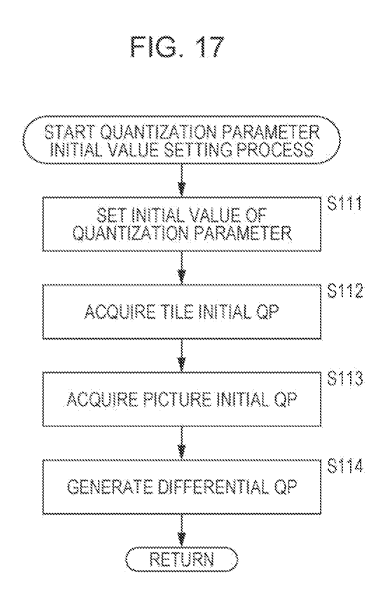

In step S102, the quantization initial value setting unit 122 performs a setting process of the quantization parameter initial value of each tile. The setting process of the quantization parameter initial value of each tile in step S102 will be described below with reference to FIG. 17. Through this process, for example, in the second method, information concerning the picture initial QP and the tile initial QP is supplied to the syntax setting unit 161.

In step S103, the syntax setting unit 161 performs an encoding process of the supplied parameters, as an encoding process of information concerning quantization parameter initial values.

For example, in the second method, the syntax setting unit 161 sets, in the encoding process, the picture initial QP obtained from the picture initial QP buffer 152 in pic_init_qp_minus26 for the picture parameter set in the encoded stream. The syntax setting unit 161 further sets the information concerning the tile initial QP near the beginning of the corresponding tile in the encoded stream as the initial value of the quantization parameter for the tile (TILE_int_QP).

In this way, the information concerning quantization parameter initial values is encoded and output to the accumulation buffer 107, and is transmitted to the decoding side.

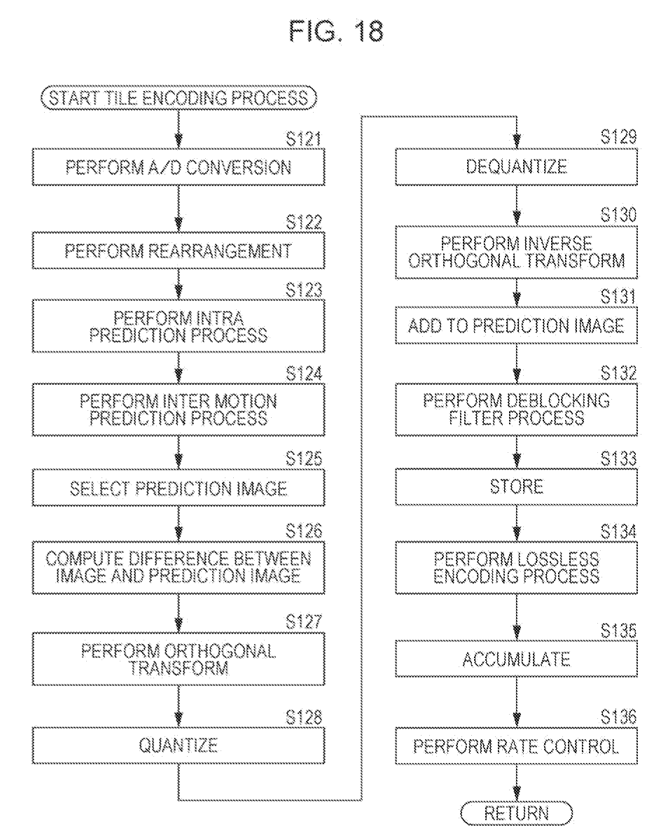

After that, in step S104, the individual units of the image encoding device 100 perform an encoding process of the respective tiles by using parallel processing. The encoding process of each tile is an encoding process of information lower than the slice header, such as DCT coefficients and motion vectors for each tile. The encoding process of each tile will be described below with reference to FIG. 18.

Through the encoding process of each tile in step S104, the information and the lower-level information for each tile is encoded and transmitted to an image decoding device 200 described below.

### [Flow of Setting Process of Quantization Parameter Initial Value of Each Tile]

Next, the setting process of the quantization parameter initial value of each tile in step S102 of FIG. 16 will be described with reference to a flowchart in FIG. 17.

In step S111, the quantization initial value setting unit 122 sets, as the initial value of a quantization parameter, a new initial value of a quantization parameter (TILE_int_QP), which is involved in the second method described above with reference to FIG. 14.

When the address of a tile boundary is supplied, then in step S112, the tile initial QP buffer 151 acquires a tile initial QP by sending a request to the rate control unit 117. The tile initial QP buffer 151 supplies the acquired tile initial QP to the differential QP generation unit 153.

When the tile initial QP is supplied from the tile initial QP buffer 151, then in step S113, the differential QP generation unit 153 acquires a picture initial QP by sending a request to the picture initial QP buffer 152.

In step S114, the differential QP generation unit 153 generates a differential QP between the picture initial QP and the tile initial QP. The differential QP generation unit 153 supplies the generated differential QP to the syntax setting unit 161 as information concerning the tile initial QP.

[Flow of Encoding Process of Each Tile]

Next, the encoding process of each tile in step S104 of FIG. 16 will be described with reference to a flowchart in FIG. 18.

In step S121, the A/D conversion unit 101 performs A/D conversion on an input image. In step S122, the screen rearrangement buffer 102 stores the A/D-converted image, and rearranges pictures from display order to coding order. In step S123, the intra prediction unit 114 performs an intra prediction process in an intra prediction mode.

In step S124, the motion prediction and compensation unit 115 performs an inter motion prediction process to perform motion prediction and motion compensation in inter prediction modes.

Through the process in step S124, the motion vector for the luminance signal of the PU of interest is searched for, the cost function is computed, and an optimum inter-prediction mode is determined from among all the inter prediction modes. Then, a prediction image is generated in the optimum inter-prediction mode.

The prediction image and cost function in the determined optimum inter-prediction mode are supplied from the motion prediction and compensation unit 115 to the prediction image selection unit 116. Furthermore, information on the determined optimum inter-prediction mode and information on motion vectors are also supplied to the lossless encoding unit 106, and are losslessly encoded in step S134, described below.

In step S125, the prediction image selection unit 116 determines an optimum mode in accordance with the respective cost functions output from the intra prediction unit 114 and the motion prediction and compensation unit 115. Specifically, the prediction image selection unit 116 selects either the prediction image generated by the intra prediction unit 114 or the prediction image generated by the motion prediction and compensation unit 115.

In step S126, the computation unit 103 computes a difference between the image that has undergone rearrangement in the process of step S122 and the prediction image selected in the process of step S125. Difference data has a smaller amount of data than the original image data. Thus, it is possible to compress the amount of data compared to the case where an image is encoded as it is.

In step S127, the orthogonal transform unit 104 performs an orthogonal transform on the difference information generated in the process of step S126. Specifically, an orthogonal transform such as a discrete cosine transform or a Karhunen-Loève transform is performed, and transform coefficients are output.

In step S128, the quantization unit 105 quantizes the orthogonal transform coefficients obtained through the process of step S127 using the quantization parameters obtained from the rate control unit 117. Note that although an arbitrary quantization method may be adopted, for example, the quantization parameter of a CU having a size greater than or equal to a designated size is supplied from the rate control unit 117, whereas, as the quantization parameter of a CU having a size smaller than the size, for example, the quantization parameter for a correlated neighboring region among neighboring regions is used.

The difference information quantized through the process of step S128 is locally decoded in the following way. That is, in step S129, the dequantization unit 108 dequantizes the quantized orthogonal transform coefficients (also referred to as quantized coefficients) generated through the process of step S128 using characteristics corresponding to the characteristics of the quantization unit 105. In step S130, the inverse orthogonal transform unit 109 performs an inverse orthogonal transform on the orthogonal transform coefficients obtained through the process of step S129 using characteristics corresponding to the characteristics of the orthogonal transform unit 104.

In step S131, the computation unit 110 adds the prediction image to the locally decoded difference information to generate a locally decoded image (the image corresponding to the input to the computation unit 103). In step S132, the deblocking filter 111 performs a deblocking filter process on the locally decoded image obtained through the process of step S131, if necessary.

In step S133, the frame memory 112 stores the decoded image subjected to the deblocking filter process using the process of step S132. Note that an image that is not subjected to a filter process by the deblocking filter 111 is also supplied to the frame memory 112 from the computation unit 110 for storage.

In step S134, the lossless encoding unit 106 encodes the transform coefficients quantized through the process of step S128. That is, lossless coding such as variable-length coding or arithmetic coding is performed on the difference image.

In this case, the lossless encoding unit 106 also encodes the information concerning the prediction mode of the prediction image selected through the process of step S125, and adds the encoded information to encoded data obtained by encoding the difference image. That is, the lossless encoding unit 106 also encodes optimum intra-prediction mode information supplied from the intra prediction unit 114 or information corresponding to the optimum inter-prediction mode and the like supplied from the motion prediction and compensation unit 115, and adds the encoded information to the encoded data.

In step S135, the accumulation buffer 107 accumulates the encoded data obtained through the process of step S134. The encoded data accumulated in the accumulation buffer 107 is read, as necessary, and is transmitted to the decoding side via a transmission path or a recording medium.

In step S136, the rate control unit 117 controls the rate of the quantization operation of the quantization unit 105 in accordance with the coding rate of the encoded data (generated coding rate) accumulated in the accumulation buffer 107 through the process of step S135 so as not to cause overflow or underfloor.

When the process of step S136 is completed, the encoding process ends.

### [Other Example Configuration of Quantization Initial Value Setting Unit and Lossless Encoding Unit]

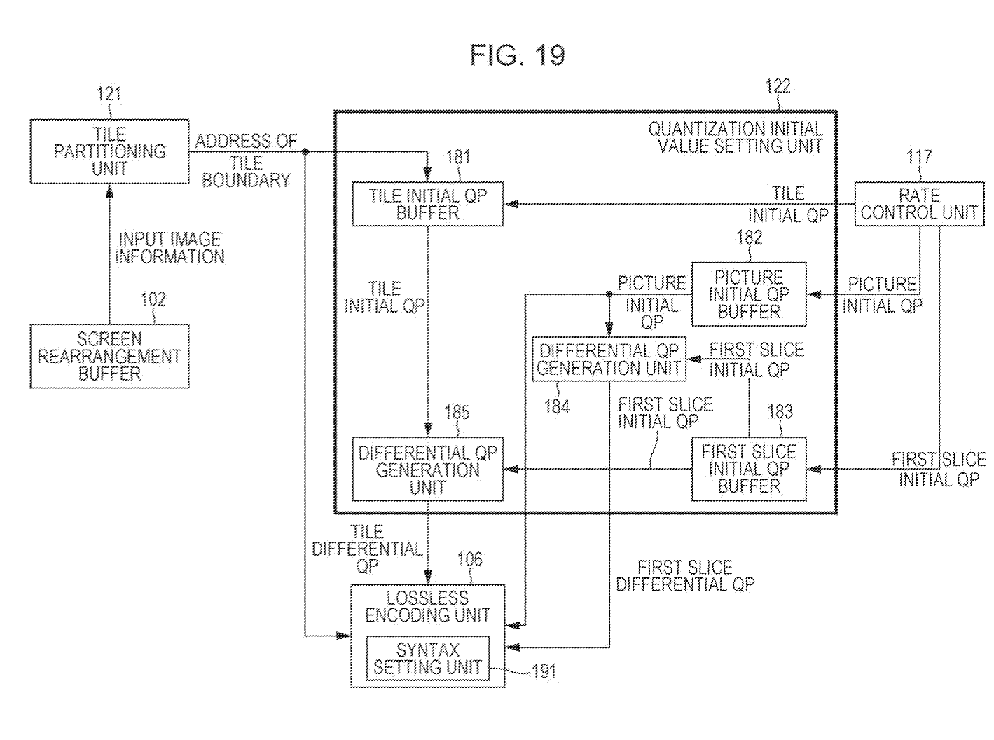

FIG. 19 is a block diagram illustrating an example main configuration of the quantization initial value setting unit 122 and the lossless encoding unit 106 that execute the first method B described above with reference to part B of FIG. 13.

In the example in FIG. 19, the quantization initial value setting unit 122 is configured to include a tile initial QP buffer 181, a picture initial QP buffer 182, a first slice initial QP buffer 183, a differential QP generation unit 184, and a differential QP generation unit 185.

The lossless encoding unit 106 is configured to include at least a syntax setting unit 191.

The address of a tile boundary is supplied from the tile partitioning unit 121 to the tile initial QP buffer 181 and the syntax setting unit 191. When the address of a tile boundary is supplied, the tile initial QP buffer 181 acquires a tile initial QP by sending a request to the rate control unit 117. The tile initial QP buffer 181 supplies the acquired tile initial QP to the differential QP generation unit 185.

A picture initial QP is supplied to the picture initial QP buffer 182 from the rate control unit 117. The picture initial QP buffer 182 supplies the picture initial QP to the differential QP generation unit 184 and the syntax setting unit 191 in accordance with a request from the differential QP generation unit 184.

An initial quantization parameter for the first slice (hereinafter referred to as the first slice initial QP) is supplied to the first slice initial QP buffer 183 from the rate control unit 117. The first slice initial QP is, for example, the quantization parameter of the initial CU included in the first slice. Alternatively, the first slice initial QP may be, for example, a value or the like close to the quantization parameter of the initial CU included in the first slice, or may be any value. The first slice initial QP buffer 183 supplies the first slice initial QP to the differential QP generation unit 184 and the differential QP generation unit 185 in accordance with a request from the differential QP generation unit 185.

When the first slice initial QP is supplied from the first slice initial QP buffer 183, the differential QP generation unit 184 acquires the picture initial QP by sending a request to the picture initial QP buffer 182. The differential QP generation unit 184 generates a first slice differential QP that is a difference between the picture initial QP and the first slice initial QP, and supplies the generated first slice differential QP to the syntax setting unit 191 as information concerning the first slice initial QP.

When the tile initial QP is supplied from the tile initial QP buffer 181, the differential QP generation unit 185 acquires the first slice initial QP by sending a request to the first slice initial QP buffer 183. The differential QP generation unit 185 generates a tile differential QP that is a difference between the first slice initial QP and the tile initial QP, and supplies the generated tile differential QP to the syntax setting unit 191 as information concerning the tile initial QP.

The syntax setting unit 191 sets syntax using, as information concerning the initial values of quantization parameters, the picture initial QP obtained from the picture initial QP buffer 182, the first slice differential QP obtained from the differential QP generation unit 184, the tile differential QP obtained from the differential QP generation unit 185, and the like.

Specifically, the syntax setting unit 191 sets the picture initial QP obtained from the picture initial QP buffer 182 in pic_init_qp_minus26 for the picture parameter set in the encoded stream. The syntax setting unit 191 further sets the first slice differential QP obtained from the differential QP generation unit 184 in slice_qp_delta in the initial slice header as the initial value of the quantization parameter for the tile. The syntax setting unit 191 sets the tile differential QP between the first slice initial QP and the tile initial QP in a transform unit of the initial CU of the corresponding tile in the encoded stream as information concerning the quantization parameter of CUs.

Similarly to the syntax setting unit 161, the syntax setting unit 191 is also supplied with tile partitioning information. The tile partitioning information is also transmitted to the decoding side, in which case, for example, as described in NPL 2, information indicating a tile boundary may be set near the beginning of a tile on the basis of the tile partitioning information.

Note that the difference between the configuration for the second method illustrated in FIG. 15 and the configuration for the first method B illustrated in FIG. 19 is as follows. That is, in the configuration for the second method in FIG. 15, the difference between the tile initial QP and the picture initial QP is encoded at the beginning of each tile. In the configuration for the first method B illustrated in FIG. 19, in contrast, the difference between the tile initial QP and the first slice initial QP is encoded.

Further, the flow of an encoding process for the first method B is basically similar to the encoding process described above with reference to FIG. 16, except for the setting process of the quantization parameter initial value of each tile in step S102. Thus, a description will now be given of an example of step S102 of FIG. 16 for the first method B.

### [Flow of Setting Process of Quantization Parameter Initial Value of Each Tile]

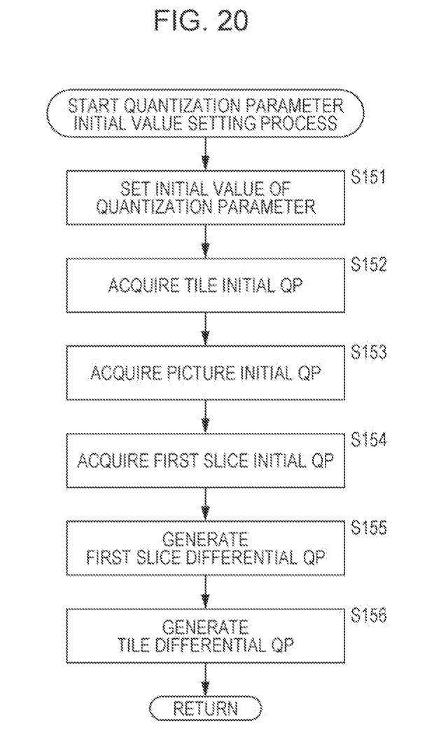

Next, another example of the setting process of the quantization parameter initial value of each tile in step S102 of FIG. 16 will be described with reference to a flowchart in FIG. 20.

In step S151, the quantization initial value setting unit 122 sets, as the initial value of a quantization parameter, slice_qp_delta in the first slice header, which is involved in the first method B described above with reference to part B of FIG. 13.

When the address of a tile boundary is supplied, then in step S152, the tile initial QP buffer 181 acquires a tile initial QP by sending a request to the rate control unit 117. The tile initial QP buffer 181 supplies the acquired tile initial QP to the differential QP generation unit 185.

In step S153, the differential QP generation unit 184 acquires a picture initial QP by sending a request to the picture initial QP buffer 152. In this case, the picture initial QP is also supplied to the syntax setting unit 191.

In step S154, the differential QP generation unit 184 and the differential QP generation unit 185 acquire a first slice initial QP by sending a request to the first slice initial QP buffer 183.

In step S155, the differential QP generation unit 184 generates a first slice differential QP between the picture initial QP and the first slice initial QP. The differential QP generation unit 153 supplies the generated first slice differential QP to the syntax setting unit 161 as the initial value of the quantization parameter for the tile.

In step S156, the differential QP generation unit 185 generates a tile differential QP between the first slice initial QP and the tile initial QP. The differential QP generation unit 185 supplies the generated tile differential QP to the syntax setting unit 161 as information concerning the quantization parameter of CUs.

In response to this, in step S103 of FIG. 16, the syntax setting unit 161 executes an encoding process of the information concerning the quantization parameter initial values. For example, in the first method B, the syntax setting unit 191 sets, in the encoding process, the picture initial QP obtained from the picture initial QP buffer 182 in pic_init_qp_minus26 for the picture parameter set in the encoded stream.

The syntax setting unit 191 further sets the first slice differential QP obtained from the differential QP generation unit 184 in slice_qp_delta for the initial slice header as the initial value of the quantization parameter for the tile. The syntax setting unit 191 sets the tile differential QP between the first slice initial QP and the tile initial QP in a transform unit of the initial CU of the corresponding tile in the encoded stream as information concerning the quantization parameter of CUs.

As described above, the image encoding device 100 is configured to set the initial value of the quantization parameter for a tile so as to ensure that processes related to quantization parameters for tiles are independent in order to keep processes related to quantization parameters for tiles from being dependent on each other.

This enables parallel processing based on tile partitioning to be performed on the decoding side, described just below, while enabling an intra-frame quantization control process.

Note that whereas the first method described above with reference to FIG. 3 involves no modifications to the syntax described above with reference to FIG. 5 to FIG. 11, the second method described above with reference to FIG. 4 involves modifications to the sequence parameter set and the picture parameter set.

### [Example of Syntax for Second Method]

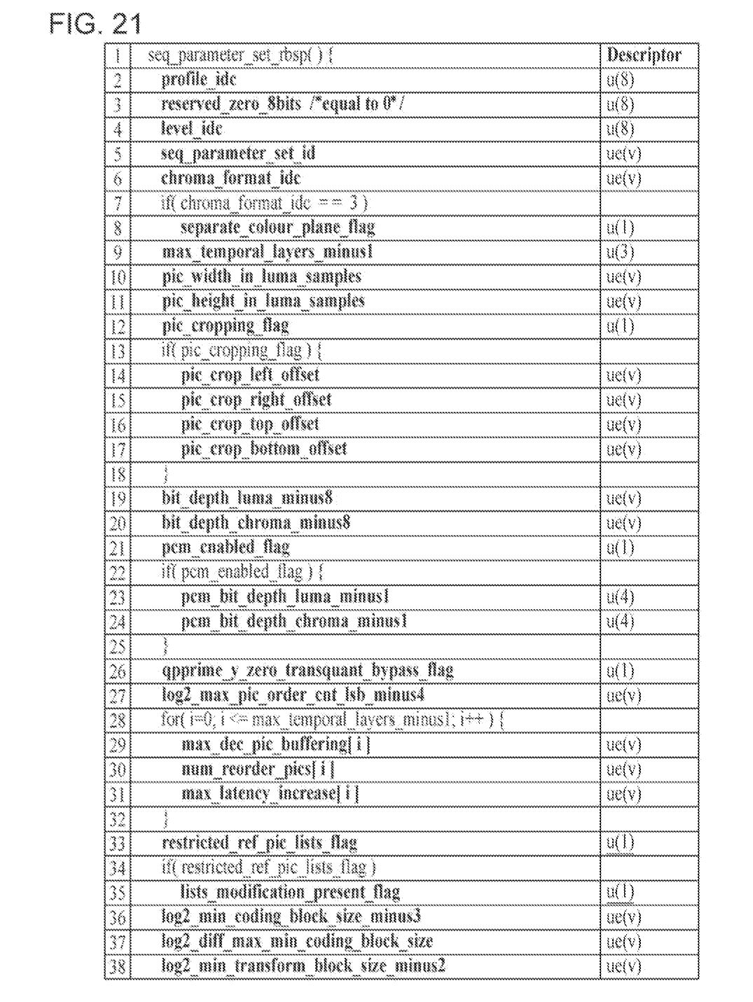

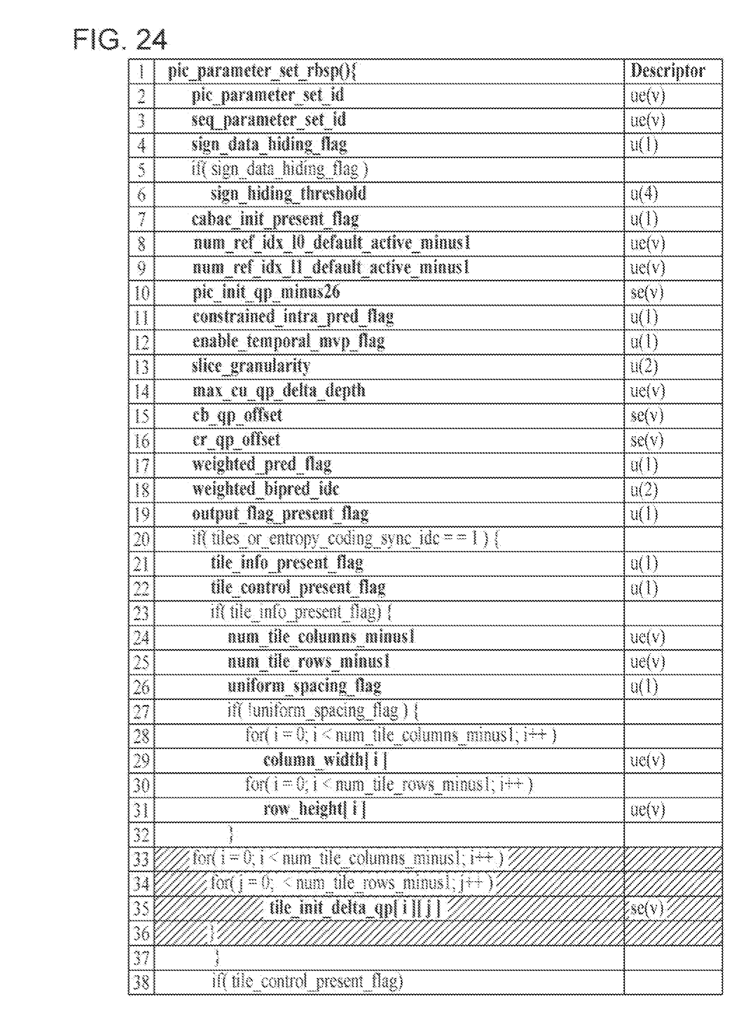

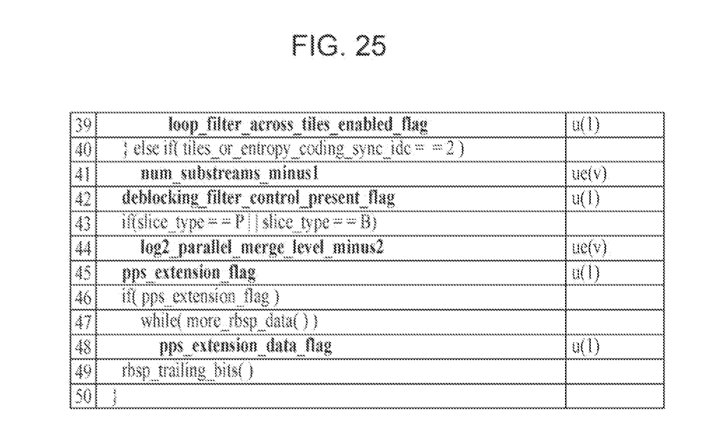

FIG. 21 to FIG. 23 are diagrams illustrating an example of the syntax for the sequence parameter set, and FIG. 24 and FIG. 25 are diagrams illustrating an example of the syntax for the picture parameter set. Numbers on the left of the respective rows represent line numbers given for description.

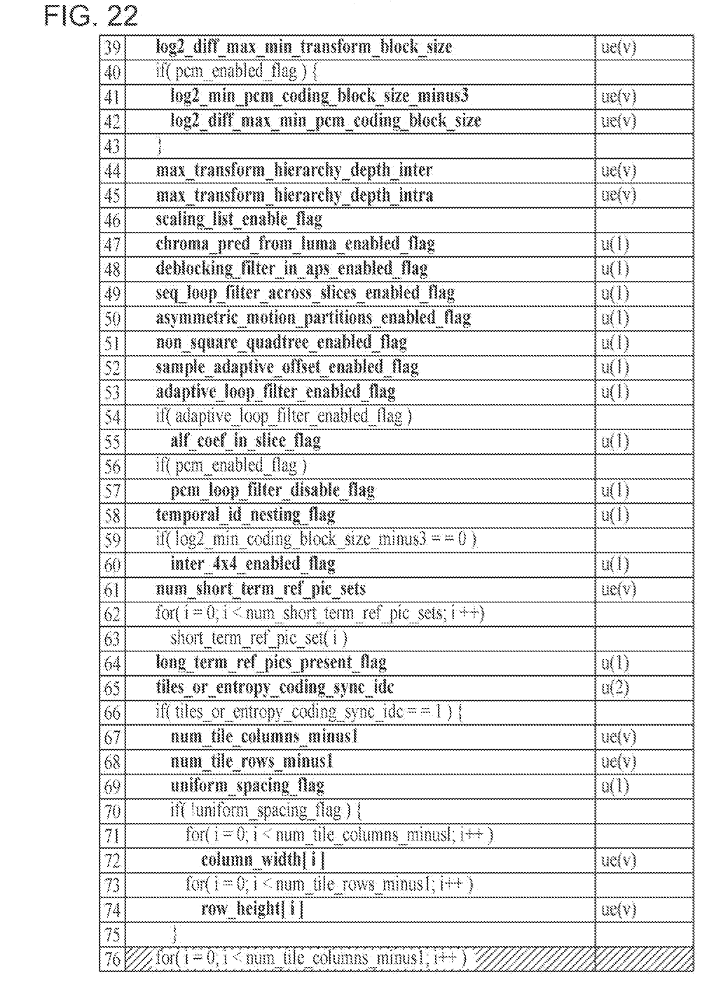

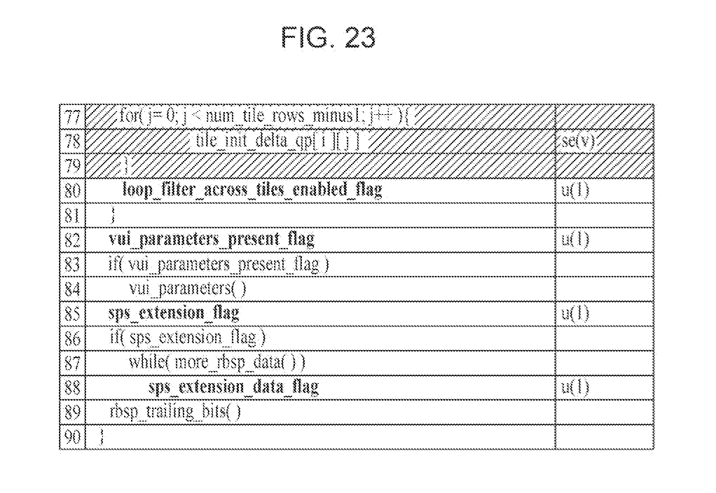

In the seventy-sixth row to seventy-ninth row in FIG. 22 to FIG. 23 and the thirty-third row to thirty-sixth row in FIG. 24, tile_init_delta_qp, which represents information concerning the initial value of the quantization parameter for each tile, is set. tile_init_delta_qp is a difference value between the initial value of the quantization parameter for each tile and the initial value of the quantization parameter for the picture. In this case, tile_init_delta_qp represents a sequence value since information regarding all the tiles is written together here.

Note that, in the second method, instead of the sequence parameter set and the picture parameter set described above being modified, slice data may be modified in a manner below.

### [Other Example of Syntax for Second Method]

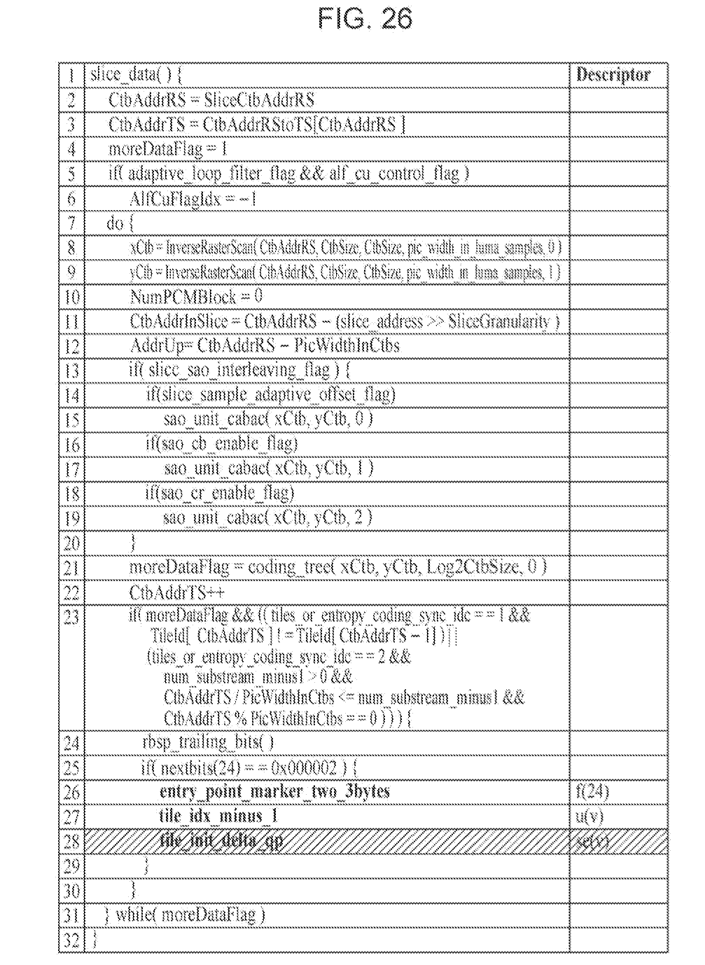

FIG. 26 is a diagram illustrating an example of the syntax for slice data. Numbers on the left of the respective rows represent line numbers given for description.

In FIG. 26, entry_point_marker_two_{—}3bytes is set in the twenty-sixth row. entry_point_marker_two_{—}3bytes is information (a marker of an entry point) indicating the beginning of a tile, which is proposed in NPL 2.

In the twenty-eighth row, tile_init_delta_qp, which represents information concerning the initial value of the quantization parameter for each tile, is set. tile_init_delta_qp is a difference value between the initial value of the quantization parameter for each tile and the initial value of the quantization parameter for the picture. In the example in FIG. 26, since information concerning the initial values of quantization parameters is written on a tile-by-tile basis, information concerning the initial value of the quantization parameter for a tile is a scalar value.

That is, in the slice data in FIG. 26, the marker in the twenty-sixth row plays the role of an entry point. Thus, information concerning the initial value of the quantization parameter for each tile can be set at the entry point (after the entry point) included in the slice data, and can be transmitted to the decoding side.

Note that, in the example in FIG. 22 to FIG. 25, information concerning the initial values of the quantization parameters for all the tiles can be written together in the image compression information, thus giving the advantage of requiring only a small amount of processing.

In contrast, the example in FIG. 26 has the advantage that there is no need to return to the sequence parameter set and the picture parameter set and to perform two-pass encoding to determine a tile initial quantization parameter difference in accordance with the operation of the rate control unit 117.

### 2. Second Embodiment

### Image Decoding Device

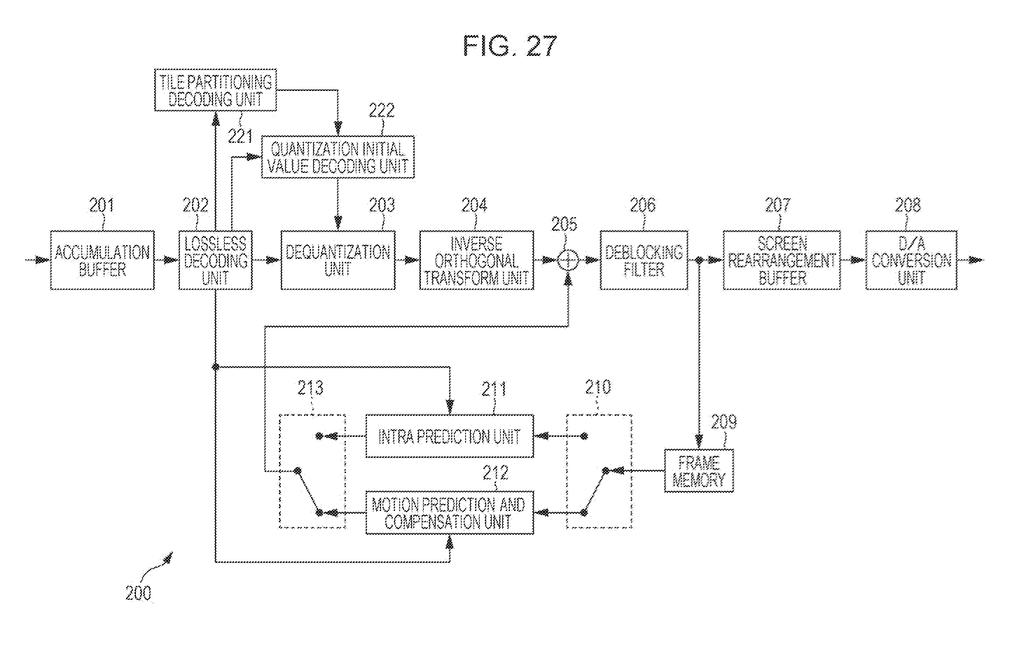

Next, a description will be given of the decoding of encoded data (encoded stream) that is encoded in the way described above. FIG. 27 is a block diagram illustrating an example main configuration of an image decoding device corresponding to the image encoding device 100 in FIG. 1.

An image decoding device 200 illustrated in FIG. 27 decodes encoded data generated by the image encoding device 100 in FIG. 1 using a decoding method corresponding to the encoding method. Note that the image decoding device 200 is configured to perform inter prediction on each prediction unit (PU) in a manner similar to that of the image encoding device 100.

Further, in the image encoding device 100 in FIG. 1, how the picture is partitioned into tiles is set by a user, and parallel processing is executed in accordance with the setting. In the image decoding device 200 in FIG. 27, on the other hand, an encoded stream, which is an input, and tile partitioning information that is information concerning how tile partitioning is to be performed are transmitted, according to which parallel processing is performed.

As illustrated in FIG. 27, the image decoding device 200 includes an accumulation buffer 201, a lossless decoding unit 202, a dequantization unit 203, an inverse orthogonal transformer 204, a computation unit 205, a deblocking filter 206, a screen rearrangement buffer 207, and a D/A conversion unit 208. The image decoding device 200 also includes a frame memory 209, a selection unit 210, an intra prediction unit 211, a motion prediction and compensation unit 212, and a selection unit 213.

The image decoding device 200 further includes a tile partitioning decoding unit 221 and a quantization initial value decoding unit 222.

The accumulation buffer 201 also serves as a receiving unit configured to receive transmitted encoded data. The accumulation buffer 201 receives and accumulates transmitted encoded data, and supplies the encoded data to the lossless decoding unit 202 at a predetermined timing.

The lossless decoding unit 202 acquires information added to the encoded data, such as information concerning quantization parameter initial values of the picture of interest and tile partitioning information. The lossless decoding unit 202 supplies the information concerning quantization parameter initial values of the picture of interest to the quantization initial value decoding unit 222, and supplies the tile partitioning information to the tile partitioning decoding unit 221.

Additionally, in addition to DCT coefficients, information necessary for decoding, such as prediction mode information and motion vector information, is added as information lower than the slice header of the encoded data. The lossless decoding unit 202 decodes the information supplied from the accumulation buffer 201, which has been encoded by the lossless encoding unit 106 in FIG. 1, using a scheme corresponding to the encoding scheme of the lossless encoding unit 106. The lossless decoding unit 202 supplies quantized coefficient data of a difference image obtained through decoding to the dequantization unit 203.

Furthermore, the lossless decoding unit 202 determines whether an intra prediction mode or an inter prediction mode has been selected as the optimum prediction mode. The lossless decoding unit 202 supplies information concerning the optimum prediction mode to one of the intra prediction unit 211 and the motion prediction and compensation unit 212 associated with the mode determined to have been selected. That is, for example, if the inter prediction mode has been selected as the optimum prediction mode by the image encoding device 100, information concerning the optimum prediction mode is supplied to the motion prediction and compensation unit 212.

The dequantization unit 203 dequantizes the quantized coefficient data obtained through decoding by the lossless decoding unit 202 using the initial value of the quantization parameter for a tile, which is obtained from the quantization initial value decoding unit 222, in accordance with a scheme corresponding to the quantization scheme of the quantization unit 105 in FIG. 1, and supplies obtained coefficient data to the inverse orthogonal transformer 204.

The inverse orthogonal transformer 204 performs an inverse orthogonal transform on the coefficient data supplied from the dequantization unit 203 using a scheme corresponding to the orthogonal transform scheme of the orthogonal transform unit 104 in FIG. 1. Through the inverse orthogonal transform process described above, the inverse orthogonal transformer 204 obtains decoded residual data corresponding to residual data that has not yet been subjected to an orthogonal transform by the image encoding device 100.

The decoded residual data obtained through the inverse orthogonal transform is supplied to the computation unit 205. Further, a prediction image is also supplied to the computation unit 205 from the intra prediction unit 211 or the motion prediction and compensation unit 212 via the selection unit 213.

The computation unit 205 adds together the decoded residual data and the prediction image to obtain decoded image data corresponding to image data from which the prediction image has not yet been subtracted by the computation unit 103 of the image encoding device 100. The computation unit 205 supplies the decoded image data to the deblocking filter 206.

The deblocking filter 206 performs a deblocking filter process on the supplied decoded image, if necessary, and supplies the resulting decoded image to the screen rearrangement buffer 207. The deblocking filter 206 performs a deblocking filter process on the decoded image to remove block distortion from the decoded image.

The deblocking filter 206 supplies the result of the filter process (the decoded image subjected to the filter process) to the screen rearrangement buffer 207 and the frame memory 209. Note that the decoded image output from the computation unit 205 may be supplied to the screen rearrangement buffer 207 or the frame memory 209 without passing through the deblocking filter 206. That is, the filter process performed by the deblocking filter 206 may be omitted.

The screen rearrangement buffer 207 performs image rearrangement. Note that, although not illustrated in FIG. 27, field coding information is supplied to the screen rearrangement buffer 207 from the tile partitioning decoding unit 221 or the like, and the screen rearrangement buffer 207 performs image rearrangement in accordance with the field coding information. That is, the frames rearranged in coding order by the screen rearrangement buffer 102 in FIG. 1 are reordered in original, display order. The D/A conversion unit 208 performs D/A conversion on the image supplied from the screen rearrangement buffer 207, and outputs the resulting image to an unillustrated display for display.

The frame memory 209 stores the decoded image supplied thereto, and supplies the stored decoded image to the selection unit 210 as a reference image at a predetermined timing or in accordance with an external request from the intra prediction unit 211, the motion prediction and compensation unit 212, or the like.

The selection unit 210 selects the destination of the reference image supplied from the frame memory 209. When decoding an intra-coded image, the selection unit 210 supplies the reference image supplied from the frame memory 209 to the intra prediction unit 211. Further, when decoding an inter-coded image, the selection unit 210 supplies the reference image supplied from the frame memory 209 to the motion prediction and compensation unit 212.

Information indicating an intra prediction mode and the like, which are obtained by decoding the header information, are supplied to the intra prediction unit 211 from the lossless decoding unit 202, as necessary. The intra prediction unit 211 performs intra prediction using the reference image acquired from the frame memory 209 in the intra prediction mode used in the intra prediction unit 114 in FIG. 1, and generates a prediction image. The intra prediction unit 211 supplies the generated prediction image to the selection unit 213.

The motion prediction and compensation unit 212 acquires, from the lossless decoding unit 202, information (such as optimum prediction mode information, motion vector information, and reference image information) obtained by decoding the header information.

The motion prediction and compensation unit 212 performs inter prediction using the reference image acquired from the frame memory 209 in the inter prediction mode indicated by the optimum prediction mode information acquired from the lossless decoding unit 202, and generates a prediction image.

The selection unit 213 supplies the prediction image obtained from the intra prediction unit 211 or the prediction image obtained from the motion prediction and compensation unit 212 to the computation unit 205. Then, the computation unit 205 adds together a prediction image generated using motion vectors and the decoded residual data (difference image information) obtained from the inverse orthogonal transformer 204, and decodes the original image. That is, the motion prediction and compensation unit 212, the lossless decoding unit 202, the dequantization unit 203, the inverse orthogonal transformer 204, and the computation unit 205 also serve as a decoding unit configured to decode encoded data using motion vectors to generate an original image.

The tile partitioning decoding unit 221 acquires the tile partitioning information obtained from the lossless decoding unit 202, and supplies the tile partitioning information to the quantization initial value decoding unit 222.

The quantization initial value decoding unit 222 reconfigures the initial value of the quantization parameter for a tile using the tile partitioning information obtained from the tile partitioning decoding unit 221 and also using information concerning the initial value of the quantization parameter of the picture of interest obtained from the lossless decoding unit 202. The quantization initial value decoding unit 222 supplies the reconfigured initial value of the quantization parameter for the tile to the dequantization unit 203.

### [Example Configuration of Lossless Decoding Unit and Quantization Initial Value Decoding Unit]

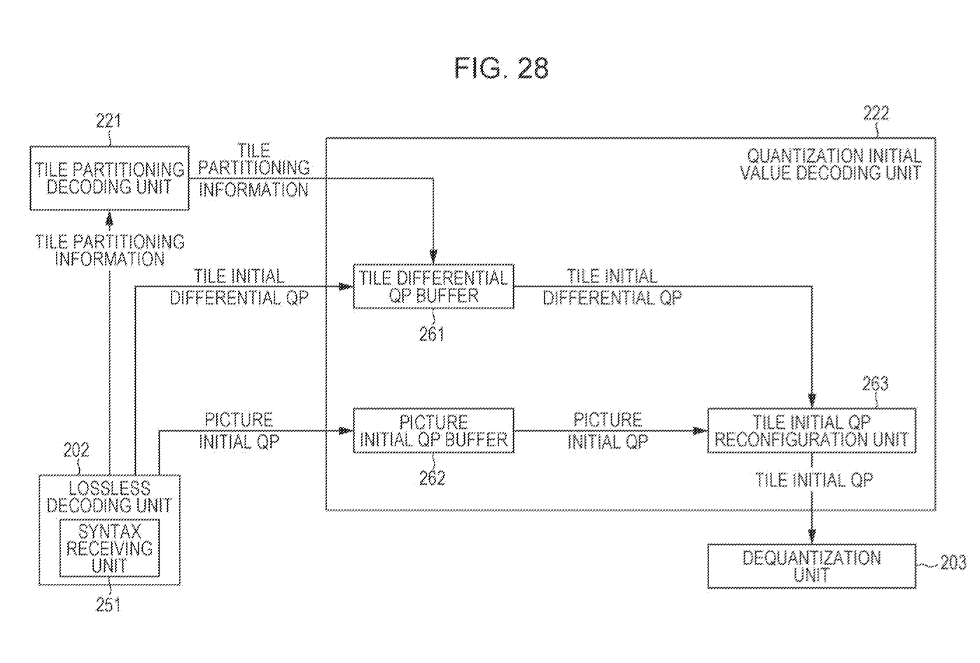

FIG. 28 is a block diagram illustrating an example main configuration of the lossless decoding unit 202 and the quantization initial value decoding unit 222 that execute the second method described above with reference to FIG. 14. That is, the blocks on the decoding side illustrated in FIG. 28 correspond to the blocks on the encoding side illustrated in FIG. 15.

In the example in FIG. 28, the lossless decoding unit 202 is configured to include a syntax receiving unit 251.

The tile partitioning decoding unit 221 is configured to include a tile differential QP buffer 261, a picture initial QP buffer 262, and a tile initial QP reconfiguration unit 263.

The syntax receiving unit 251 acquires tile partitioning information from the encoded stream, and supplies the acquired tile partitioning information to the tile partitioning decoding unit 221. The syntax receiving unit 251 acquires a picture initial QP, a tile initial differential QP, and so on as information concerning quantization parameter initial values of the picture of interest, and supplies the acquired information to the quantization initial value decoding unit 222.

Specifically, the syntax receiving unit 251 acquires the picture initial QP from the sequence parameter set in the encoded stream, and supplies the acquired picture initial QP to the picture initial QP buffer 262. The syntax receiving unit 251 further acquires the tile initial differential QP (the differential QP in FIG. 15) that is information concerning the tile initial QP from near the beginning of each tile in the encoded stream, and supplies the acquired tile initial differential QP to the tile differential QP buffer 261.

The tile differential QP buffer 261 refers to the tile partitioning information obtained from the tile partitioning decoding unit 221, and supplies the tile initial differential QP obtained from the syntax receiving unit 251 to the tile initial QP reconfiguration unit 263 at the timing of the address of a tile boundary.

The picture initial QP buffer 262 supplies the picture initial QP obtained from the syntax receiving unit 251 to the tile initial QP reconfiguration unit 263.

The tile initial QP reconfiguration unit 263 reconfigures the tile initial QP using the tile initial differential QP obtained from the tile differential QP buffer 261 and the picture initial QP obtained from the picture initial QP buffer 262, and supplies the reconfigured tile initial QP to the dequantization unit 203.

Note that, although not illustrated in the example in FIG. 28, similarly to a conventional configuration, a difference between the initial value of the quantization parameter for a tile and the quantization parameter of the initial CU in the tile is set in a transform unit of the initial CU in the tile as information concerning the quantization parameter of CUs. Thus, for example, in the dequantization unit 203, the quantization parameter of the initial CU in the tile is reconfigured using the tile initial QP obtained from the tile initial QP reconfiguration unit 263, and is used.

Furthermore, although an example of the second method is illustrated in the example in FIG. 28, the first method A illustrated in part A of FIG. 13 may also be performed using the functional blocks in FIG. 28.

Note that, in the first method A, the syntax receiving unit 251 acquires the initial value of the quantization parameter for a tile, the QP difference of the initial CU of the tile, and so on as information concerning quantization parameter initial values of the picture of interest.

That is, a difference from the second method is that the syntax receiving unit 251 receives the picture initial QP from the picture parameter set in the encoded stream as the initial value of the quantization parameter for the tile. Another difference from the second method is that, in the first method A, the syntax receiving unit 251 receives the tile initial differential QP from a transform unit of the initial CU of the corresponding tile in the encoded stream, as the QP difference of the initial CU of the tile.

[Flow of Decoding Process]

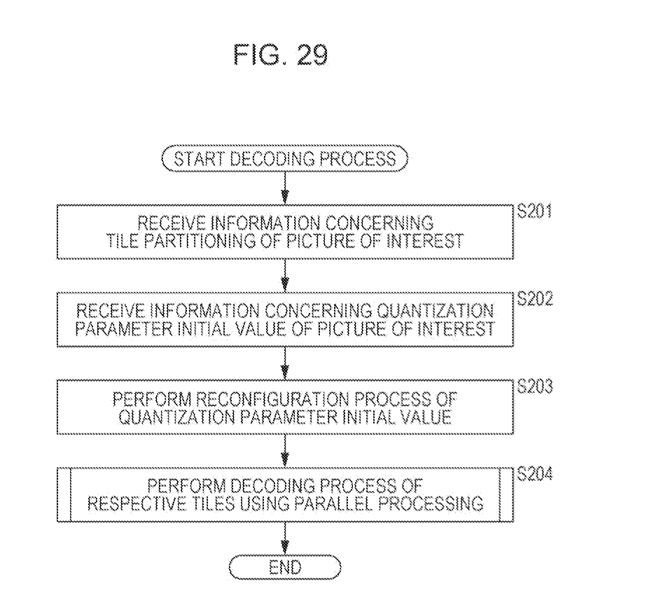

Next, a description will be given of the flow of individual processes executed by the image decoding device 200 as described above. First, the flow of a decoding process for the second method will be described with reference to a flowchart in FIG. 29.

In step S201, the quantization initial value decoding unit 222 receives information concerning tile partitioning of the picture of interest from the syntax receiving unit 251 via the tile partitioning decoding unit 221.

In step S202, the quantization initial value decoding unit 222 receives information concerning quantization parameter initial values of the picture of interest from the syntax receiving unit 251.

Specifically, the tile differential QP buffer 261 receives a tile initial differential QP from the syntax receiving unit 251 as a piece of the information concerning quantization parameter initial values of the picture of interest. The picture initial QP buffer 262 receives a picture initial QP from the syntax receiving unit 251 as a piece of the information concerning quantization parameter initial values of the picture of interest.

Then, the tile differential QP buffer 261 supplies the received tile initial differential QP to the tile initial QP reconfiguration unit 263. The picture initial QP buffer 262 supplies the received tile initial differential QP to the tile initial QP reconfiguration unit 263.

In step S203, the tile initial QP reconfiguration unit 263 reconfigures the quantization parameter initial value. That is, the tile initial QP reconfiguration unit 263 adds together the tile initial differential QP and the picture initial QP to reconfigure the tile initial QP. The tile initial QP reconfiguration unit 263 supplies the reconfigured tile initial QP to the dequantization unit 203.

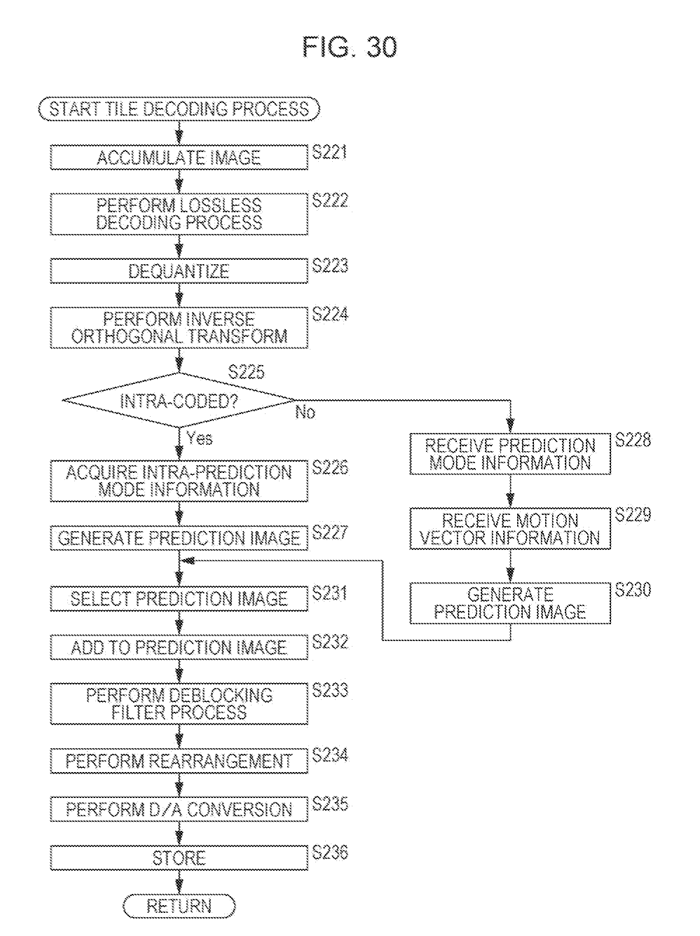

After that, in step S204, the individual units of the image decoding device 200 perform a decoding process of the respective tiles by using parallel processing. The decoding process of each tile is a decoding process of information lower than the slice header, such as DCT coefficients and motion vectors for each tile. The decoding process of each tile will be described below with reference to FIG. 30.

Through the decoding process of each tile in step S204, the information and the lower-level information for each tile is decoded, and the image encoded by the image encoding device 100 is reconfigured. Then, the process ends.

### [Flow of Tile Decoding Process]

Next, the tile decoding process in step S204 of FIG. 29 will be described with reference to a flowchart in FIG. 30.

When the tile decoding process is started, then in step S221, the accumulation buffer 201 receives and accumulates the transmitted encoded stream. In step S222, the lossless decoding unit 202 decodes the encoded stream (encoded difference image information) supplied from the accumulation buffer 201. That is, the I-pictures, P-pictures, and B-pictures encoded by the lossless encoding unit 106 in FIG. 1 are decoded.

In this case, various pieces of information other than difference image information included in the encoded stream, such as header information, are also decoded. The lossless decoding unit 202 acquires, for example, prediction mode information, motion vector information, and so on. The lossless decoding unit 202 supplies the acquired information to the associated units.

In step S223, the dequantization unit 203 dequantizes the quantized orthogonal transform coefficients obtained through the process of step S222. In this case, the dequantization unit 203 uses the tile initial QP obtained from the quantization initial value decoding unit 222 as the quantization parameter of the initial CU of the tile, or uses the quantization parameter of the initial CU of the tile, which is calculated from the tile initial QP. Note that, as described above with reference to FIG. 11, as the quantization parameter of a CU having a size smaller than a designated size, for example, a quantization parameter for a correlated neighboring region among neighboring regions is used. In step S224, the inverse orthogonal transformer 204 performs an inverse orthogonal transform on the orthogonal transform coefficients dequantized in step S223.

In step S225, the lossless decoding unit 202 determines whether or not the encoded data to be processed has been intra-coded, on the basis of information concerning the optimum prediction mode, which is decoded in step S222. If it is determined that the encoded data to be processed has been intra-coded, the process proceeds to step S226.

In step S226, the intra prediction unit 211 acquires intra-prediction mode information. In step S227, the intra prediction unit 211 performs intra prediction using the intra-prediction mode information acquired in step S226, and generates a prediction image.

Further, if it is determined in step S226 that the encoded data to be processed has not been intra-coded, that is, the encoded data to be processed has been inter-coded, the process proceeds to step S228.

The motion prediction and compensation unit 212 acquires inter-prediction mode information in step S228, and acquires motion vector information in step S229.

In step S230, the motion prediction and compensation unit 212 generates a prediction image in the inter prediction mode acquired in step S228 using the motion vectors acquired in step S229. The generated prediction image is supplied to the selection unit 213.

In step S231, the selection unit 213 selects the prediction image generated in step S227 or the prediction image generated in step S230. In step S232, the computation unit 205 adds the prediction image selected in step S231 to the difference image information obtained through the inverse orthogonal transform in step S224. Accordingly, the original image is decoded. That is, a prediction image is generated using motion vectors, and the generated prediction image and the difference image information obtained from the inverse orthogonal transformer 204 are added together to decode the original image.

In step S233, the deblocking filter 206 performs a deblocking filter process on the decoded image obtained in step S232, if necessary.

In step S234, the screen rearrangement buffer 207 performs rearrangement on the image subjected to the filter process in step S233. That is, frames rearranged for coding by the screen rearrangement buffer 102 of the image encoding device 100 are reordered in original, display order.

In step S235, the D/A conversion unit 208 performs D/A conversion on the image whose frames have been reordered in step S234. The resulting image is output to an unillustrated display, and an image is displayed.

In step S236, the frame memory 209 stores the images subjected to the filter process in step S235.

When the process of step S236 is completed, the decoding process ends.

[Other Example Configuration of Lossless Decoding Unit and Quantization Initial Value Decoding Unit]

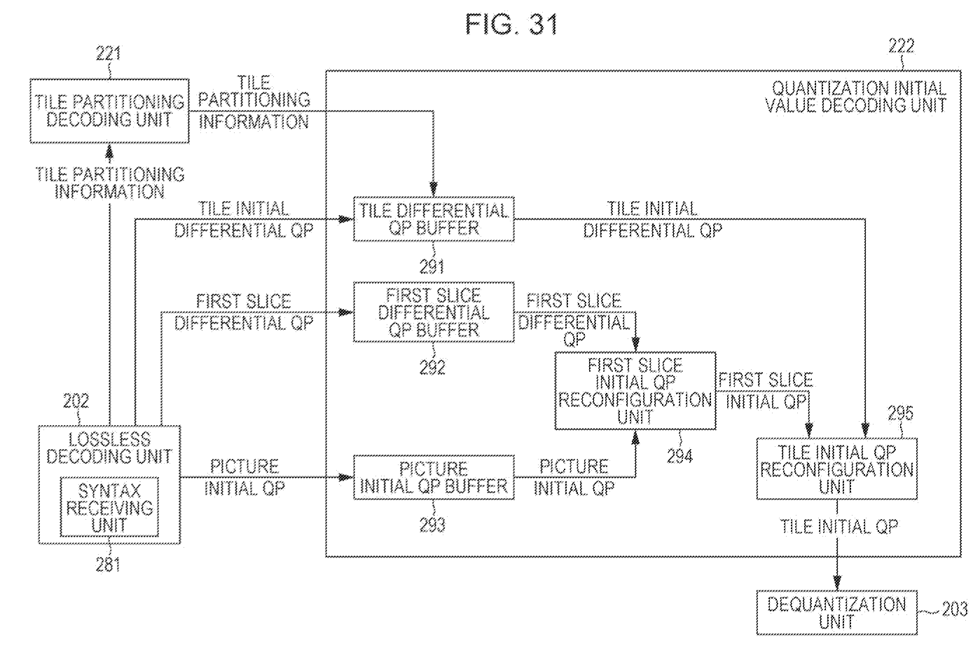

FIG. 31 is a block diagram illustrating an example main configuration of the lossless decoding unit 202 and the quantization initial value decoding unit 222 that execute the first method B described above with reference to part B of FIG. 13. That is, the blocks on the decoding side illustrated in FIG. 31 correspond to the blocks on the encoding side illustrated in FIG. 19.

In the example in FIG. 31, the lossless decoding unit 202 is configured to include a syntax receiving unit 281.

The quantization initial value decoding unit 222 is configured to include a tile differential QP buffer 291, a first slice differential QP buffer 292, a picture initial QP buffer 293, a first slice initial QP reconfiguration unit 294, and a tile initial QP reconfiguration unit 295.

The syntax receiving unit 281 acquires tile partitioning information from the encoded stream, and supplies the acquired tile partitioning information to the tile partitioning decoding unit 221. The syntax receiving unit 281 acquires a first slice differential QP from the first slice header of the encoded stream as the initial value of the quantization parameter for a tile, and supplies the acquired first slice differential QP to the first slice differential QP buffer 292.

The syntax receiving unit 281 further acquires a picture initial QP from the picture parameter set of the encoded stream as information for reconfiguring the initial value of the quantization parameter for the tile, and supplies the picture initial QP to the picture initial QP buffer 293. Furthermore, the syntax receiving unit 281 acquires a tile initial differential QP (the tile differential QP in FIG. 19), which is information concerning the tile initial QP, from a transform unit of the initial CU of each tile in the encoded stream, as a QP difference of the initial CU of the tile. The syntax receiving unit 281 supplies the acquired tile initial differential QP to the tile differential QP buffer 291.

The tile differential QP buffer 291 refers to the tile partitioning information obtained from the tile partitioning decoding unit 221, and supplies the tile initial differential QP obtained from the syntax receiving unit 281 to the tile initial QP reconfiguration unit 295 at the timing of the address of a tile boundary.

The first slice differential QP buffer 292 supplies the first slice differential QP obtained from the syntax receiving unit 281 to the first slice initial QP reconfiguration unit 294.

The picture initial QP buffer 293 supplies the picture initial QP obtained from the syntax receiving unit 281 to the first slice initial QP reconfiguration unit 294.

The first slice initial QP reconfiguration unit 294 reconfigures the first slice initial QP using the first slice differential QP obtained from the first slice differential QP buffer 292 and also using the picture initial QP obtained from the picture initial QP buffer 293. The tile initial QP reconfiguration unit 295 supplies the reconfigured first slice initial QP to the dequantization unit 203.

The tile initial QP reconfiguration unit 295 reconfigures the tile initial QP using the tile initial differential QP obtained from the tile differential QP buffer 291 and also using the first slice initial QP obtained from the first slice initial QP reconfiguration unit 294, and supplies the reconfigured tile initial QP to the dequantization unit 203.

Note that the difference between the configuration for the second method illustrated in FIG. 28 and the configuration for the first method B illustrated in FIG. 31 is as follows. That is, in the configuration for the second method in FIG. 28, the initial QP of each tile is reconfigured based on the picture initial QP that is the initial value of the quantization parameter for the tile. In the configuration for the first method B illustrated in FIG. 31, in contrast, the initial QP of each tile (the quantization parameter of the initial CU of the tile) is reconfigured based on the first slice initial QP for the picture, which is the initial value of the quantization parameter for the tile.

### [Flow of Decoding Process]

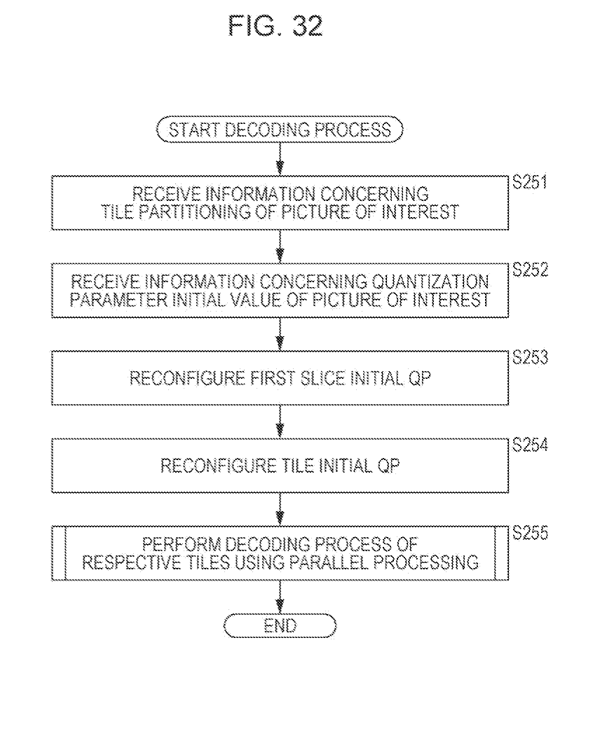

Next, an example of the flow of a decoding process for the first method B will be described with reference to a flowchart in FIG. 32.

In step S251, the quantization initial value decoding unit 222 receives information concerning tile partitioning of the picture of interest from the syntax receiving unit 281 via the tile partitioning decoding unit 221.

In step S252, the quantization initial value decoding unit 222 receives information concerning quantization parameter initial values of the picture of interest from the syntax receiving unit 281.

Specifically, the tile differential QP buffer 291 receives a tile initial differential QP (the quantization parameter of the initial CU of the tile) from the syntax receiving unit 281 as a piece of the information concerning quantization parameter initial values of the picture of interest. The first slice differential QP buffer 292 receives a first slice differential QP from the syntax receiving unit 281 as a piece of the information concerning quantization parameter initial values of the picture of interest. The picture initial QP buffer 293 receives a picture initial QP from the syntax receiving unit 251 as a piece of the information concerning quantization parameter initial values of the picture of interest.

Then, the tile differential QP buffer 261 supplies the received tile initial differential QP to the tile initial QP reconfiguration unit 295. The first slice differential QP buffer 292 supplies the received first slice differential QP to the first slice initial QP reconfiguration unit 294. The picture initial QP buffer 262 supplies the received first slice differential QP to the first slice initial QP reconfiguration unit 294.

In step S253 and S254, the first slice initial QP reconfiguration unit 294 and the tile initial QP reconfiguration unit 295 reconfigure initial value of quantization parameters.

Specifically, in step S253, the first slice initial QP reconfiguration unit 294 adds together the first slice differential QP and the picture initial QP to reconfigure the first slice initial QP. The first slice initial QP reconfiguration unit 294 supplies the reconfigured first slice initial QP to the tile initial QP reconfiguration unit 295.

In step S254, the tile initial QP reconfiguration unit 295 adds together the tile initial differential QP and the first slice initial QP to reconfigure the tile initial QP. The tile initial QP reconfiguration unit 263 supplies the reconfigured tile initial QP to the dequantization unit 203 as the quantization parameter of the initial CU of the tile.

After that, in step S255, the individual units of the image decoding device 200 perform a decoding process of the respective tiles by using parallel processing, as described above with reference to FIG. 30.

Through the decoding process of each tile in step S255, the information and the lower-level information for each tile is decoded, and the image encoded by the image encoding device 100 is reconfigured. Then, the process ends.

By performing the respective processes in the way described above, the image decoding device 200 can accurately decode encoded data that is encoded by the image encoding device 100, achieving improvements in coding efficiency.

That is, in the image encoding device 100, the initial value of the quantization parameter for a tile is set so as to ensure that processes related to quantization parameters for tiles are independent, and information concerning initial values of quantization parameters is delivered.

By decoding (reconfiguring) information concerning initial values of quantization parameters using such information as described above and by using the decoded information, the image decoding device 200 can perform processes related to quantization parameters for tiles in parallel. Thus, processing efficiency for decoding is improved.

Note that while the foregoing description has been made of a case complying with HEVC by way of example, the application range of the present technology is not limited to examples complying with HEVC. The present technology may also be applied to devices configured to perform tile partitioning, to perform tile-based parallel processing, and to perform an encoding process and a decoding process even if the devices adopt other coding schemes.

In addition, the present technology may also be applied to, for example, an image encoding device and an image decoding device used to receive image information (bit stream) compressed using an orthogonal transform such as a discrete cosine transform and motion compensation, such as MPEG or H.26x, via a network medium such as satellite broadcasting, cable television, the Internet, or a mobile phone. The present technology may also be applied to an image encoding device and an image decoding device used for processing on storage media such as optical disks, magnetic disks, and flash memories. Furthermore, the present technology may also be applied to a motion prediction and compensation device included in the image encoding device, the image decoding device, and the like.

### 3. Third Embodiment

### Application to Multi-View Image Encoding/Multi-View Image Decoding

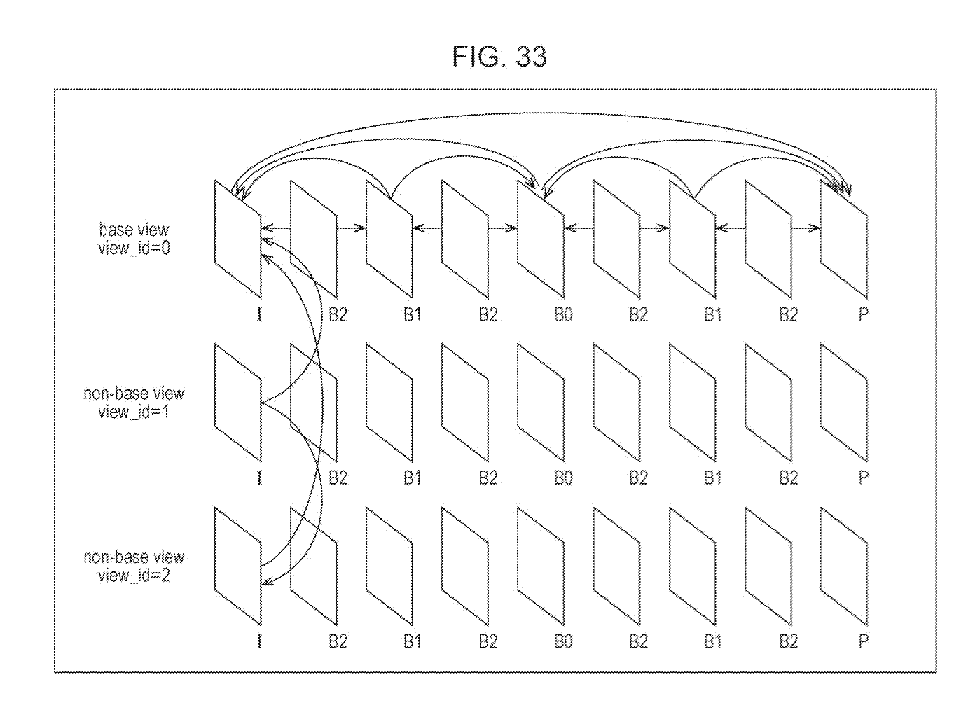

The series of processes described above may be applied to multi-view image encoding/multi-view image decoding. FIG. 33 illustrates an example of a multi-view image encoding scheme.

A illustrated in FIG. 33, multi-view images include images at a plurality of views, and an image at a predetermined one of the plurality of views is designated as an image of a base view. The images of the respective views other than the image of the base view are handled as images of non-base views.

In a case where multi-view image encoding as in FIG. 33 is performed, parameters such as the (information concerning) initial values of quantization parameters and tile partitioning information described above may be set for each view (the same view). Note that, in the following, for the sake of description, tile partitioning information is omitted and only initial values of quantization parameters are described as an example of the parameters. In addition, in each view (different views), an initial value of a quantization parameter set for another view may be shared.

In this case, the initial values of the quantization parameters set for the base view are used in at least one non-base view. Alternatively, for example, the initial values of the quantization parameters set for a non-base view (view_id=i) are used in at least either the base view or a non-base view (view_id=j).

Accordingly, a decoding process can be efficiently performed on a picture partitioned into tiles in a case where motion vectors are encoded or decoded.

[Multi-View Image Encoding Device]

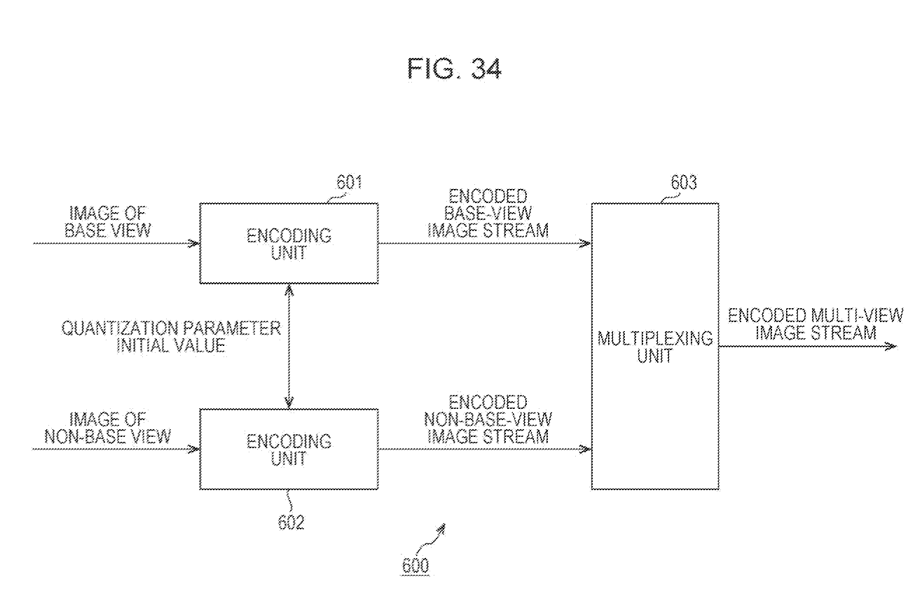

FIG. 34 is a diagram illustrating a multi-view image encoding device for performing the multi-view image encoding operation described above. As illustrated in FIG. 34, a multi-view image encoding device 600 includes an encoding unit 601, an encoding unit 602, and a multiplexing unit 603.

The encoding unit 601 encodes images of base views to generate an encoded base-view image stream. The encoding unit 602 encodes images of non-base views to generate an encoded non-base-view image stream. The multiplexing unit 603 multiplexes the encoded base-view image stream generated by the encoding unit 601 and the encoded non-base-view image stream generated by the encoding unit 602 to generate an encoded multi-view image stream.

The image encoding device 100 (FIG. 1) is applicable to the encoding unit 601 and the encoding unit 602 of the multi-view image encoding device 600. In this case, The multi-view image encoding device 600 sets the initial values of the quantization parameters set by the encoding unit 601 and the initial values of the quantization parameters set by the encoding unit 602, and transmits the set initial values of the quantization parameters.

Note that, as described above, the initial values of the quantization parameters set by the encoding unit 601 may be set so as to be shared and used by the encoding unit 601 and the encoding unit 602, and may be transmitted. Conversely, the initial values of the quantization parameters collectively set by the encoding unit 602 may be set so as to be shared and used by the encoding unit 601 and the encoding unit 602, and may be transmitted.

[Multi-View Image Decoding Device]

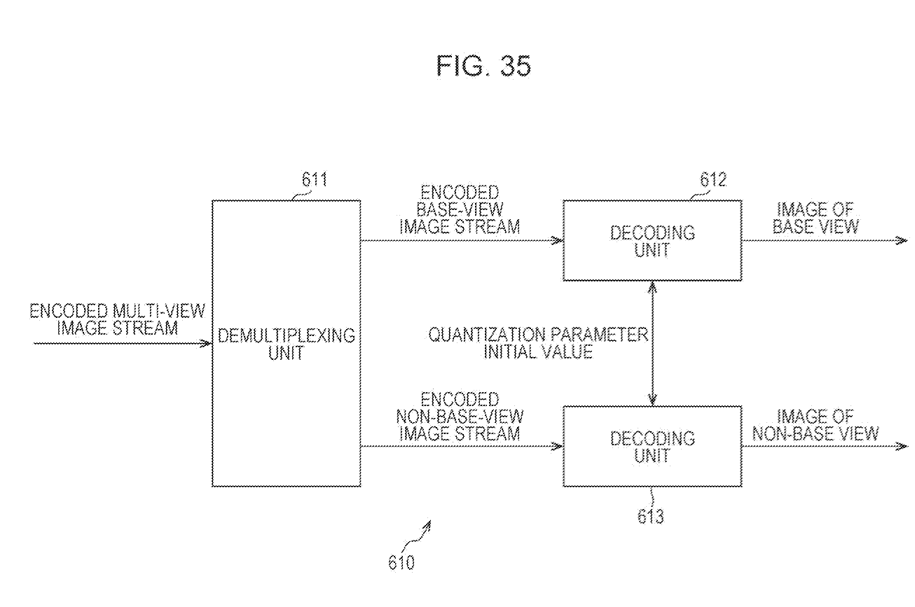

FIG. 35 is a diagram illustrating a multi-view image decoding device for performing the multi-view image decoding operation described above. As illustrated in FIG. 35, a multi-view image decoding device 610 includes a demultiplexing unit 611, a decoding unit 612, and a decoding unit 613.

The demultiplexing unit 611 demultiplexes an encoded multi-view image stream in which an encoded base-view image stream and an encoded non-base-view image stream have been multiplexed, and extracts the encoded base-view image stream and the encoded non-base-view image stream. The decoding unit 612 decodes the encoded base-view image stream extracted by the demultiplexing unit 611, and obtains images of base views. The decoding unit 613 decodes the encoded non-base-view image stream extracted by the demultiplexing unit 611, and obtains images of non-base views.

The image decoding device 200 (FIG. 27) is applicable to the decoding unit 612 and the decoding unit 613 of the multi-view image decoding device 610. In this case, the multi-view image decoding device 610 performs processing using the initial values of the quantization parameters set by the encoding unit 601 and decoded by the decoding unit 612 and using the initial values of the quantization parameters set by the encoding unit 602 and decoded by the decoding unit 613.

Note that, as described above, in some cases, the initial values of the quantization parameters set by the encoding unit 601 (or the encoding unit 602) may be set so as to be shared and used by the encoding unit 601 and the encoding unit 602, and may be transmitted. In this case, in the multi-view image decoding device 610, processing is performed using the initial values of the quantization parameters set by the encoding unit 601 (or the encoding unit 602) and decoded by the decoding unit 612 (or the decoding unit 613).

### 4. Fourth Embodiment

### Application to Layered Image Encoding/Layered Image Decoding

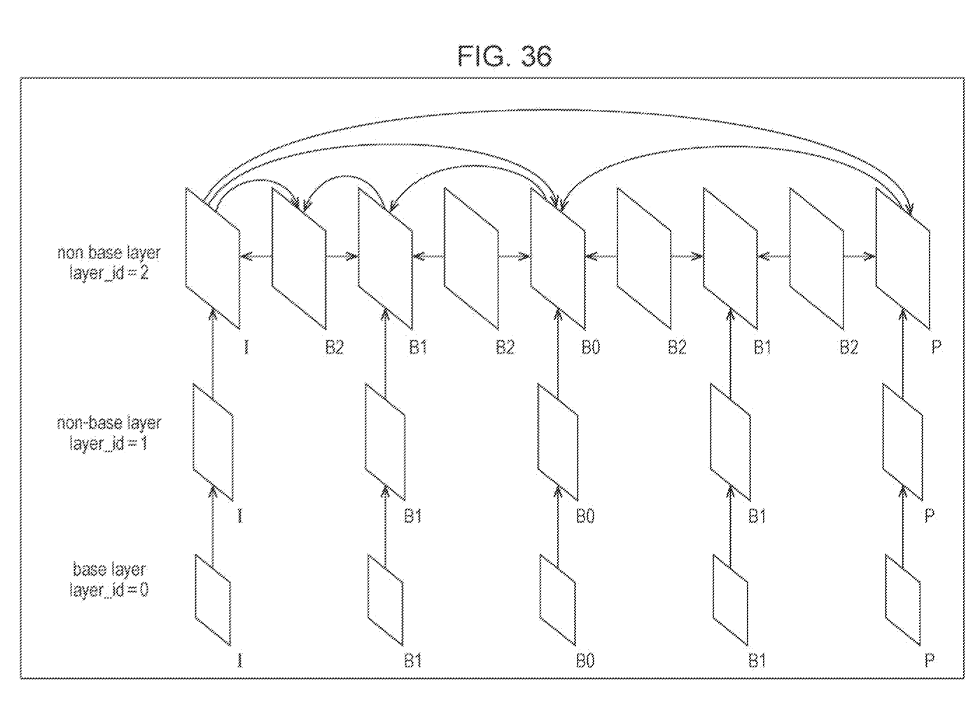

The series of processes described above may be applied to layered image encoding/layered image decoding. FIG. 36 illustrates an example of a multi-view image encoding scheme.

As illustrated in FIG. 36, layered images include images of a plurality of layers (resolutions), and an image of a predetermined one layer among the plurality of resolutions is designated as an image of a base layer. The images of the respective layers other than the image of the base layer are handled as images of non-base layers.

In a case where layered image encoding (spatial scalability) as in FIG. 36 is performed, the initial values of the quantization parameters described above can be set in each layer (the same layer). In addition, in each layer (different layers), the initial values of the quantization parameters set in another layer may be shared.

In this case, the initial values of the quantization parameters set in the base layer are used in at least one non-base layer. Alternatively, for example, the initial values of the quantization parameters set in a non-base layer (layer_id=i) are used in at least either the base layer or a non-base layer (layer_id=j).

Accordingly, a decoding process can be efficiently performed on a picture partitioned into tiles in a case where motion vectors are encoded or decoded.

[Layered Image Encoding Device]

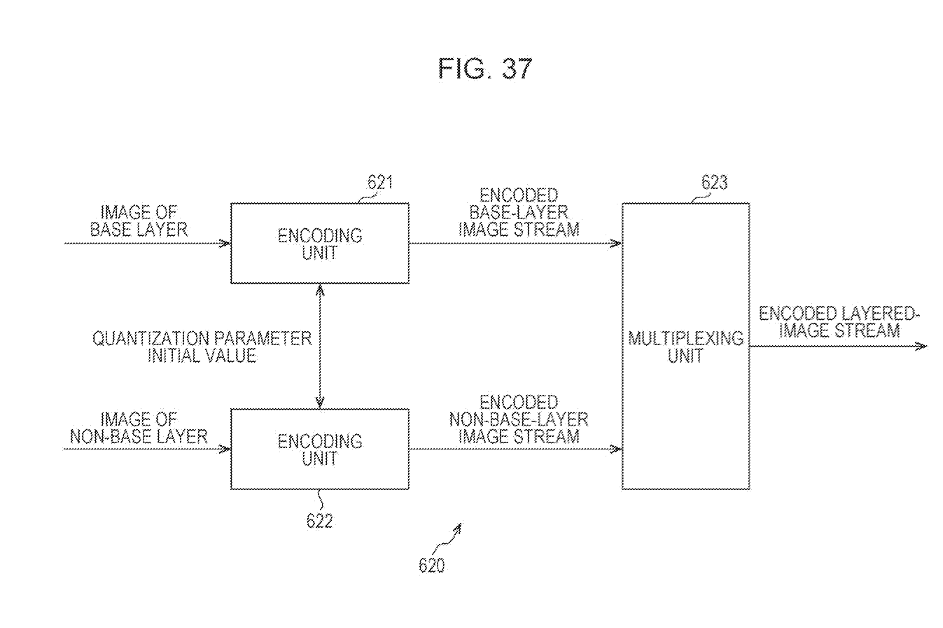

FIG. 37 is a diagram illustrating a layered image encoding device for performing the layered image encoding operation described above. As illustrated in FIG. 37, a layered image encoding device 620 includes an encoding unit 621, an encoding unit 622, and a multiplexing unit 623.

The encoding unit 621 encodes images of base layers to generate an encoded base-layer image stream. The encoding unit 622 encodes images of non-base layers to generate an encoded non-base-layer image stream. The multiplexing unit 623 multiplexes the encoded base-layer image stream generated by the encoding unit 621 and the encoded non-base-layer image stream generated by the encoding unit 622 to generate an encoded layered-image stream.

The image encoding device 100 (FIG. 1) is applicable to the encoding unit 621 and the encoding unit 622 of the layered image encoding device 620. In this case, the layered image encoding device 620 sets the initial values of the quantization parameters set by the encoding unit 621 and the initial values of the quantization parameters set by the encoding unit 602, and transmits the set initial values of the quantization parameters.

Note that, as described above, the initial values of the quantization parameters set by the encoding unit 621 may be set so as to be shared and used by the encoding unit 621 and the encoding unit 622, and may be transmitted. Conversely, the initial values of the quantization parameters set by the encoding unit 622 may be set so as to be shared and used by the encoding unit 621 and the encoding unit 622, and may be transmitted.

[Layered Image Decoding Device]

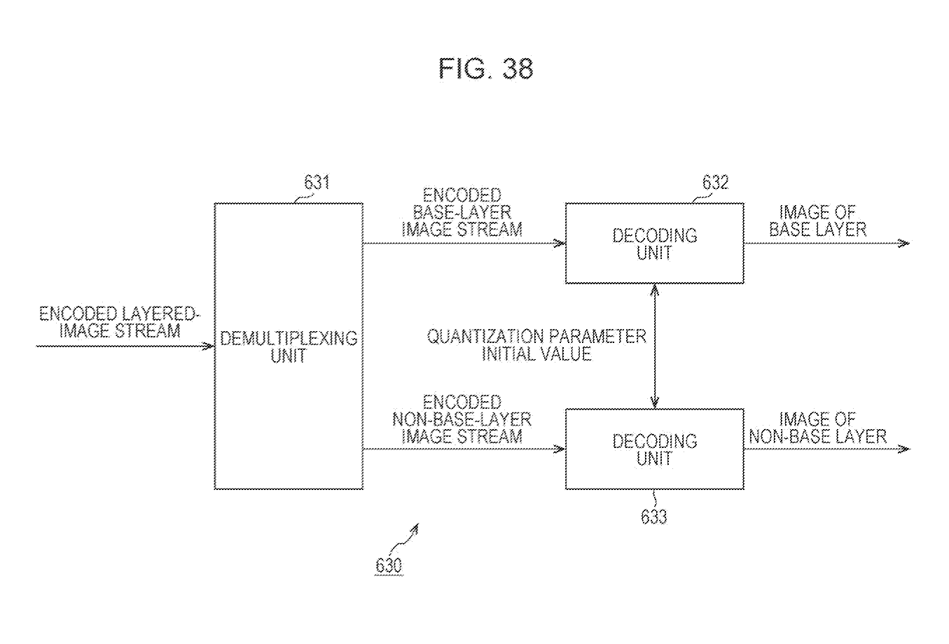

FIG. 38 is a diagram illustrating a layered image decoding device for performing the layered image decoding operation described above. As illustrated in FIG. 38, a layered image decoding device 630 includes a demultiplexing unit 631, a decoding unit 632, and a decoding unit 633.

The demultiplexing unit 631 demultiplexes an encoded layered-image stream in which an encoded base-layer image stream and an encoded non-base-layer image stream have been multiplexed, and extracts the encoded base-layer image stream and the encoded non-base-layer image stream. The decoding unit 632 decodes the encoded base-layer image stream extracted by the demultiplexing unit 631, and obtains images of base layers. The decoding unit 633 decodes the encoded non-base-layer image stream extracted by the demultiplexing unit 631, and obtains images of non-base layers.

The image decoding device 200 (FIG. 27) is applicable to the decoding unit 632 and the decoding unit 633 of the layered image decoding device 630. In this case, the layered image decoding device 630 performs processing using the initial values of the quantization parameters set by the encoding unit 621 and decoded by the decoding unit 632 and using the initial values of the quantization parameters set by the encoding unit 622 and decoded by the decoding unit 633.

Note that, as described above, in some cases, the initial values of the quantization parameters set by the encoding unit 621 (or the encoding unit 622) may be set so as to be shared and used by the encoding unit 621 and the encoding unit 622, and may be transmitted. In this case, in the layered image decoding device 630, processing is performed using the initial values of the quantization parameters set by the encoding unit 621 (or the encoding unit 622) and decoded by the decoding unit 632 (or the decoding unit 633).

### 5. Fifth Embodiment

### Computer

The series of processes described above may be executed by hardware or may be executed by software. If the series of processes is to be executed by software, a program constituting the software is installed in a computer. Here, examples of the computer include a computer incorporated in dedicated hardware, and a computer capable of executing various functions by the installation of various programs, such as a general-purpose personal computer.

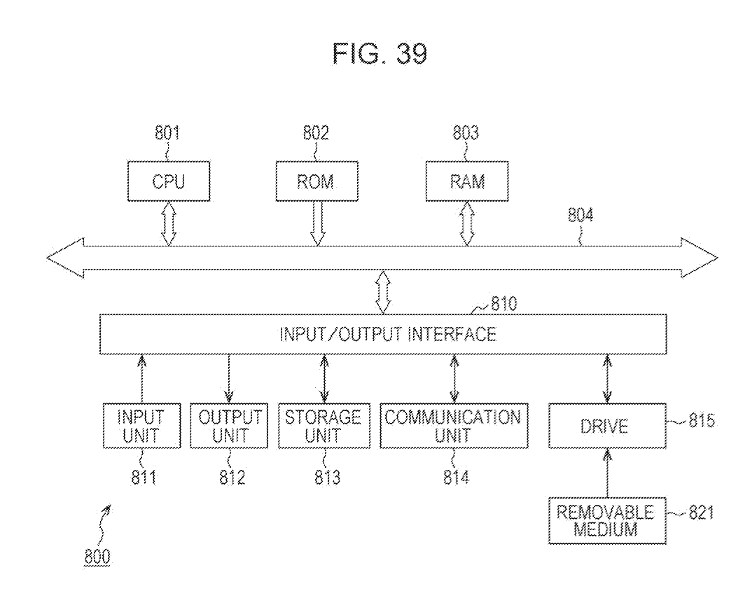

FIG. 39 is a block diagram illustrating an example configuration of hardware of a computer that executes the series of processes described above in accordance with a program.

In a computer 800, a CPU (Central Processing Unit) 801, a ROM (Read Only Memory) 802, and a RAM (Random Access Memory) 803 are connected to one another via a bus 804.

An input/output interface 805 is further connected to the bus 804. An input unit 806, an output unit 807, a storage unit 808, a communication unit 809, and a drive 810 are connected to the input/output interface 805.

The input unit 806 includes a keyboard, a mouse, a microphone, and so on. The output unit 807 includes a display, a speaker, and so on. The storage unit 808 includes a hard disk, a non-volatile memory, and so on. The communication unit 809 includes a network interface and so on. The drive 810 drives a removable medium 811 such as a magnetic disk, an optical disk, a magneto-optical disk, or a semiconductor memory.

In the computer having the configuration described above, the CPU 801 loads a program stored in, for example, the storage unit 808 into the RAM 803 through the input/output interface 805 and the bus 804, and executes the program. Accordingly, the series of processes described above is performed.

The program executed by the computer 800 (the CPU 801) may be provided in the form of being recorded on the removable medium 811, for example, a package medium. In addition, the program may also be provided through a wired or wireless transmission medium such as a local area network, the Internet, or digital satellite broadcasting.

In the computer, the removable medium 811 is set in the drive 810, thereby allowing the program to be installed into the storage unit 808 through the input/output interface 805. In addition, the program may be received by the communication unit 809 via a wired or wireless transmission medium, and may be installed into the storage unit 808. Alternatively, the program may be installed in advance in the ROM 802 or the storage unit 808.

Note that the program which the computer executes may be a program in which processing operations are performed in a time-series manner in the order stated herein, or may be a program in which processing operations are performed in parallel or at necessary timing such as when called.

In addition, steps describing a program recorded on a recording medium, as used herein, include, of course, processing operations performed in a time-series manner in the order stated, and processing operations executed in parallel or individually but not necessarily performed in a time-series manner.

Furthermore, the term system, as used herein, refers to an overall apparatus including a plurality of devices (apparatuses).

In addition, a configuration described above as a single device (or processing unit) may be divided into a plurality of devices (or processing units). Conversely, configurations described above as a plurality of devices (or processing units) may be configured so as to be combined into a single device (or processing unit). Additionally, as a matter of course, a configuration other than that described above may be added to the configuration of each device (or each processing unit). Furthermore, part of the configuration of a certain device (or processing unit) may be included in the configuration of another device (or another processing unit) if the devices (or processing units) have substantially the same configuration and/or operation within an entire system. In other words, the present technology is not limited to the embodiments described above, and a variety of changes can be made without departing from the scope of the present technology.

The image encoding device and the image decoding device according to the embodiments described above may be applied to various pieces of electronic equipment such as a transmitter or a receiver used to deliver data via satellite broadcasting, wired broadcasting such as cable TV, or the Internet or used to deliver data to or from terminals via cellular communication, a recording apparatus for recording images on media such as an optical disk, a magnetic disk, and a flash memory, and a reproducing apparatus for reproducing images from such storage media. In the following, a description will be given of four example applications.

### 6. Example Applications

### First Example Application

### Television Receiver

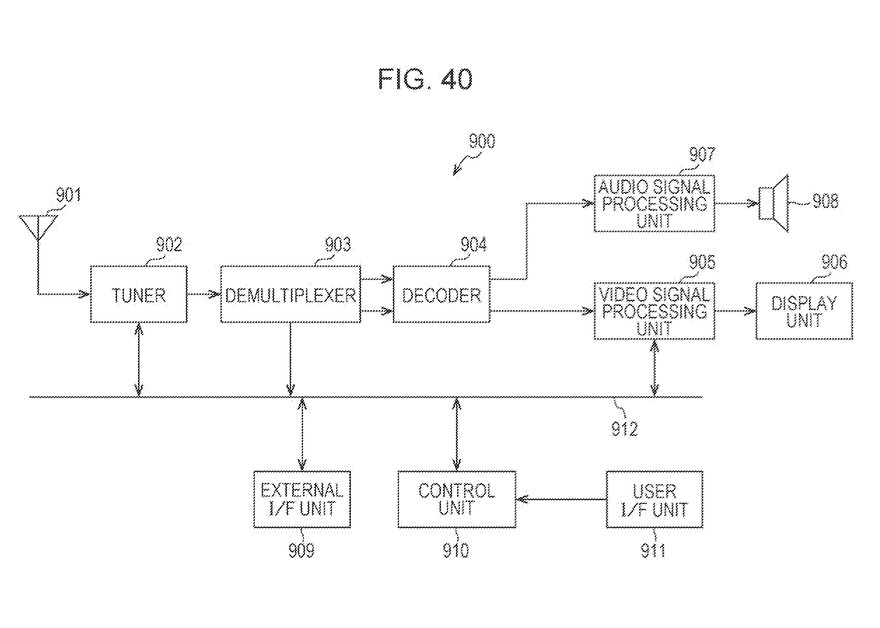

FIG. 40 illustrates an example of a schematic configuration of a television apparatus to which any of the embodiments described above applies. A television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal in a desired channel from a broadcast signal received via the antenna 901, and demodulates the extracted signal. Then, the tuner 902 outputs an encoded bit stream obtained by demodulation to the demultiplexer 903. That is, the tuner 902 functions as transmission means in the television apparatus 900 for receiving an encoded stream including encoded images.

The demultiplexer 903 demultiplexes the encoded bit stream into a video stream and an audio stream of a program to be viewed, and outputs the demultiplexed streams to the decoder 904. The demultiplexer 903 further extracts auxiliary data such as EPG (Electronic Program Guide) from the encoded bit stream, and supplies the extracted data to the control unit 910. Note that the demultiplexer 903 may descramble the encoded bit stream if the encoded bit stream has been scrambled.

The decoder 904 decodes the video stream and audio stream input from the demultiplexer 903. Then, the decoder 904 outputs video data generated through the decoding process to the video signal processing unit 905. The decoder 904 further outputs audio data generated through the decoding process to the audio signal processing unit 907.

The video signal processing unit 905 reproduces the video data input from the decoder 904, and causes video to be displayed on the display unit 906. The video signal processing unit 905 may also cause an application screen supplied via a network to be displayed on the display unit 906. The video signal processing unit 905 may further perform additional processes, such as noise removal, on the video data in accordance with settings. In addition, the video signal processing unit 905 may also generate a GUI (Graphical User Interface) image such as a menu, a button, or a cursor, and superimpose the generated image on an output image.

The display unit 906 is driven by a drive signal supplied from the video signal processing unit 905, and displays video or an image on a video surface of a display device (such as a liquid crystal display, a plasma display, or an GELD (Organic ElectroLuminescence Display) (organic EL display)).

The audio signal processing unit 907 performs reproduction processes, such as D/A conversion and amplification, on the audio data input from the decoder 904, and causes audio to be output from the speaker 908. The audio signal processing unit 907 may further perform additional processes, such as noise removal, on the audio data.

The external interface 909 is an interface for connecting the television apparatus 900 to an external apparatus or a network. For example, a video stream or audio stream received via the external interface 909 may be decoded by the decoder 904. That is, the external interface 909 also functions as transmission means in the television apparatus 900 for receiving an encoded stream including encoded images.

The control unit 910 includes a processor such as a CPU, and memories such as a RAM and a ROM. The memories store a program to be executed by the CPU, program data, EPG data, data acquired via a network, and so on. The program stored in the memories is read and executed by the CPU when, for example, the television apparatus 900 is started. The CPU executes the program to control the operation of the television apparatus 900 in accordance with, for example, an operation signal input from the user interface 911.

The user interface 911 is connected to the control unit 910. The user interface 911 includes, for example, buttons and switches for allowing the user to operate the television apparatus 900, a receiving unit for a remote control signal, and so on. The user interface 911 detects an operation of the user via the above-described components to generate an operation signal, and outputs the generated operation signal to the control unit 910.

The bus 912 serves to connect the tuner 902, the demultiplexer 903, the decoder 904, the video signal processing unit 905, the audio signal processing unit 907, the external interface 909, and the control unit 910 to one another.

In the television apparatus 900 having the configuration described above, the decoder 904 has the function of the image decoding device according to the embodiment described above. Accordingly, the television apparatus 900 can efficiently perform a decoding process on a picture partitioned into tiles when decoding an image.

### Second Example Application

### Mobile Phone

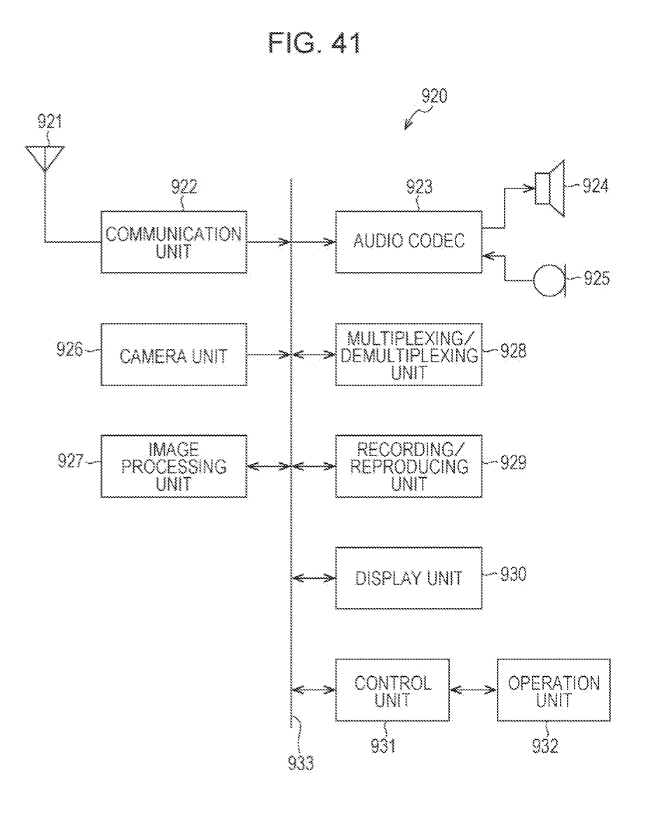

FIG. 41 illustrates an example of a schematic configuration of a mobile phone to which any of the embodiments described above applies. A mobile phone 920 includes an antenna 921, a communication unit 922, an audio codec 923, a speaker 924, a microphone 925, a camera unit 926, an image processing unit 927, a multiplexing/demultiplexing unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 serves to connect the communication unit 922, the audio codec 923, the camera unit 926, the image processing unit 927, the multiplexing/demultiplexing unit 928, the recording/reproducing unit 929, the display unit 930, and the control unit 931 to one another.

The mobile phone 920 performs operations, such as transmitting and receiving an audio signal, transmitting and receiving an electronic mail or image data, capturing an image, and recording data, in various operation modes including a voice call mode, a data communication mode, an image capture mode, and a videophone mode.

In the voice call mode, an analog audio signal generated by the microphone 925 is supplied to the audio codec 923. The audio codec 923 converts the audio signal into audio data, and performs A/D conversion and compression on the converted audio data. Then, the audio codec 923 outputs the compressed audio data to the communication unit 922. The communication unit 922 encodes and modulates the audio data, and generates a transmission signal. Then, the communication unit 922 transmits the generated transmission signal to a base station (not illustrated) via the antenna 921. Further, the communication unit 922 amplifies a radio signal received via the antenna 921, and performs frequency conversion on the amplified signal to acquire a reception signal. Then, the communication unit 922 demodulates and decodes the reception signal to generate audio data, and outputs the generated audio data to the audio codec 923. The audio codec 923 expands the audio data, and performs D/A conversion to generate an analog audio signal. Then, the audio codec 923 supplies the generated audio signal to the speaker 924 to cause audio to be output.

Furthermore, in the data communication mode, for example, the control unit 931 generates text data that forms an electronic mail in accordance with an operation of the user via the operation unit 932. Furthermore, the control unit 931 causes text to be displayed on the display unit 930. The control unit 931 further generates electronic mail data in accordance with transmission instructions given from the user via the operation unit 932, and outputs the generated electronic mail data to the communication unit 922. The communication unit 922 encodes and modulates the electronic mail data, and generates a transmission signal. Then, the communication unit 922 transmits the generated transmission signal to a base station (not illustrated) via the antenna 921. Further, the communication unit 922 amplifies a radio signal received via the antenna 921, and performs frequency conversion on the amplified signal to acquire a reception signal. Then, the communication unit 922 demodulates and decodes the reception signal to restore electronic mail data, and outputs the restored electronic mail data to the control unit 931. The control unit 931 causes the content of the electronic mail to be displayed on the display unit 930, and also causes the electronic mail data to be stored in a storage medium of the recording/reproducing unit 929.

The recording/reproducing unit 929 includes a desired readable/writable storage medium. The storage medium may be, for example, a built-in storage medium such as a RAM or a flash memory, or an externally attached storage medium such as a hard disk, a magnetic disk, a magneto-optical disk, an optical disk, a USB (Universal Serial Bus) memory, or a memory card.

Furthermore, in the image capture mode, for example, the camera unit 926 captures an image of an object to generate image data, and outputs the generated image data to the image processing unit 927. The image processing unit 927 encodes the image data input from the camera unit 926, and causes an encoded stream to be stored in the storage medium of the storage/reproducing unit 929.

Furthermore, in the videophone mode, for example, the multiplexing/demultiplexing unit 928 multiplexes the video stream encoded by the image processing unit 927 and the audio stream input from the audio codec 923, and outputs a multiplexed stream to the communication unit 922. The communication unit 922 encodes and modulates the stream, and generates a transmission signal. Then, the communication unit 922 transmits the generated transmission signal to a base station (not illustrated) via the antenna 921. Further, the communication unit 922 amplifies a radio signal received via the antenna 921, and performs frequency conversion on the amplified signal to acquire a reception signal. The transmission signal and the reception signal may include an encoded bit stream. Then, the communication unit 922 demodulates and decodes the reception signal to restore a stream, and outputs the restored stream to the multiplexing/demultiplexing unit 928. The multiplexing/demultiplexing unit 928 multiplexes a video stream and an audio stream from the input stream, and outputs the video stream to the image processing unit 927 and the audio stream to the audio codec 923. The image processing unit 927 decodes the video stream, and generates video data. The video data is supplied to the display unit 930, and a series of images is displayed on the display unit 930. The audio codec 923 expands the audio stream, and performs D/A conversion to generate an analog audio signal. Then, the audio codec 923 supplies the generated audio signal to the speaker 924 to cause audio to be output.

In the mobile phone 920 having the configuration described above, the image processing unit 927 has the function of the image encoding device and image decoding device according to the embodiments described above. Accordingly, the mobile phone 920 can efficiently perform a decoding process on a picture partitioned into tiles when encoding and decoding an image.

### Third Example Application

### Recording/Reproducing Apparatus

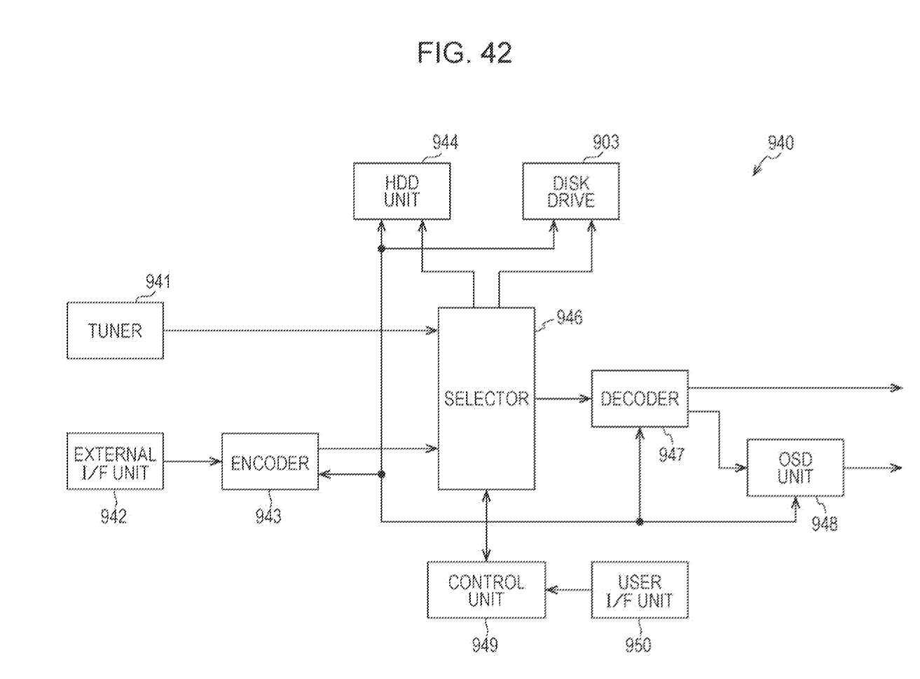

FIG. 42 illustrates an example of a schematic configuration of a recording/reproducing apparatus to which any of the embodiments described above applies. A recording/reproducing apparatus 940 encodes, for example, audio data and video data of a received broadcast program, and records the encoded audio data and video data on a recording medium. Furthermore, the recording/reproducing apparatus 940 may also encode audio data and video data acquired from, for example, another apparatus, and record the encoded audio data and video data on a recording medium. Moreover, the recording/reproducing apparatus 940 reproduces, for example, data recorded on a recording medium using a monitor and a speaker in accordance with instructions given from a user. In this case, the recording/reproducing apparatus 940 decodes audio data and video data.

The recording/reproducing apparatus 940 includes a tuner 941, an external interface 942, an encoder 943, an HDD (Hard Disk Drive) 944, a disk drive 945, a selector 946, a decoder 947, an on-screen display (OSD) 948, a control unit 949, and a user interface 950.

The tuner 941 extracts a signal in a desired channel from a broadcast signal received via an antenna (not illustrated), and demodulates the extracted signal. Then, the tuner 941 outputs an encoded bit stream obtained by demodulation to the selector 946. That is, the tuner 941 functions as transmission means in the recording/reproducing apparatus 940.

The external interface 942 is an interface for connecting the recording/reproducing apparatus 940 to an external apparatus or a network. The external interface 942 may be, for example, an IEEE 1394 interface, a network interface, a USB interface, a flash memory interface, or the like. For example, video data and audio data received via the external interface 942 are input to the encoder 943. That is, the external interface 942 functions as transmission means in the recording/reproducing apparatus 940.

The encoder 943 encodes video data and audio data input from the external interface 942 if the video data and audio data have not been encoded. Then, the encoder 943 outputs an encoded bit stream to the selector 946.

The HDD 944 records an encoded bit stream including compressed content data such as video and audio, various programs, and other data on an internal hard disk. Furthermore, the HDD 944 reads the above-described data from the hard disk when reproducing video and audio.

The disk drive 945 records and reads data on and from a recording medium placed therein. The recording medium placed in the disk drive 945 may be, for example, a DVD disk (such as DVD-Video, DVD-RAM, DVD-R, DVD-RW, DVD+R, or DVD+RW) or a Blu-ray (registered trademark) disc.

The selector 946 selects an encoded bit stream input from the tuner 941 or the encoder 943 when recording video and audio, and outputs the selected encoded bit stream to the HDD 944 or the disk drive 945. Further, when reproducing video and audio, the selector 946 outputs an encoded bit stream input from the HDD 944 or the disk drive 945 to the decoder 947.

The decoder 947 decodes the encoded bit stream, and generates video data and audio data. Then, the decoder 947 outputs the generated video data to the OSD 948. The decoder 904 further outputs the generated audio data to an external speaker.

The OSD 948 reproduces the video data input from the decoder 947, and displays video. In addition, the OSD 948 may also superimpose a GUI image such as a menu, a button, or a cursor on the video to be displayed.

The control unit 949 includes a processor such as a CPU, and memories such as a RAM and a ROM. The memories store a program to be executed by the CPU, program data, and so on. The program stored in the memories is read and executed by the CPU when, for example, the recording/reproducing apparatus 940 is started. The CPU executes the program to control the operation of the recording/reproducing apparatus 940 in accordance with, for example, an operation signal input from the user interface 950.

The user interface 950 is connected to the control unit 949. The user interface 950 includes, for example, buttons and switches for allowing the user to operate the recording/reproducing apparatus 940, a receiving unit for a remote control signal, and so on. The user interface 950 detects an operation of the user via the above-described components to generate an operation signal, and outputs the generated operation signal to the control unit 949.

In the recording/reproducing apparatus 940 having the configuration described above, the encoder 943 has the function of the image encoding device according to the embodiment described above. Furthermore, the decoder 947 has the function of the image decoding device according to the embodiment described above. Accordingly, the recording/reproducing apparatus 940 can efficiently perform a decoding process on a picture partitioned into tiles when encoding and decoding an image.

### Fourth Example Application

### Imaging Apparatus

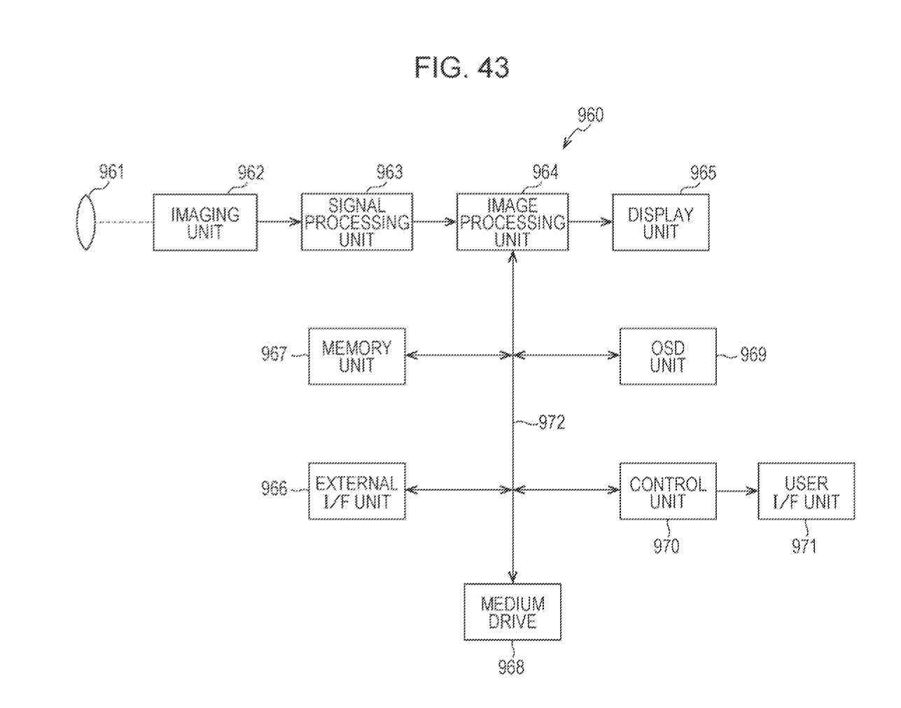

FIG. 43 illustrates an example of a schematic configuration of an imaging apparatus to which any of the embodiments described above applies. An imaging apparatus 960 captures an image of an object to generate an image, encodes the image data, and records the encoded image data on a recording medium.

The imaging apparatus 960 includes an optical block 961, an imaging unit 962, a signal processing unit 963, an image processing unit 964, a display unit 965, an external interface 966, a memory 967, a medium drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 serves to connect the image processing unit 964, the external interface 966, the memory 967, the medium drive 968, the OSD 969, and the control unit 970 to one another.

The optical block 961 includes a focus lens, an aperture mechanism, and so on. The optical block 961 forms an optical image of the object on an imaging surface of the imaging unit 962. The imaging unit 962 includes an image sensor such as a CCD (Charge Coupled Device) or CMOS (Complementary Metal Oxide Semiconductor) image sensor, and converts the optical image formed on the imaging surface into an image signal serving as an electrical signal by performing photoelectric conversion. Then, the imaging unit 962 outputs the image signal to the signal processing unit 963.

The signal processing unit 963 performs a variety of camera signal processing operations, such as knee correction, gamma correction, and color correction, on the image signal input from the imaging unit 962. The signal processing unit 963 outputs the image data subjected to the camera signal processing operations to the image processing unit 964.

The image processing unit 964 encodes the image data input from the signal processing unit 963, and generates encoded data. Then, the image processing unit 964 outputs the generated encoded data to the external interface 966 or the medium drive 968. Further, the image processing unit 964 decodes the encoded data input from the external interface 966 or the medium drive 968, and generates image data. Then, the image processing unit 964 outputs the generated image data to the display unit 965. Furthermore, the image processing unit 964 may output the image data input from the signal processing unit 963 to the display unit 965 to cause an image to be displayed. Moreover, the image processing unit 964 may superimpose display data acquired from the OSD 969 on the image to be output to the display unit 965.

The OSD 969 generates a GUI image such as a menu, a button, or a cursor, and outputs the generated image to the image processing unit 964.

The external interface 966 is formed as, for example, a USB input/output terminal. The external interface 966 connects, for example, the imaging apparatus 960 to a printer when printing an image. A drive is further connected to the external interface 966, if necessary. A removable medium such as a magnetic disk or an optical disk is placed in the drive, and a program read from the removable medium may be installed into the imaging apparatus 960. In addition, the external interface 966 may also be formed as a network interface to be connected to a network such as a LAN or the Internet. That is, the external interface 966 functions as transmission means in the imaging apparatus 960.

The recording medium to be placed in the medium drive 968 may be, for example, any readable/writable removable medium such as a magnetic disk, a magneto-optical disk, an optical disk, or a semiconductor memory. Alternatively, a recording medium may be fixedly attached to the medium drive 968, and may form a built-in hard disk drive or a non-portable storage unit such as an SSD (Solid State Drive).

The control unit 970 includes a processor such as a CPU, and memories such as a RAM and a ROM. The memories store a program to be executed by the CPU, program data, and so on. The program stored in the memories is read and executed by the CPU when, for example, the imaging apparatus 960 is started. The CPU executes the program to control the operation of the imaging apparatus 960 in accordance with, for example, an operation signal input from the user interface 971.

The user interface 971 is connected to the control unit 970. The user interface 971 includes, for example, buttons, switches, and so on for allowing the user to operate the imaging apparatus 960. The user interface 971 detects an operation of the user via the above-described components to generate an operation signal, and outputs the generated operation signal to the control unit 970.

In the imaging apparatus 960 having the configuration described above, the image processing unit 964 has the function of the image encoding device and the image decoding device according to the embodiments described above. Accordingly, the imaging apparatus 960 can efficiently perform a decoding process on a picture partitioned into tiles when encoding and decoding an image.

### 7. Example Applications of Scalable Coding

### First System

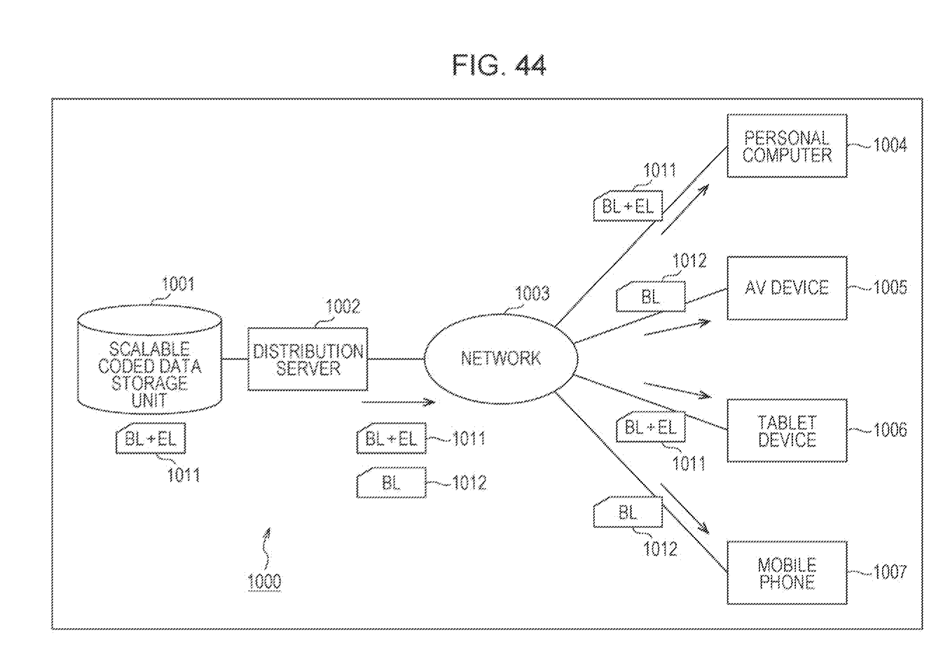

Next, a specific example of use of scalable encoded data which has been encoded using scalable coding (layered coding) described above with reference to FIG. 36 to FIG. 38 will be described with reference to FIG. 44. Scalable coding is utilized for, for example, as in the example illustrated in FIG. 44, the selection of data to be transmitted.

In a data transmission system 1000 illustrated in FIG. 44, a distribution server 1002 reads scalable coded data stored in a scalable coded data storage unit 1001, and distributes the scalable coded data to terminal devices, such as a personal computer 1004, an AV device 1005, a tablet device 1006, and a mobile phone 1007, via a network 1003.

In this case, the distribution server 1002 selects encoded data having desired quality in accordance with the performance of the terminal device, the communication environment, and the like, and transmits the selected encoded data. Even if the distribution server 1002 transmits data having quality higher than necessary, the terminal device may not always obtain a high-quality image, and delay or overflow may be caused. In addition, such data may occupy communication bandwidth more than necessary, or may increase the load on the terminal device more than necessary. Conversely, even if the distribution server 1002 transmits data having quality lower than necessary, the terminal device may not necessarily obtain an image with a sufficient quality. Thus, the distribution server 1002 reads the scalable coded data stored in the scalable coded data storage unit 1001, if necessary, as encoded data having quality appropriate for the performance of the terminal device, the communication environment, and the like, and transmits the read encoded data.

For example, it is assumed that the scalable coded data storage unit 1001 stores scalable coded data (BL+EL) 1011 which has been scalably coded. The scalable coded data (BL+EL) 1011 is encoded data including a base layer and an enhancement layer, and is data which is decoded to obtain both an image of the base layer and an image of the enhancement layer.

The distribution server 1002 selects an appropriate layer in accordance with the performance of a terminal device that transmits data, the communication environment, and the like, and reads the data of the layer. For example, the distribution server 1002 reads high-quality scalable coded data (BL+EL) 1011 from the scalable coded data storage unit 1001, and transmits the scalable coded data (BL+EL) 1011 to the personal computer 1004 or the tablet device 1006, which has high processing capabilities, as it is. In contrast, for example, the distribution server 1002 extracts the data of the base layer from the scalable coded data (BL+EL) 1011, and transmits the extracted data of the base layer to the AV device 1005 or the mobile phone 1007, which has low processing capabilities, as scalable coded data (BL) 1012 having the same content as the scalable coded data (BL+EL) 1011 but having lower quality than the scalable coded data (BL+EL) 1011.

The use of scalable coded data in this manner facilitates the adjustment of the amount of data, thereby suppressing the occurrence of delay or overflow and suppressing an unnecessary increase in the load on a terminal device or a communication medium. Furthermore, the scalable coded data (BL+EL) 1011 has reduced redundancy between layers, and therefore has a smaller amount of data than data having individually encoded data of the respective layers. Accordingly, the storage area of the scalable coded data storage unit 1001 can be more efficiently utilized.

Note that since various devices such as the personal computer 1004, the AV device 1005, the tablet device 1006, and the mobile phone 1007 can be used as terminal devices, the hardware performance of terminal devices varies depending on the device. In addition, since various applications may be executed by terminal devices, the software capabilities of the applications may vary. Furthermore, the network 1003 serving as a communication medium may be implemented as any communication line network which can be wired, wireless, or both, such as the Internet and a LAN (Local Area Network), and has various data transmission capabilities. In addition, such performance and capabilities may be change by means of other communication and the like.

Accordingly, prior to the start of transmission of data, the distribution server 1002 may communicate with a terminal device to which the data is to be transmitted, and may obtain information concerning the capabilities of the terminal device, such as the hardware performance of the terminal device or the performance of application (software) executed by the terminal device, and also obtain information concerning the communication environment, such as the available bandwidth of the network 1003. In addition, the distribution server 1002 may select an appropriate layer on the basis of the obtained information.

Note that a layer may be extracted by a terminal device. For example, the personal computer 1004 may decode the transmitted scalable coded data (BL+EL) 1011, and display an image of a base layer or an image of an enhancement layer. Alternatively, for example, the personal computer 1004 may extract the scalable coded data (BL) 1012 of the base layer from the transmitted scalable coded data (BL+EL) 1011, store the extracted scalable coded data (BL) 1012, transfer the extracted scalable coded data (BL) 1012 to another device, or decode the extracted scalable coded data (BL) 1012 to display an image of the base layer.

Needless to say, the number of scalable coded data storage units 1001, the number of distribution servers 1002, the number of networks 1003, and the number of terminal devices are arbitrary. Furthermore, while a description has been given of an example in which the distribution server 1002 transmits data to a terminal device, examples of use are not limited to this example. The data transmission system 1000 may be used in any system that selects an appropriate layer, when transmitting encoded data which has been encoded using scalable coding to a terminal device, in accordance with the capabilities of the terminal device, the communication environment, and the like.

In addition, the application of the present technology to the data transmission system 1000 as illustrated in FIG. 44 described above in a manner similar to an application to the hierarchical encoding and hierarchical decoding described above with reference to FIG. 36 to FIG. 38 also makes it possible to achieve advantages similar to the advantages described above with reference to FIG. 36 to FIG. 38.

### Second System

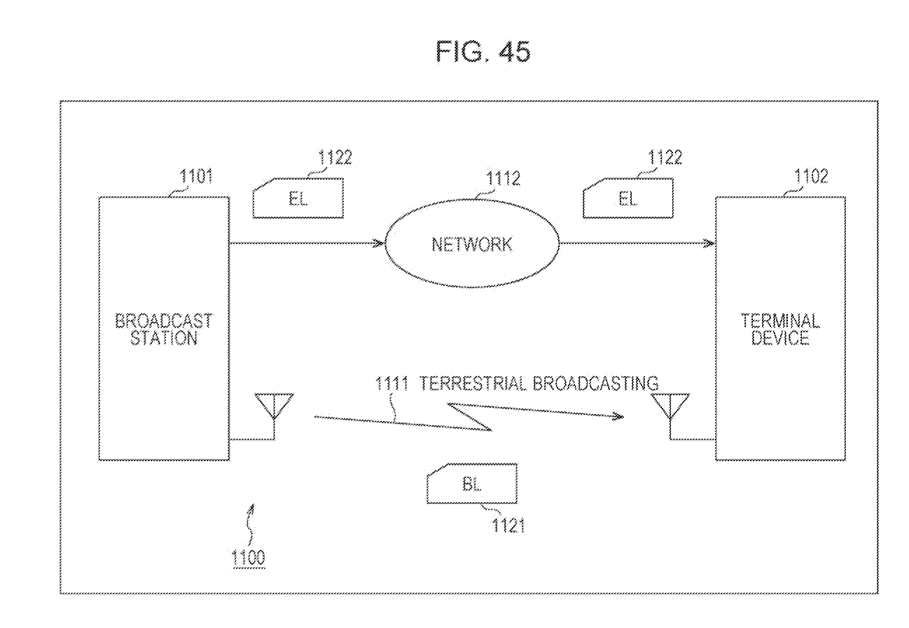

Scalable coding may also be used for, for example, as in an example illustrated in FIG. 45, transmission via a plurality of communication media.

In a data transmission system 1100 illustrated in FIG. 45, a broadcast station 1101 transmits scalable coded data (BL) 1121 of a base layer via terrestrial broadcasting 1111. The broadcast station 1101 further transmits (for example, packetizes and transmits) scalable coded data (EL) 1122 of an enhancement layer via a desired network 1112 formed of a communication network which may be wired, wireless, or both.

A terminal device 1102 has a function to receive the terrestrial broadcasting 1111 from the broadcast station 1101, and receives the scalable coded data (BL) 1121 of the base layer transmitted via the terrestrial broadcasting 1111. The terminal device 1102 further has a communication function to perform communication via the network 1112, and receives the scalable coded data (EL) 1122 of the enhancement layer transmitted via the network 1112.

The terminal device 1102 decodes the scalable coded data (BL) 1121 of the base layer acquired via the terrestrial broadcasting 1111 in accordance with, for example, user instructions or the like to obtain an image of the base layer, stores the scalable coded data (BL) 1121, or transfers the scalable coded data (BL) 1121 to another device.

Furthermore, the terminal device 1102 combines the scalable coded data (BL) 1121 of the base layer acquired via the terrestrial broadcasting 1111 with the scalable coded data (EL) 1122 of the enhancement layer acquired via the network 1112 in accordance with, for example, user instructions or the like to obtain scalable coded data (BL+EL), and decodes the scalable coded data (BL+EL) to obtain an image of the enhancement layer, stores the scalable coded data (BL+EL), or transfers the scalable coded data (BL+EL) to another device.

As described above, scalable coded data can be transmitted via, for example, communication media different from one layer to another. Thus, the load can be distributed, and delay or overflow can be suppressed from occurring.

Moreover, a communication medium to be used for transmission may be made selectable for each layer in accordance with the situation. For example, the scalable coded data (BL) 1121 of the base layer having a relatively large amount of data may be transmitted via a communication medium having a large bandwidth, and the scalable coded data (EL) 1122 of the enhancement layer having a relatively small amount of data may be transmitted via a communication medium having a narrow bandwidth. Alternatively, for example, the communication medium via which the scalable coded data (EL) 1122 of the enhancement layer is to be transmitted may be switched between the network 1112 and the terrestrial broadcasting 1111 in accordance with the available bandwidth of the network 1112. As a matter of course, the above similarly applies to data of an arbitrary layer.

Control in the manner described above can further suppress an increase in the load of data transmission.

Needless to say, the number of layers is arbitrary, and the number of communication media to be used for transmission is also arbitrary. In addition, the number of terminal devices 1102 to which data is to be distributed is also arbitrary. Furthermore, while a description has been given in the context of broadcasting from the broadcast station 1101 by way of example, examples of use are not limited to this example. The data transmission system 1100 may be used in any system that divides data encoded using scalable coding into a plurality of segments in units of layers and that transmits the data segments via a plurality of lines.

In addition, the application of the present technology to the data transmission system 1100 as illustrated in FIG. 45 described above in a manner similar to an application to the hierarchical encoding and hierarchical decoding described above with reference to FIG. 36 to FIG. 38 also makes it possible to achieve advantages similar to the advantages described above with reference to FIG. 36 to FIG. 38.

### Third System

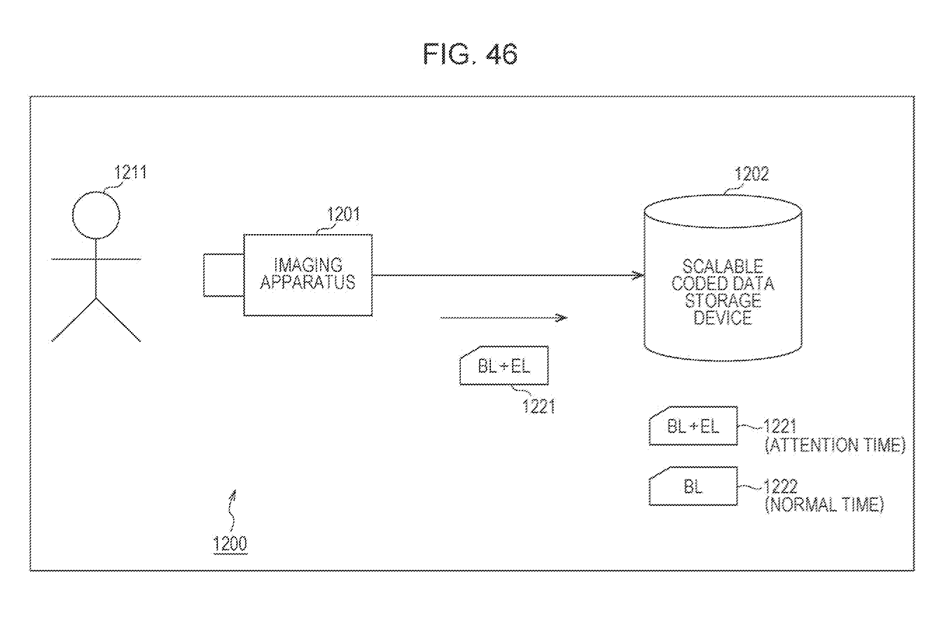

Scalable coding may also be used for, for example, as in an example illustrated in FIG. 46, the storage of encoded data.

In an imaging system 1200 illustrated in FIG. 46, an imaging apparatus 1201 performs scalable coding on image data obtained by capturing an image of an object 1211, and supplies the resulting data to a scalable coded data storage device 1202 as scalable coded data (BL+EL) 1221.

The scalable coded data storage device 1202 stores the scalable coded data (BL+EL) 1221 supplied from the imaging apparatus 1201 at the quality corresponding to the situation. For example, in normal time, the scalable coded data storage device 1202 extracts data of a base layer from the scalable coded data (BL+EL) 1221, and stores the extracted data of the base layer as scalable coded data (BL) 1222 of the base layer having a low quality and a small amount of data. In contrast, for example, in attention time, the scalable coded data storage device 1202 stores the scalable coded data (BL+EL) 1221 having a high quality and a large amount of data, as it is.

Accordingly, the scalable coded data storage device 1202 can save an image at high quality only when necessary. This can suppress an increase in the amount of data while suppressing a reduction in the worth of the image due to a reduction in quality, and can improve use efficiency of the storage area.

For example, it is assumed that the imaging apparatus 1201 is a security camera. If an object to be monitored (for example, an intruder) does not appear in a captured image (normal time), it may be probable that the captured image does not have important content. Thus, a reduction in the amount of data is prioritized, and the image data (scalable coded data) of the image is stored at low quality. In contrast, if an object to be monitored appears as the object 1211 in a captured image (attention time), it may be probable that the captured image has important content. Thus, image quality is prioritized, and the image data (scalable coded data) of the image is stored at high quality.

Note that either the normal time or the attention time may be determined by, for example, the scalable coded data storage device 1202 by analyzing an image. Alternatively, the imaging apparatus 1201 may determine the normal time or the attention time, and may transmit the determination result to the scalable coded data storage device 1202.

Note that the determination of either the normal time or the attention time may be based on an arbitrary standard, and an image on which the determination is based may have any content. Needless to say, conditions other than the content of an image may be used as the determination standard. The state may be changed in accordance with, for example, the magnitude, waveform, or the like of recorded audio, or may be changed at intervals of a predetermined period of time. Alternatively, the state may be changed in accordance with external instructions such as user instructions.

Furthermore, while a description has been given of an example of changing between two states, namely, normal time and attention time, the number of states is arbitrary, and the state change may be made between more than two states, such as normal time, attention time, more attention time, and much more attention time. Note that the upper limit number of states to be changed depends on the number of layers of scalable coded data.

Moreover, the imaging apparatus 1201 may be configured to determine the number of layers of scalable coding in accordance with the state. For example, in normal time, the imaging apparatus 1201 may generate scalable coded data (BL) 1222 of the base layer having a low quality and a small amount of data, and supply the generated scalable coded data (BL) 1222 to the scalable coded data storage device 1202. Furthermore, for example, in attention time, the imaging apparatus 1201 may generate scalable coded data (BL+EL) 1221 of the base layer having a high quality and a large amount of data, and supply the generated scalable coded data (BL+EL) 1221 to the scalable coded data storage device 1202.

While a security camera has been described as an example, the imaging system 1200 may be used in any application, and may be used in applications other than a security camera.

In addition, the application of the present technology to the imaging system 1200 illustrated in FIG. 46 described above in a manner similar to an application to the hierarchical encoding and hierarchical decoding described above with reference to FIG. 36 to FIG. 38 also makes it possible to achieve advantages similar to the advantages described above with reference to FIG. 36 to FIG. 38.

Note that an example in which various pieces of information such as information concerning quantization parameter initial values and the like, tile partitioning information, motion vector information, and prediction mode information are multiplexed into an encoded stream and are transmitted from the encoding side to the decoding side has been described herein. However, the technique for transmitting these pieces of information is not limited to the example described above. For example, these pieces of information may be transmitted or recorded as separate data associated with an encoded bit stream without being multiplexed into the encoded bit stream. The term “associate”, as used herein, means allowing an image (which may be part of an image, such as a slice or a block) included in a bit stream to be linked to information corresponding to the image when the image is decoded. That is, the information may be transmitted on a transmission path different from that for the image (or bit stream). Furthermore, the information may be recorded on a recording medium different from that for the image (or bit stream) (or recorded in a different recording area of the same recording medium). Furthermore, the information and the image (or bit stream) may be associated with each other in arbitrary units such as a plurality of frames, one frame, or a portion in a frame.

While preferred embodiments of the present disclosure have been described in detail with reference to the accompanying drawings, the present disclosure is not limited to such examples. It is apparent that any person having ordinary knowledge in the field of art to which the present disclosure pertains could achieve various exemplary changes or exemplary modifications within the scope of the technical idea as defined in the CLAIMS, and it is to be understood that such exemplary changes or modifications may also fall within the technical scope of the present disclosure.

Note that the present technology may also provide the following configurations.

(1) An image processing device including:

a receiving unit configured to receive an encoded stream and an initial value of a quantization parameter for a tile in a picture included in an image and partitioned into a plurality of tiles, the initial value of the quantization parameter for the tile being set so as to ensure that processes related to quantization parameters for tiles in the picture are independent;

a quantization parameter reconfiguration unit configured to reconfigure a quantization parameter of a coding unit in the tile, using the initial value of the quantization parameter for the tile received by the receiving unit; and

a decoding unit configured to decode the encoded stream received by the receiving unit using the quantization parameter reconfigured by the quantization parameter reconfiguration unit to generate the image.

(2) The image processing device according to (1), wherein

the receiving unit receives, as the initial value of the quantization parameter for the tile, a value set at a certain position in the encoded stream.

(3) The image processing device according to (1) or (2), wherein

the receiving unit receives, as the initial value of the quantization parameter for the tile, a value set in a picture parameter set in the encoded stream.

(4) The image processing device according to (1) or (2), wherein

the receiving unit receives, as the initial value of the quantization parameter for the tile, a value set in an initial slice header of the picture in the encoded stream.

(5) The image processing device according to (1) or (2), wherein

the receiving unit receives, as the initial value of the quantization parameter for the tile, a value set near the beginning of the tile in the encoded stream.

(6) The image processing device according to (1) or (2), wherein

the receiving unit receives, as the initial value of the quantization parameter for the tile, a value set in slice data in the encoded stream.

(7) The image processing device according to any one of (1) to (6), wherein

the receiving unit receives information concerning a quantization parameter of a coding unit in the tile, and

the quantization parameter reconfiguration unit reconfigures a quantization parameter of a coding unit in the tile, using the information concerning a quantization parameter of a coding unit in the tile received by the receiving unit.

(8) An image processing method including:

receiving an encoded stream and an initial value of a quantization parameter for a tile in a picture included in an image and partitioned into a plurality of tiles, the initial value of the quantization parameter for the tile being set so as to ensure that processes related to quantization parameters for tiles in the picture are independent;

reconfiguring a quantization parameter of a coding unit in the tile, using the received initial value of the quantization parameter for the tile; and

decoding the received encoded stream using the reconfigured quantization parameter to generate the image,

wherein the image processing method is performed by an image processing device.

(9) An image processing device including:

an encoding unit configured to encode an image to generate an encoded stream;

an initial value setting unit configured to set an initial value of a quantization parameter for a tile in a picture included in the image and partitioned into a plurality of tiles so as to ensure that processes related to quantization parameters for tiles in the picture are independent; and

a transmission unit configured to transmit the initial value of the quantization parameter for the tile set by the initial value setting unit and the encoded stream generated by the encoding unit.

(10) The image processing device according to (9), wherein

the initial value setting unit sets the initial value of the quantization parameter for the tile at a certain position in the encoded stream.

(11) The image processing device according to (9) or (10), wherein

the initial value setting unit sets the initial value of the quantization parameter for the tile in a picture parameter set in the encoded stream.

(12) The image processing device according to (9) or (10), wherein

the initial value setting unit sets the initial value of the quantization parameter for the tile in an initial slice header of the picture in the encoded stream.

(13) The image processing device according to (9) or (10), wherein

the initial value setting unit sets the initial value of the quantization parameter for the tile near the beginning of a tile in the encoded stream.

(14) The image processing device according to (9) or (10), wherein

the initial value setting unit sets the initial value of the quantization parameter for the tile in slice data in the encoded stream.

(15) The image processing device according to any one of (9) to (14), wherein

the transmission unit transmits information concerning a quantization parameter of a coding unit in the tile, the quantization parameter of the coding unit in the tile being generated using the initial value of the quantization parameter for the tile.

(16) An image processing method including:

encoding an image to generate an encoded stream;

setting an initial value of a quantization parameter for a tile in a picture included in the image and partitioned into a plurality of tiles so as to ensure that processes related to quantization parameters for tiles in the picture are independent; and

transmitting the set initial value of the quantization parameter for the tile and the generated encoded stream,

wherein the image processing method is performed by an image processing device.

### REFERENCE SIGNS LIST

100 image encoding device, 105 quantization unit, 106 lossless encoding unit, 117 rate control unit, 121 tile partitioning unit, 122 quantization initial value setting unit, 151 tile initial QP buffer, 152 picture initial QP buffer, 153 differential QP generation unit, 161 syntax setting unit, 181 tile initial QP buffer, 182 picture initial QP buffer, 183 first slice initial QP buffer, 184, 185 differential QP generation unit, 191 syntax setting unit, 200 image decoding device, 221 tile partitioning decoding unit, 222 quantization initial value decoding unit, 251 syntax receiving unit, 261 tile differential QP buffer, 262 picture initial QP buffer, 263 tile initial QP reconfiguration unit, 281 syntax receiving unit, 291 tile differential QP buffer, 292 first slice differential QP buffer, 293 picture initial QP buffer, 294 first slice initial QP reconfiguration unit, 295 tile initial QP reconfiguration unit

1. An image processing device comprising:
a receiving unit configured to receive an encoded stream and an initial value of a quantization parameter for a tile in a picture included in an image and partitioned into a plurality of tiles, the initial value of the quantization parameter for the tile being set so as to ensure that processes related to quantization parameters for tiles in the picture are independent;
a quantization parameter reconfiguration unit configured to reconfigure a quantization parameter of a coding unit in the tile, using the initial value of the quantization parameter for the tile received by the receiving unit; and
a decoding unit configured to decode the encoded stream received by the receiving unit using the quantization parameter reconfigured by the quantization parameter reconfiguration unit to generate the image.

2. The image processing device according to claim 1, wherein
the receiving unit receives, as the initial value of the quantization parameter for the tile, a value set at a certain position in the encoded stream.

3. The image processing device according to claim 2, wherein
the receiving unit receives, as the initial value of the quantization parameter for the tile, a value set in a picture parameter set in the encoded stream.

4. The image processing device according to claim 2, wherein
the receiving unit receives, as the initial value of the quantization parameter for the tile, a value set in an initial slice header of the picture in the encoded stream.

5. The image processing device according to claim 2, wherein
the receiving unit receives, as the initial value of the quantization parameter for the tile, a value set near the beginning of the tile in the encoded stream.

6. The image processing device according to claim 2, wherein
the receiving unit receives, as the initial value of the quantization parameter for the tile, a value set in slice data in the encoded stream.

7. The image processing device according to claim 1, wherein
the receiving unit receives information concerning a quantization parameter of a coding unit in the tile, and
the quantization parameter reconfiguration unit reconfigures a quantization parameter of a coding unit in the tile, using the information concerning a quantization parameter of a coding unit in the tile received by the receiving unit.

8. An image processing method comprising:
receiving an encoded stream and an initial value of a quantization parameter for a tile in a picture included in an image and partitioned into a plurality of tiles, the initial value of the quantization parameter for the tile being set so as to ensure that processes related to quantization parameters for tiles in the picture are independent;
reconfiguring a quantization parameter of a coding unit in the tile, using the received initial value of the quantization parameter for the tile; and
decoding the received encoded stream using the reconfigured quantization parameter to generate the image,
wherein the image processing method is performed by an image processing device.

9. An image processing device comprising:
an encoding unit configured to encode an image to generate an encoded stream;
an initial value setting unit configured to set an initial value of a quantization parameter for a tile in a picture included in the image and partitioned into a plurality of tiles so as to ensure that processes related to quantization parameters for tiles in the picture are independent; and
a transmission unit configured to transmit the initial value of the quantization parameter for the tile set by the initial value setting unit and the encoded stream generated by the encoding unit.

10. The image processing device according to claim 9, wherein
the initial value setting unit sets the initial value of the quantization parameter for the tile at a certain position in the encoded stream.

11. The image processing device according to claim 10, wherein
the initial value setting unit sets the initial value of the quantization parameter for the tile in a picture parameter set in the encoded stream.

12. The image processing device according to claim 10, wherein
the initial value setting unit sets the initial value of the quantization parameter for the tile in an initial slice header of the picture in the encoded stream.

13. The image processing device according to claim 10, wherein
the initial value setting unit sets the initial value of the quantization parameter for the tile near the beginning of a tile in the encoded stream.

14. The image processing device according to claim 10, wherein
the initial value setting unit sets the initial value of the quantization parameter for the tile in slice data in the encoded stream.

15. The image processing device according to claim 9, wherein
the transmission unit transmits information concerning a quantization parameter of a coding unit in the tile, the quantization parameter of the coding unit in the tile being generated using the initial value of the quantization parameter for the tile.

16. An image processing method comprising:
encoding an image to generate an encoded stream;
setting an initial value of a quantization parameter for a tile in a picture included in the image and partitioned into a plurality of tiles so as to ensure that processes related to quantization parameters for tiles in the picture are independent; and
transmitting the set initial value of the quantization parameter for the tile and the generated encoded stream,
wherein the image processing method is performed by an image processing device.
